(19) United States
(12) Patent Application Publication
(10) Pub. No.: US 2025/0104128 A1
(43) Pub. Date: Mar. 27, 2025

(54) SYSTEM AND METHOD FOR FACILITATING A CONNECTION OF TWO PARTIES

(71) Applicant: Gitcha LLC, Powell Butte, OR (US)

(72) Inventors: Daniel Wayne Cooper, Powell Butte, OR (US); Jacob Tyler Hokinson, Eugene, OR (US)

(21) Appl. No.: 18/896,787

(22) Filed: Sep. 25, 2024

Related U.S. Application Data
(60) Provisional application No. 63/540,192, filed on Sep. 25, 2023.

(51) Int. Cl. G06Q 30/0601

(52) U.S. Cl. CPC G06Q 30/0631

(57) ABSTRACT

Systems and methods are described herein relating to facilitating the connection of two parties in a secure manner. In some cases, the described systems and techniques provide an introduction tool used to connect two users based on a publicly accessible want item listing posted by or on behalf of a first user. The introduction tool may apply different levels of restrictions (e.g., privacy restrictions or controls) to different stages of communications between the first user and a second user associated with possession of an item that satisfies a set of matching criteria for the want item listing. The introduction tool, in some cases, may retain at least some level of anonymity between the first and second users, such as to give the first user the ability to terminate communications with the second user at various stages through the introduction process.

### CROSS-REFERENCE TO RELATED APPLICATIONS

This application claims the benefit of U.S. Provisional Application No. 63/540,192, filed Sep. 25, 2023, entitled “SYSTEM AND METHOD FOR FACILITATING A CONNECTION OF TWO PARTIES,” the contents of which are incorporated by reference herein in their entirety.

### BACKGROUND

In 1979, entrepreneur Michael Aldrich was the first to create an on-line shopping experience. Now, ecommerce via the World Wide Web accounts for over $1 trillion annually for the US Economy. In that time, ecommerce has grown via the standard marketplace for sellers and buyers: a person with an item (seller) provides an item for sale and people who are looking to purchase (buyer) can either contact the seller directly or purchase the item through various means on the internet, including both standard type transactions as well as auction-based formats.

This marketplace arrangement is true for the real estate market too, where the market is conducted through a traditional buyer & seller or landlord & renter listing format: homes and properties are listed for sale or rent by their owners or real estate agents representing the owners through on-line mediums and professional listing services. These sources are generally where interested buyers can view & search up-to-date publicly listed homes, review the photos and specifications, and schedule appointments to tour the properties. For renters, renters can view photos and specifications on-line and frequently, if they are interested, they can submit applications through website portals. While most real estate purchases or rental agreements are consummated off-line, almost all discovery & connections start with a home that is presented as ‘for-sale’ or ‘for-rent’ on-line and/or via an official Multiple Listing Service (MLS) listing on various internet sites.

All digital platforms and professional networks such as the national Multiple Listing Service (MLS) provide a conduit for those with the item to sell or rent, and the buyers & renters are only able to view what owners decide to publicly list. This has worked for decades, but if a buyer or renter—or a professional representing a buyer or renter—wishes to find something not listed on the market, there is no searchable, organized platform to state the specifications needed or wanted in the property they are seeking. The problems with this model are many and growing. In an increasingly competitive and tight inventory market, consumers and professionals are relegated to whatever property is being publicly offered and there are limited avenues to cater to the buyer or renter with specific needs or wants outside of the active market. And, there is no way to balance out the buyer and seller relationship outside of economic impacts—the market simply is steered & controlled by those who possess the item or asset who want to make their property publicly available.

If the property desired by a buyer, renter or their agent is not found, currently consumers and professionals have a very small handful of options to make their wants and needs in a property known. Limited web forums and traditional classified want-ads are broad & general sites rather than specifically designed for specific real estate want listings in exact locations & markets. All are regionally separated rather than nationally integrated and the ability to search them in a streamlined and cohesive way is not offered. These platforms are also not intended to be a public listing (much like for-sale listings in the real estate market), rather they are a short advertisement that becomes obscure within 24 hours. And, they do not offer a collective, efficient and effective manner to connect or qualify both parties. For consumers there are no means to control their privacy or the direction of communication so they can avoid unwanted contact by potential spammers or professional agents wanting to obtain them as clients. On the professional side there are no avenues for agents representing buyers and renters to connect with owners & agents representing owners in a specific and direct way. While this direction of the existing seller-to-buyer or landlord-to-renter marketplace has been in place for decades, it has reached different levels of ineffectiveness throughout the national real estate market.

To date, the marketplace has not adjusted to provide additional options for the consumer to obtain what they are looking to purchase or rent, or to invite new ways of professional-to-professional connections when an agent represents a buyer or renter. Simply, there are no technologies intended to prioritize and energize the buyers and renters side in a marketplace, offering an interface that can provide them new opportunities by allowing them to specifically list what they are looking for while providing them an exclusive tool that will allow them to privately connect with owners and agents on their terms.

### BRIEF DESCRIPTION OF THE DRAWINGS

Various techniques will be described with reference to the drawings, in which:

FIG. 1 illustrates an example communication system in which the described techniques can be practiced, according to at least one embodiment;

FIG. 2 illustrates an example implementation of the communication system of FIG. 1, in which the described techniques can be practiced, according to at least one embodiment;

FIG. 3 illustrates another example implementation of the communication system of FIG. 1, in which the described techniques can be practiced, according to at least one embodiment;

FIG. 4 illustrates example interactions of different user types with any of the communications system of FIGS. 1-3, according to at least one embodiment;

FIGS. 5A-5B illustrate an example process for interacting with an introduction tool, which may be provided by any of the communications systems of FIGS. 1-3, according to at least one embodiment;

FIG. 6 illustrates an example process for introducing two users performed by a communications system, such as any of communication systems of FIGS. 1-3, according to at least one embodiment; and

FIGS. 7A-51B illustrate examples views of a user interface for interacting with one or more of the systems of FIGS. 1-3, such as may be provided by the user interface 110 of FIG. 1, according to at least one embodiment.

### DETAILED DESCRIPTION

The present disclosure, in some aspects, includes or relates to a system or service, such as provided through downloadable software in both web and mobile applications for use as an online marketplace or communications center, facilitating the connection of two parties in a secure manner, such as for transaction of goods and services, including the purchase and sale of real property, the renting of available rental properties, etc. In some cases, the described systems and techniques facilitate connecting two or more parties by prioritizing the wants and needs of the buyer, renter or their representing agent. In some aspects, the described systems and techniques provide a connection method for buyers and renters and their agents seeking real property to connect with sellers, landlords and their agents in a simplified, efficient & private way.

While various examples herein related to real property such as residential or commercial real estate or land that is being rented or sold, it should be appreciated that the present disclosure in various embodiments is applicable to facilitating the connection of two parties for any suitable purpose and for any suitable goods and/or services, including consumer products (e.g., cars, clothing, housewares, furniture, electronics, clothing, furniture, appliances, toys, cosmetics, food products, beverages, cleaning products, personal care products, sports equipment, books, stationery, gardening tools, pet supplies, automotive parts, home decor, kitchenware, musical instruments, software, tools, and the like) and services such as cleaning, construction, software development, graphic design, video production, legal services, transportation, marketing, IT support, human resources management, administrative assistance, business consulting, catering, corporate training, copywriting, event planning, photography, real estate management, home healthcare, tutoring, market research, and the like. Additionally, in various embodiments, the present disclosure can be relevant to facilitating the connection of two parties for various non-commercial or semi-non-commercial purposes such as conversation, debate, brainstorming session, coaching, mentoring, conflict resolution, team building, networking, socializing, collaboration, dating, teaching, learning, counseling, feedback session, performance review, and the like.

Various embodiments related to a national, sortable and searchable want-ad marketplace that provides a system for buyers, renters and their agents to publicly list what they are specifically seeking in a property purchase or rental (‘want-ad listing’), and where on the other side, property owners and their agents can load the details, photos and description of real property that they own or represent. Once the owners identify that they possess real property that may fit the criteria of a public want-ad listing, they can introduce their property to the potential buyer, renter or agent. Various embodiments provide an exclusive system that privately and securely connects real property owners and their agents with prospective purchasers, renters and their agents.

It should be appreciated that the various examples provided herein are used to illustrate various example embodiments, but should not be construed to be limiting on the wide variety of additional embodiments that are within the scope and spirit of the present disclosure.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) more efficient utilization of computing resources to route communications between different users; (2) a reduction in communications between multiple parties to form a connection; (3) other benefits and advantages as will be described and made apparent in the description below.

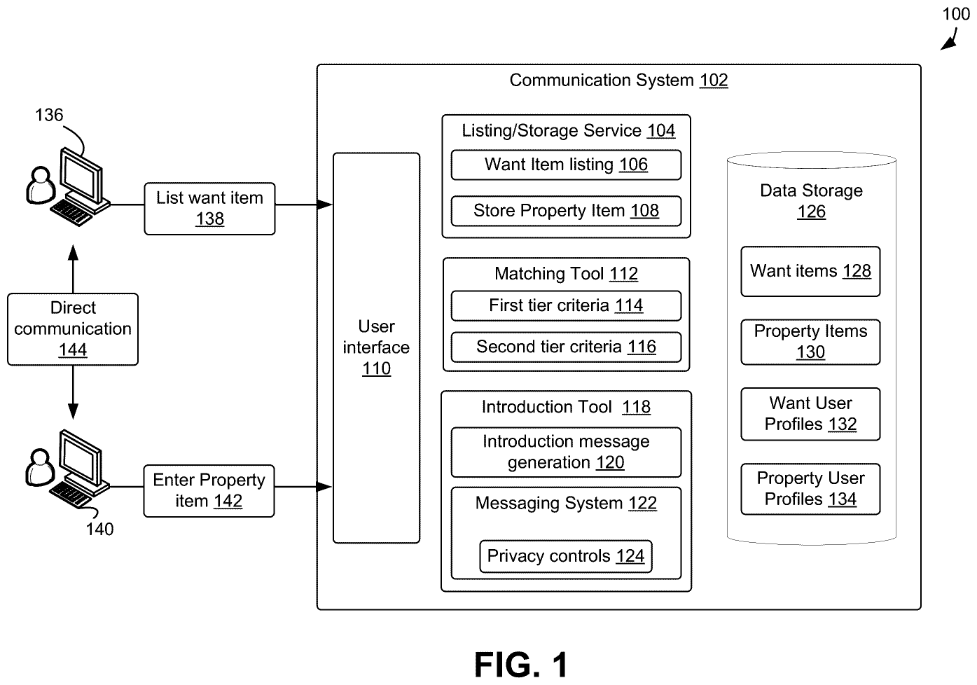

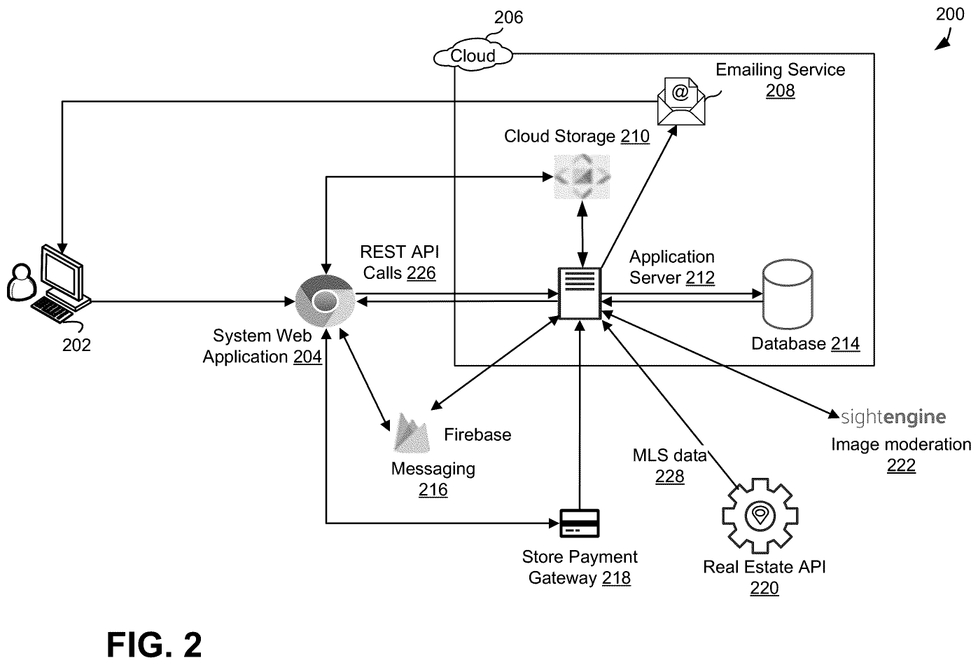

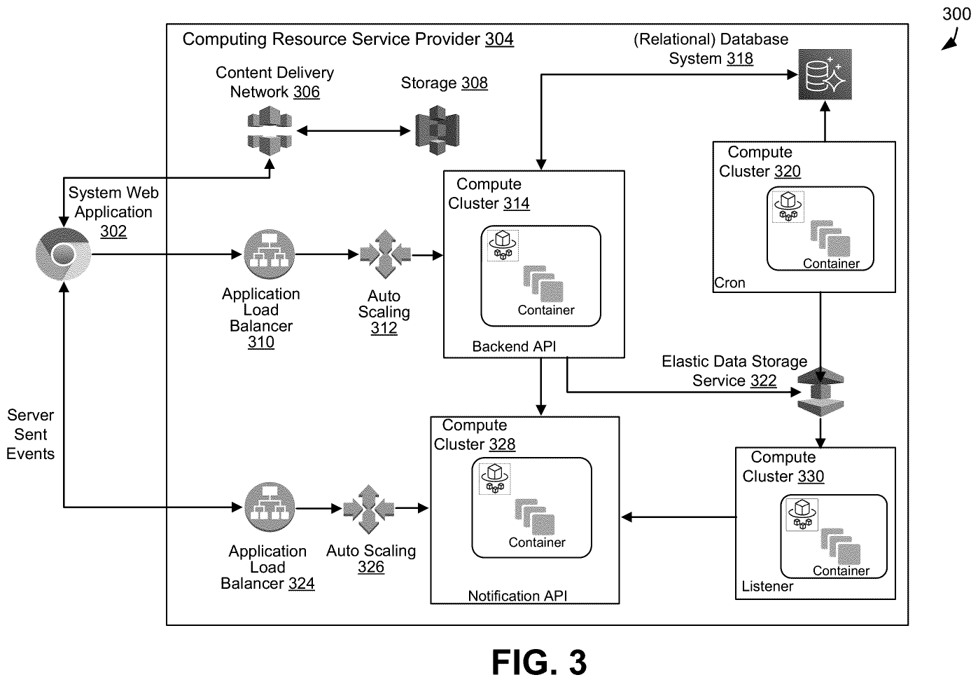

FIG. 1 illustrates an example environment 100 including a communication system 102 to introduce and connect various users 136 and 140, such as to fulfill a transaction. In various examples, the communication system 102 may be provided by various computing resources, including software, hardware, or combinations thereof. In some cases, communication system 102 may be provided in whole or in part by a cloud computing service provider, examples of which will be described in reference to FIGS. 2 and 3 below. In yet some cases, the communication system 102 may be provided as a service to various users or clients. As described herein, there may be three different classes or types of users: want users or users looking to acquire any of a variety of goods, services, information, etc., property or property users offering any of a variety of goods, services information, etc. for acquisition or to gauge interest, and agents that may represent one or the other (or both) of the want users and the property users. For ease of reference, generally want and property users will be used in the following description unless something specific to an agent is mentioned. It should be appreciated that in many circumstances an agent my be used interchangeably with either a want user or a want or property user. As illustrated, a want user may interact with the communication system 102 via a want user device 136, and a property user may interact with the communication system 102 via a property user device 140 through one or more networks, including wired and/or wireless communication networks (not illustrated).

Want user device 136 and/or property user device 140 may refer to a client computer system or computing device connected to a server (e.g., provided by a computing resource service provider, such as a cloud computing service) over a network. User and property devices 136, 140 may include one or more instances of a physical computing instance (e.g., a physical server computer, a mobile communication device, a laptop computer, a tablet computer, a personal computer, etc.). In some cases, a client or user may refer to a user or operator of a client computer system and to interact with various forms of data, such as through one or more user interfaces 110 (which may include one or more graphical user interfaces of GUIs) provided by the communication system or service 102. Examples of different views of a graphical user interface will be described in greater detail below.

In some examples, various users may interface with want item listings 106 through a dashboard or user interface, such as may be provided by the user interface 110. In some cases, user interface 110 may provide a publicly accessible dashboard, web interface, application, etc., through which users may view want item listings 106. In various examples, property items 108 may not be shared publicly, and may be accessed via a secure login with the communication system 102, such as through user interface 110. In some cases, access to property items 108 may be limited or retracted to property owners associated with (e.g., owners of), the property item, or authorized agents thereof. In this way, the communication system 102 may provide a buyer centric interface and platform that is not centered around the seller, such that items for sale or offered through communication system 102 may be held private until a potential interested party or user expresses interest in the item, such as through the introduction tool 118, as will be described in greater detail below.

In some cases, the communications system 102 may include or provide a listing or posting service or interface 104. In some cases, the listing/posting service 104 may be provided as a web interface for different want and property users 136, 140 to interact with, such as by posting a want listing 106 (generally referred to herein as an item or item listing) for a want item 138, or loading a property item 142 to be saved by the listing/storage service 102. In some cases, the want listings 106 may be provided through a public web interface, whereas the property items 108 may be held private (e.g., saved by the listing/storage service 104 in a data storage system 126 as property items 130), such that only the property user 140 associated with a given item can view the saved property item until a connection is made with a potential want user 136.

As used herein, a want user or want user device 136 may include any user, such as acting through a device, that is interested in acquiring a good, a service, information, intangible asset, etc., such as by posting a want item 138. Similarly, a property user or property user device 140 may include any user, such as acting through a device, that possess some type of asset, including real property, any type of property or good, provides a service, or has some type of information or intangible asset that the user would like to offer for sale, or just gauge interest in for some type of acquisition or trade.

In some cases, the communications system 102 may include or provide a matching tool or process 112, which may match want items, such as a want item listing 106, with a property item, such as a property item 108. The matching tool 112 may be provided by one or more of various computing resources, such as physical computing resources, software, and/or virtual computing resources. In some cases, the matching tool 112 may be configured with different levels or priorities of criteria, such that a match may be identified between a want item and a property item if a first tier criteria 114 fully or partially match (e.g., greater than a given percentage of criteria, a certain number of the first criteria, a selected subset of the first criteria, etc.). In some cases, second tier criteria 116 may also be configured, such to better select one or more matches for a given want item or property item, to prioritize matches based on the number of second tier criteria that match, etc. In some cases, first tier criteria may be selected by the system 102, whereas second tier criteria may be selected by a property user, or a want user, or a combination of the two. In other cases, both of the first and second criteria may be selected by one or both of the want user 136 and property user 140. In some cases, a want user may specify a set of first tier criteria, and a property user may specify a different et of first tier criteria. In this example, if both sets of first criteria are satisfied, then a match may be identified. It should be appreciated that various other matching criteria and schemes are contemplated herein.

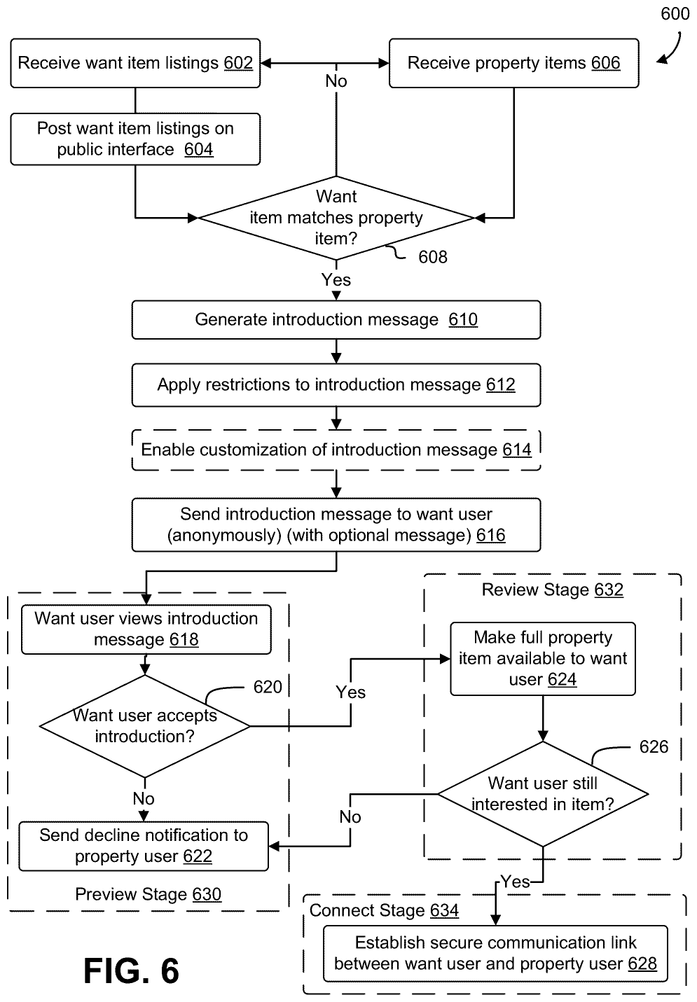

In some cases, the communications system 102 may include or provide an introduction tool or process 118. The introduction tool 118 may be provided by one or more of various computing resources, such as physical computing resources, software, and/or virtual computing resources. After a property item 108 is matched with a want item listing 106 by matching tool 112 (or alternatively manually selected by a property user 142 via the listing service/interface 104), the introduction tool or process 118 may facilitate a one way, at least partially anonymous connection (or in some case, fully anonymous connection to begin with) to be made between the property user 140 and the want user 136. This may include generating an introduction message via process 120, whereby certain details of the property item may be provided (e.g., in an editable message, to be edited by the property user 140), to notify the want user 136 to see if the want user 136 is interested in the property item. The introduction message may be routed to the want user 136 via a messaging system or process 122, whereby the identity of the property user 140 associated with the property item may be kept anonymous via one or more privacy controls 124, including but not limited to omitting or obfuscating the property user's identity, email address, other contact information, specifics about the property item that may enable the want user 136 to ascertain the identity of the property user 140, etc. A more detailed example of the operation of the introduction tool 118 will be described in greater detail below in reference to FIG. 6. Once an introduction is made (e.g., anonymously) to the want user 136, if the want user 136 indicates a selection of continued interest, the want user 136 (or in some cases, the property user 140), may then initiate a direct communication with the property user 140 (or want user) whereby the communication is not anonymous and can proceed to fulfill or complete a transaction for good, services information, etc. In various cases, the introduction message generated by process 120 may be temporarily or permanently saved, such as via data storage service 126, such as associated with a property user profile 134.

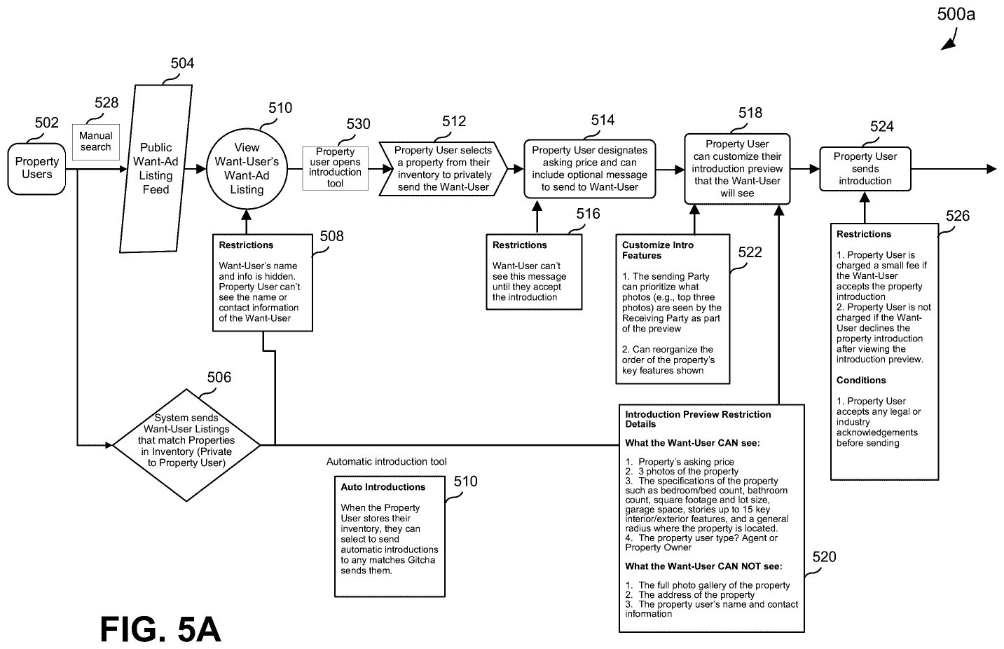

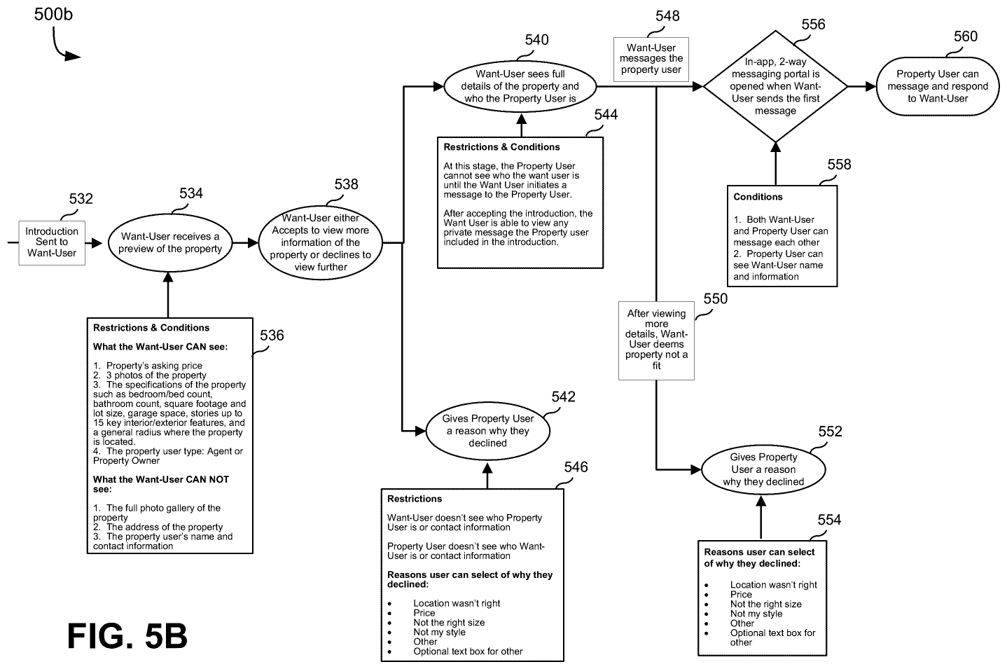

In some cases, privacy controls 124 may include implementing restrictions or limitations on various stages of the introduction process, such as may be provided by the introduction tool 118. An example of such restrictions are described in greater detail below in reference to FIGS. 5A and 5B. The privacy controls implemented may be different at different stages of the introduction process, such as the preview stage, review stage, and connection stage, as described below in greater detail in reference to FIG. 6.

In some examples, agents acting on behalf of want users 136 may select to include personal contact information with a want item listing 106. In these cases, an agent may circumvent the introduction tool, such that a property user could contact the agent directly. In other cases, the introduction tool 118 could still be implemented, such as to regulate the interactions, or utilize other benefits provided by the introduction tool 118, etc. In yet some cases, a want item user 136 may also select to include personal contact information with a want item listing 106. In these cases, an want user may circumvent the introduction tool, such that a property user could contact the want user directly. In other cases, the introduction tool 118 could still be implemented, such as to regulate the interactions, or utilize other benefits provided by the introduction tool 118, etc.

In some examples, the communication system 102 may include or interface with data storage, such as through a data storage service 126 to store and manage large volumes of data, including text, image, and other data. The data storage service 126 may store various data, such as may be organized into various accounts or profiles, including want user and property user profiles 132, 134, and want and property items 128, 130. A user profile 132, 134 may include contact information of various formats (email, messing identifier, phone number, etc., address, payment information, etc.) and may include various other data, such as account history with the communication system 102, rating information by other users, introduction messages and other message history, and so on. Each want item 128 and property item 130 may include various attributes of the specific item, as will be described in greater detail below.

FIG. 2 illustrates an example implementation 200 of a communication system, such as may be an example of communication system 102 described above in reference to FIG. 1. As illustrated, the communication system 102 may be provided through a web application 204, that interfaces with a number of different services or components, including an application server 212 via REST API calls 226, database 214, cloud storage 210, a payment gateway 218, various data sources, such as a real estate API 220 that may provide MILS data 228 in the case of real property, an image moderation service 222, and various communication platforms, such as messaging service or system 216 and/or emailing service 208. In some cases, a user 202 may interact with the web application 204 and/or via email service 224, or messaging service 216 to make connections with other users, as described herein.

FIG. 3 illustrates an example implementation 300 of a communication system, such as may be an example of communication system 102 described above in reference to FIG. 1. As illustrated in FIG. 3, a computing resource service provider 304 may provide the backend for the communications system's web application 302. The computing resource service provider 304 may provide load balancing via load balancers 310, 324, including autoscaling functionality via auto scaling 312, 326, to provide various API's and processes via different virtual machine or container clusters (e.g., compute clusters) 314, 320, 328, 330 to enable the web application to operate. The computing resource service provider 304 may also provide a content delivery network 306 and various storage services, including block storage 308, a relational database system 318, an elastic data storage service 322, and various other services and computing resources.

The computing resource service provider 304 may provide various services such as data processing, data storage, software applications, security, encryption, and/or other such services. The computing resource service provider 304 may provide services that may be accessible through various software, hardware, and/or variations thereof. In some examples, the services may be implemented as software applications or services executing on various computing devices. Examples of such computing devices include one or more instances of a physical computing instance (e.g., a physical server computer, a mobile communication device, a laptop computer, a tablet computer, a personal computer, a mainframe, etc.) or one or more instances of a virtual computing instance, such as a virtual machine hosted on one or more computer servers, or other various capable computing systems.

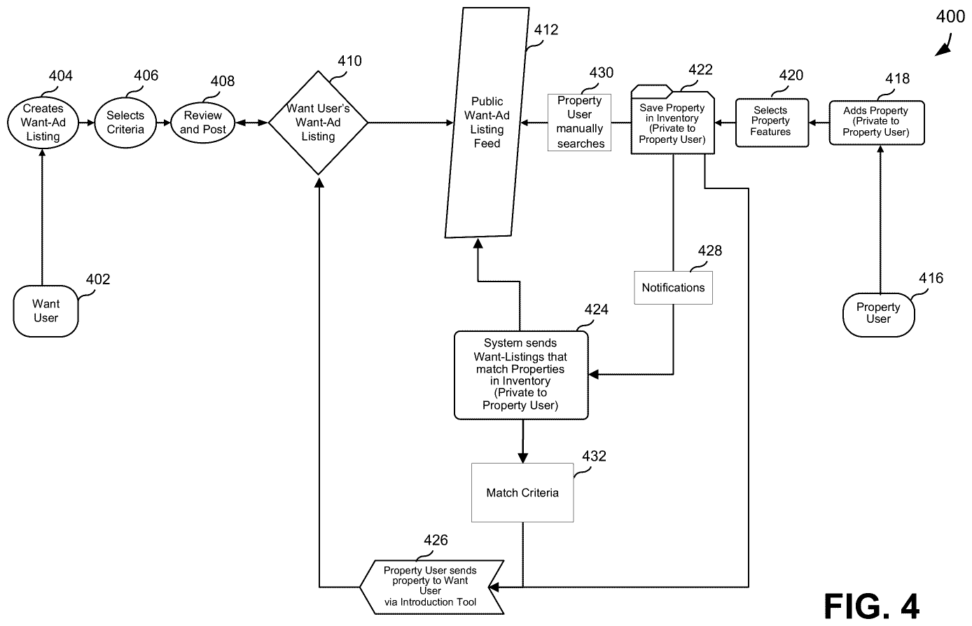

FIG. 4 illustrates example interactions 400 of different user types with a communications system, such as any of systems 102-302 described above in reference to FIGS. 1-3. As illustrated, a want user 402 may create a want item or ad listing, at operation 404. This may include specifying certain attributes of a good or service the want user 402 is looking to acquire. In various examples, the want user may include an agent, a buyer, a renter, a property manager, an investor, etc. The want user 402 may select various criteria to positively identify a match, such as first criteria and/or second criteria described above, at operation 406.

In some cases, the first tier criteria (e.g., required criteria for a match), may include, for a property: one or more of location, property type, number of bedrooms, number of bathrooms, square footage, timeline for purchasing or renting, budget (e.g., number, range, maximum), a title, and in some cases for agents: requested concessions. In some examples, the second tier criteria or optional criteria may include one or more of: school district, neighborhood, number of garage spaces of garage square footage, number of stories, lot size, year built, if it is ADA accessible, property interior and/or exterior features, purchase type (primary, secondary, investment, etc.), financial details, and/or additional descriptions. In some cases, the system may select at least a subset of the provided attributes for determining a match. In some cases, the subset may be predetermined by the system, and/or selected by the want user. For example, matching criteria may include one or more of: location, property type, number of bedrooms, number of bathrooms, square footage, budget/price, and/or garage spaces, and/or number of stories.

In some cases, the system may generate a preview of the want item listing, display it to the want user 402, and enable the want user to make additional changes and post the want item listing, at operation 408, whereby the want item listing 410 is published to a public want item listing feed, at operation 412.

Concurrently or at a different time, a property or property user 416 may add an item (e.g., property) to a private sell or property user listening, at operation 418. The property user may include one or more of an agent, a property owner, a property manager, and/or an investor. The property user 416 may input property features into the system, at operation 420, whereby the sell or property item may be saved to the property user's private inventory, at operation 422. The property features or attributes may be the same as some or all of the attributes designated by the want user (e.g., in the case of real property, the attributes may be the same for most if not all item listings).

In some cases, the property user 416 may manually search for want item listings via the public want item listing feed 412, at operation 430. In other cases, the communications system and/or matching tool (.e.g., the matching tool described above in reference to FIG. 1) may determine if any available want item listings match the property item via process 424 by comparing the attributes of both to see if they satisfy matching criteria 432. If one or more want items does satisfy the match criteria, then the communications system may send a notification to the property user 416 or a profile associated with the property user 416.

Once a match has been identified, either via the system or manually by the sell/property user 416, then the property/property user 416 may configure and send an introduction message to the want user 402 anonymously, to enable the want user to determine if they want to engage in further communications with the property user 416, such as via the introduction tool or process described above in reference to FIG. 1. In some cases, the communication system may automatically configure and send one or more introduction messages to want users 402 upon a match being identified.

In some aspects, as illustrated, one or more of operations 404, 406, 408, 410, and/or 412 may be performed by, performed on behalf of, or associated with the want user or want user device. Similarly, one or more of operations 418, 420, 422, 422, 424, 426, 428, 430, and/or 432 may be performed by, performed on behalf of, or associated with the property user or property user device.

FIGS. 5A-5B illustrate an example process 500a and 500b for interacting with an introduction tool, such as may be provided by a communications system, such as any of systems 102-302 described above in reference to FIGS. 1-3.

As illustrated, a property user 502 may interact with the communications system, to either manually find a match, at operation 528, via searching a public want item listing 504, or via a match identified via an automated matching tool, as described in greater detail above, at operation 506. Once a match has been identified, the property user 502 may view a restricted or redacted version of the want item listing, at operation 510. In some cases, the restrictions 508 may include redacting or otherwise not making available one or more of the want user's name and/or other contact information, such as to keep the identity of the want user anonymous. The restrictions may be enforced (e.g., the data from the want items listing manipulated or changed) by the communication system.

In the case the property user 502 manually identifies a want item listing, the property user 502 may engage with the introduction tool, as described above, at operation 520, and select a property or item from their private inventory to send to the want user, at operation 512. In some aspects, the property user 502 may designate an asking price, and/or other attributes of the item or property, and configure an optional message to send to the want user, at operation 514. In some cases, one or more restrictions 516 may be placed on the communication to the want user, including, for example, that the want user cannot see the message until they accept the introduction. In some cases, the property user 502 can customize the message further, at operation 518, such as including a number of prioritized photos, reorganizing order of features of the item in the message, and various other customizations 522. In some aspects, other restrictions may be enforced on the introduction message by the communication system, such as removing some or all identifying information of the property user from the message, etc., at operation 520.

In some aspects, the property user 502 may configure the communication system to automatically identify matches (e.g., perform operation 506), and to automatically generate and send an introduction message to a want user, at operation 510, while enforcing one or more restrictions on the message, at operation 520. It should be appreciated that the restrictions at operation 520 are given as examples, and that other restrictions may similarly be enforced. In these cases, the property user 502 may still be provided an option to further customize the introduction message, at operation 518.

In either the manual search or automatic match options, once the introduction message has been finalized (or a given time period, for example, has passed since an automated message has been generated and the property owner given an opportunity to modify it), the property user 502 may select to send the introduction message to the want user, at operations 524, in some cases, with one or more restrictions or conditions applied (e.g., acceptance of legal or industry acknowledgements.

The introduction may be sent to the want user (or account associated thereof), at operation 532, whereby the want user may receive the introduction message at operation 534. In some cases, the communications system may apply a filter or set of restrictions 536 on the introduction message at this stage, to ensure only a limited amount of information or a subset of information from the property item is made available to the want user. In other cases, the communication system may apply the restrictions during message generation (e.g., at operation 520). In some cases, both restrictions stages may be implemented, such as to enforce different restrictions on the property user side and the want user side.

In some cases, the want user may decline the introduction, and optionally provide one or more reasons as to why they declined, at operation 542. In some cases, the communication system may impose one or more restrictions on the response, at operation 546, such as to keep the identity of the want user private, etc. In the case the want user accepts the introduction, the want user may be granted access by the communication system to the full details of the property item, at operation 540. The state may impose restrictions on the property user a this stage, at operation 544, such that until the want user initiates a message to the property user, the property user is not informed of the identity of the want user.

After viewing the complete listing, the want user may message the property user directly, at operation 548, such as through a secure messaging application provided by or through the communication system (e.g., via messaging system 122 provided by or in conjunction with introduction tool 118). This may initiate a two way messaging portal at operation 556, where the identities of the parties are made available to each other, at 558. This may enable the property user to respond to the want user, at operation 560. In some cases, after viewing the complete listing, the want user may decline further communications, at operation 550 and 552. In some cases, the want user may provide reasons as for declining, at operation 554.

In some aspects, as illustrated, one or more of operations 534, 538, 540, 542, 548, 550, 552, and/or 556 may be performed by, performed on behalf of, or associated with the want user or want user device. Similarly, one or more of operations 528, 510, 506, 510, 530, 512, 514, 518, 522, and/or 524 may be performed by, performed on behalf of, or associated with the property user or property user device.

FIG. 6 illustrates an example process 600 for introducing two users, such as may be performed by a communications system, such as any of communication systems 102-302 described above in reference to FIGS. 1-3. In some cases, one or more operations of process 600 may be performed by the introduction tool 118, an introduction message generation process 120, and/or a messaging system 122 as described above in reference to FIG. 1. As illustrated, dashed lines outlining an operator may indicate optional operations, such that process 600 may be performed both with or without the indicated operation.

As illustrated, process 600 may begin with one or more of operation 602, in which one or more want item listings may be received, and operation 606, in which one or more property items may be received, by a communications system or introduction tool, as described above. Various parameters or attributes of a want item, such as one or more example attributes described above, may be received to define a want item. In some cases, once a certain number or type of been parameters have been received, the system may publish or post the want item listing on a publicly accessible interface (e.g., a marketplace, website, etc.), at operation 604. In some cases, a property item, such as received at operation 606, may similarly bee defined by a number of parameters or attributes, such as one or more of the examples described above.

In some cases, the communication system may at various times, search for matches between want item listings and property items. In some cases, this process may be automatic, and/or may performed at various time intervals, upon the occurrence or detection of a trigger event (a new want item or sell item being uploaded or listed with the communication system), or upon some other type of trigger. In some cases, this automatic matching process may be performed any of a number of times until a match or partial match is found, at operation 608. In some cases, process 600 may loop from operation 608 through one or more of 602, 604, and 606, until a match is found, upon which determination, process 600 may proceed to operation 610. In other cases, at any time, a property user (or a want user) may search the publicly listed want times to manually find a match, at which point, process 600 may proceed to operation 610.

At operation 610, the communication system and/or introduction tool may generate an introduction message to be sent from a property user associated with the matched property item to a want user associated with a matched want item listing. In some cases, the introduction message may include a limited amount of information concerning the property item, such as to enable a want user to gauge interest in the property item, such as with disclosing the identity of the property user or providing information hat would enable the want user to identify the property item owner. In some cases, process 600 may include operation 612, in which one or more restrictions, such as privacy controls, may be applied to the introduction message. The restrictions may include removing identifying information from the message, limiting the amount of detail provided with the property item, and various other restrictions, examples of which are discussed throughout this disclosure. In some cases, the restrictions may be applied by the privacy controls component of messaging system 122, described above in reference to FIG. 1. In some optional cases, a preview of the introduction message may be provided to a property user device or account (e.g., via a notification or through a dashboard interface), which may enable the property user to further edit the introduction message, add an optional message, etc., at operation 614. Next, at operation 616, the communication system and/or messaging system may send the introduction message to the want user (e.g., anonymously).

The want user may then select to view the introduction message, at operation 618, such as through a user dashboard, through an email or other notification, etc. The want user may then select whether the accept the introduction, at operation 620. If the want user declines, at operation 620, a decline notification may be sent to the property owner, which may stop further communications between the want and property user (as neither user at this point, in some cases, has contact information of the other user), at operation 622. Operations 618 and 620 (an in some cases, operation 622) may define preview stage 630, where the want user obtains limited amount of information of a property item, and retains the exclusive right to cease further communications.

If, at operation 620, the want user accepts the introduction, then process 600 may proceed to operation 624, in which the full property item details may be made available to the want user, such a through a want user dashboard, email notification, etc. At this point, the system may request an indication of interest from the want user, at operation 626. If the want user is not interested, a decline notification may be sent to the property user, at operation 622. However, if the want user is still interested, as determined at operation 626, process 600 may proceed to operation 628, where a communication link may be established between the want user and the property user, such as via a messaging system 122. At any point thereafter, the want user may terminate the communication link, and the system will restrict further communications to the want user or between the property user and the want user. Operations 624 and 626 (an in some cases, operation 622) may define review stage 632, where the want user obtains more or complete information of a property item, and retains the exclusive right to cease further communications. Similarly, operation 628 may define connection stage 634, where the want user obtains more or complete information of a property item, and both want user and property user have the ability to terminate further communications.

In some cases, the described process 600 may include unlocking or lifting one or more restrictions progressively, gradually, etc., on the communications between a want user and a property user, as the process moves through the preview stage 630, review stage 632, and the connect stage 634.

A novel aspect of the described communication system enables the want user to decline further communications with a property owner concerning a property item at multiple stages of the introduction process, enabling the want user to better manage unwanted communications and marketing materials being sent to them. In some aspects, this may reduce network bandwidth usage and effectuate better utilization of computing resources used by various users to perform various transactions of property, goods, services, information, etc.

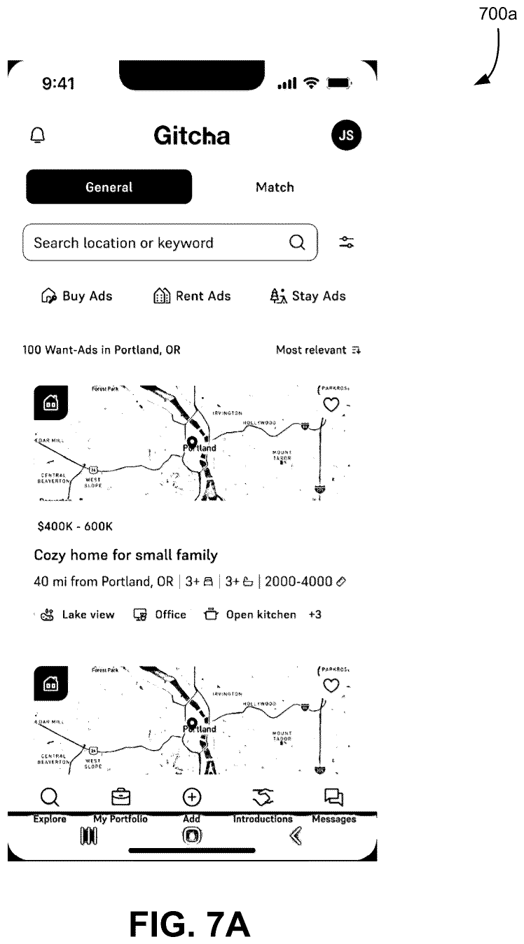

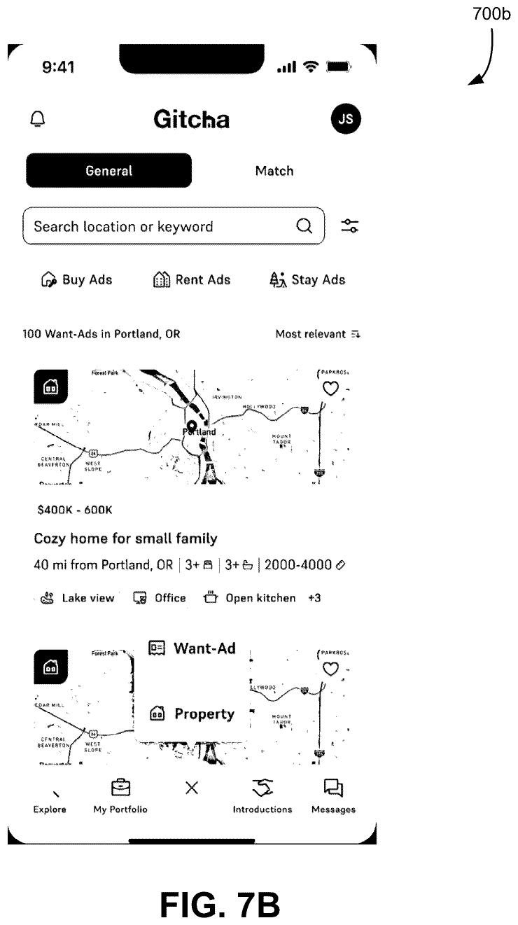

FIGS. 7A-51B illustrate examples views of a user interface for interacting with one or more of the systems of FIGS. 1-3, such as may be provided by the user interface 110 of communications system 1002 described above in reference to FIG. 1. As described below, the example interface may be described primarily in terms of real estate as the medium of property to transact. However, it should be appreciated that the described user interface, and systems and techniques more generally, are applicable to various goods and services, and other items that two users may seek to exchange or transact.

Want User Example: The Buyer. Renter & their Agents

In various embodiments, a general home screen, such as view 700a illustrated in FIG. 7A, displays the marketplace of the want-ad listings that can be automatically generated in some examples by a user's location based on either the IP address of the user's internet service or the GPS location registered by the user's mobile device. The home want-ad listing screen in some embodiments can be the same for both buyers, renters and their agents (‘Want User’) as well as property owners and their agents (‘Property User’). Various embodiments allow a Want User to create a want-ad listing, a publicly published listing where they can list both specific and general criteria for their desired purchase or rental of real property, or other property. To create a want-ad listing, a want user can navigate from the home screen by utilizing the ‘add’ button and then selecting ‘want-ad’, as illustrated in view 700b of FIG. 7B.

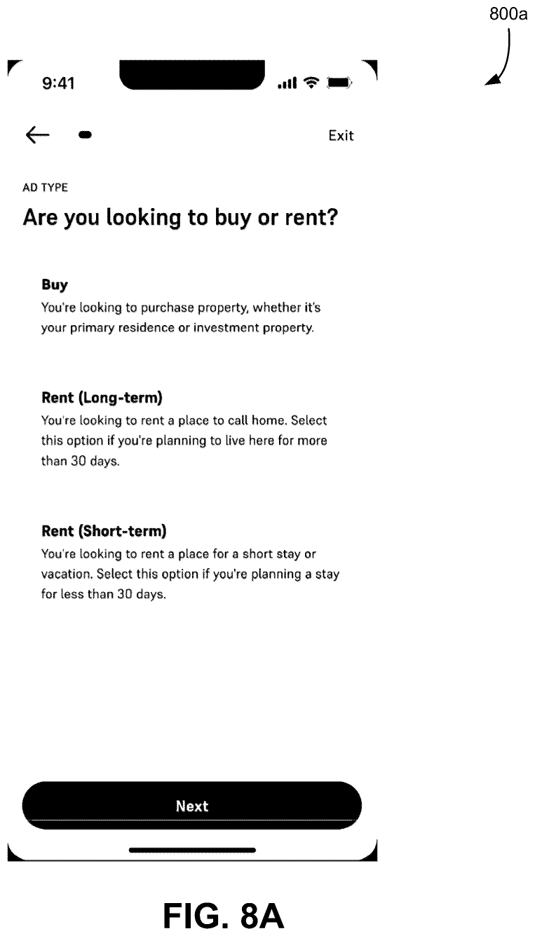

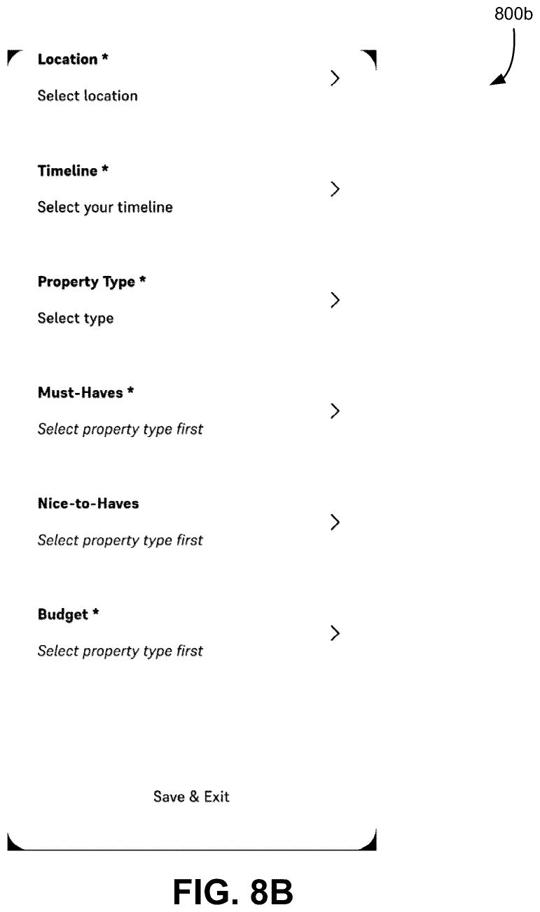

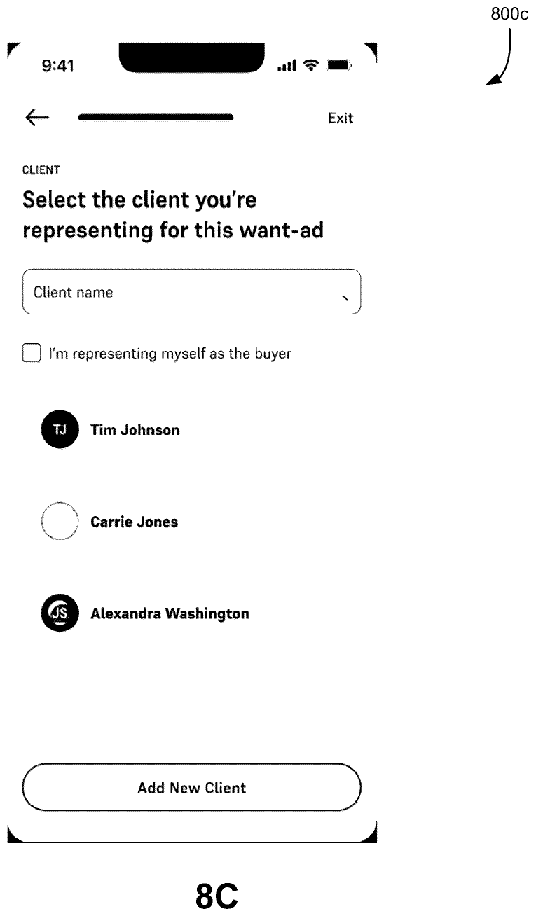

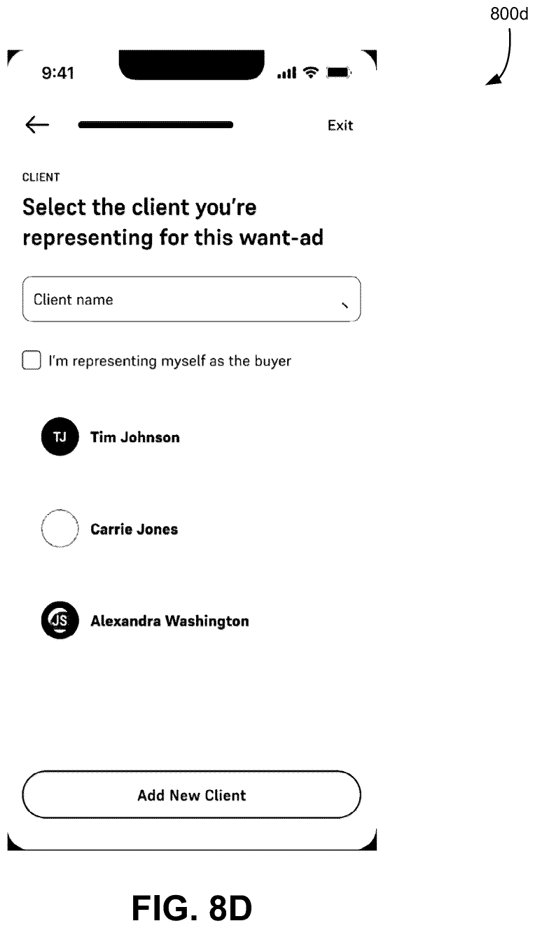

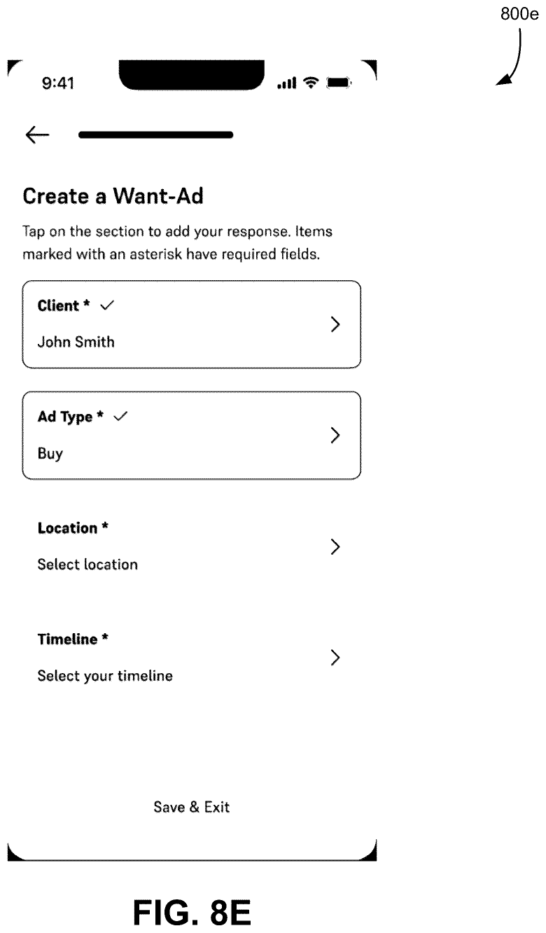

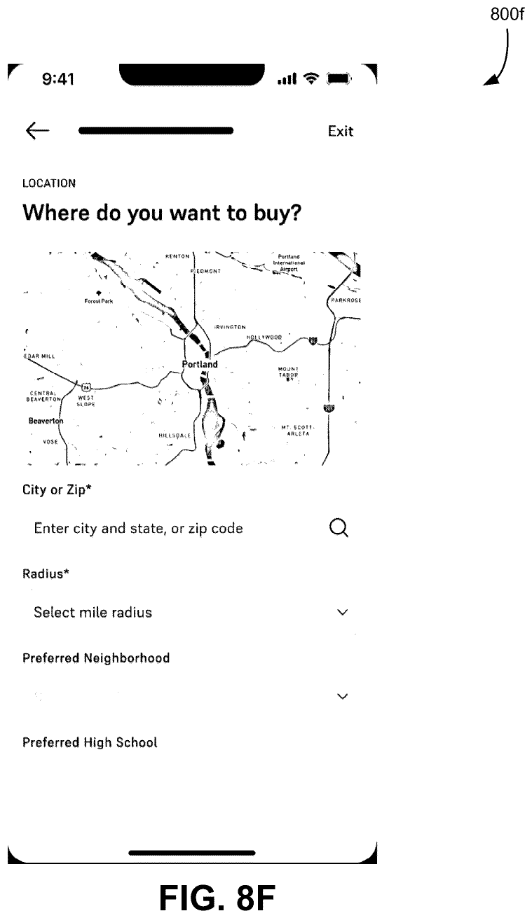

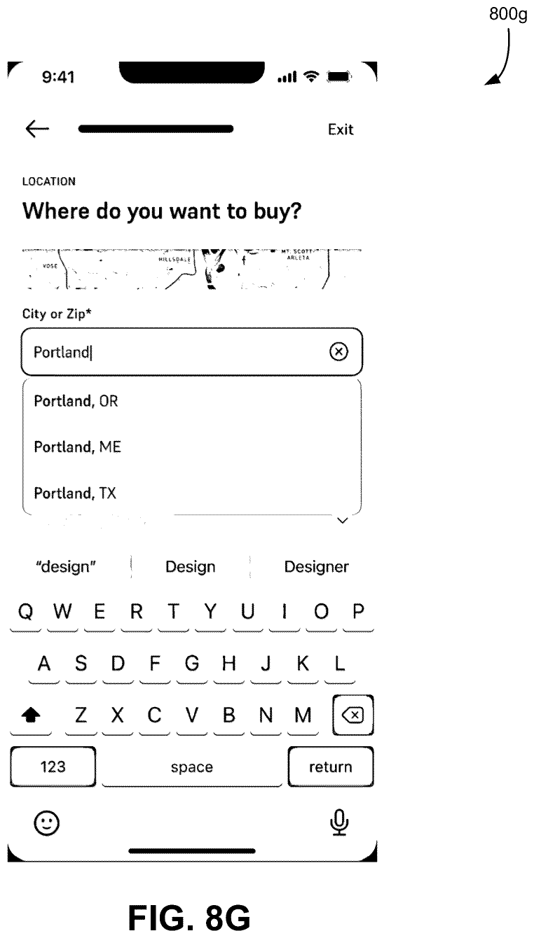

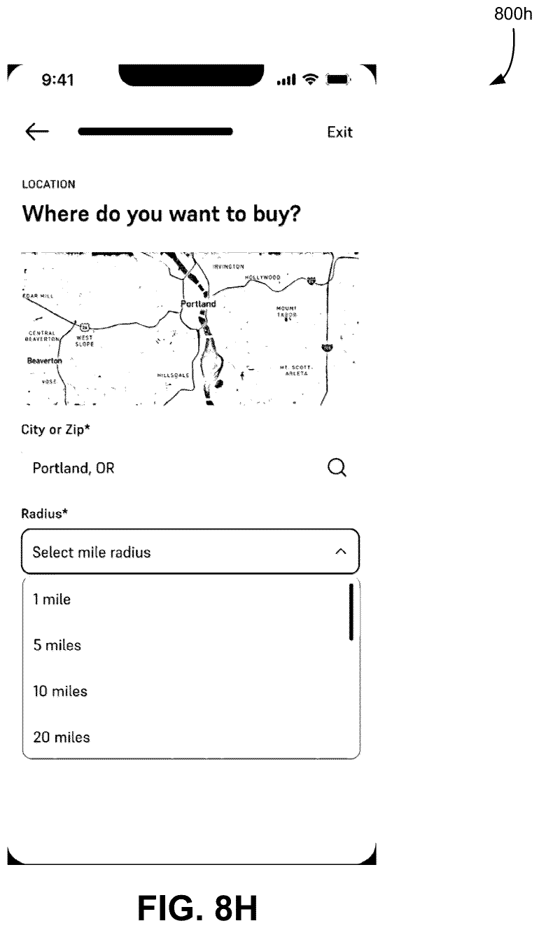

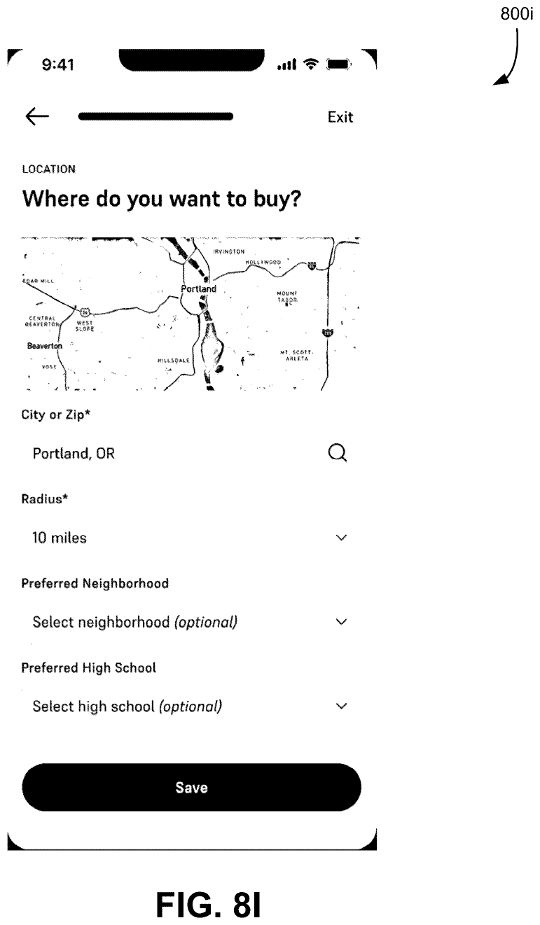

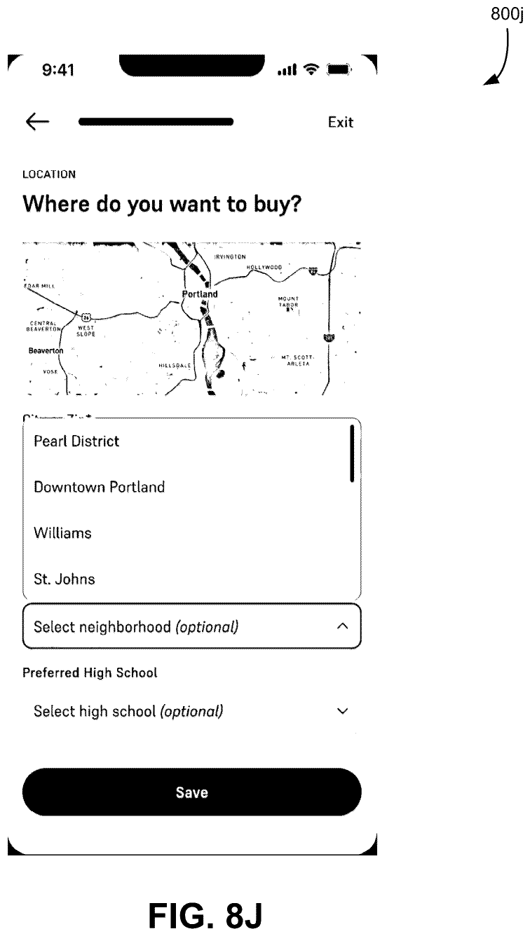

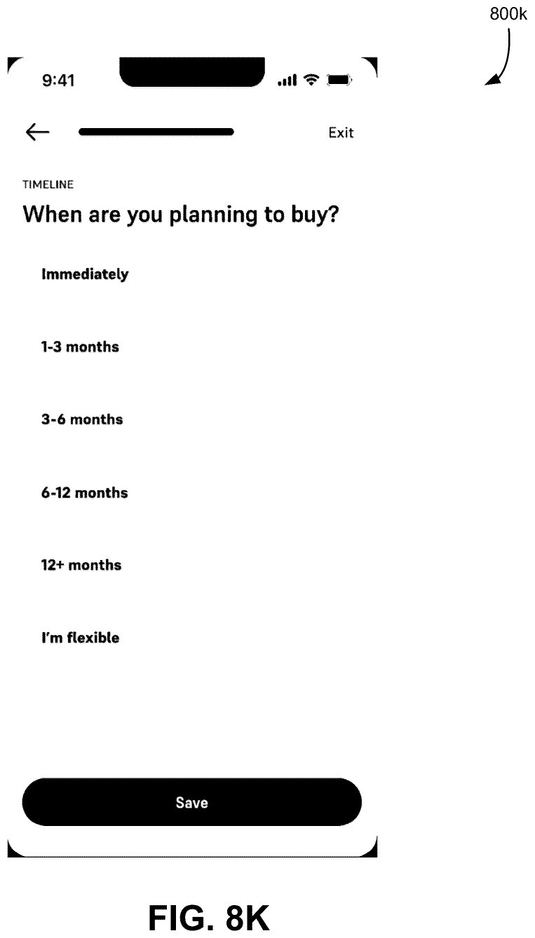

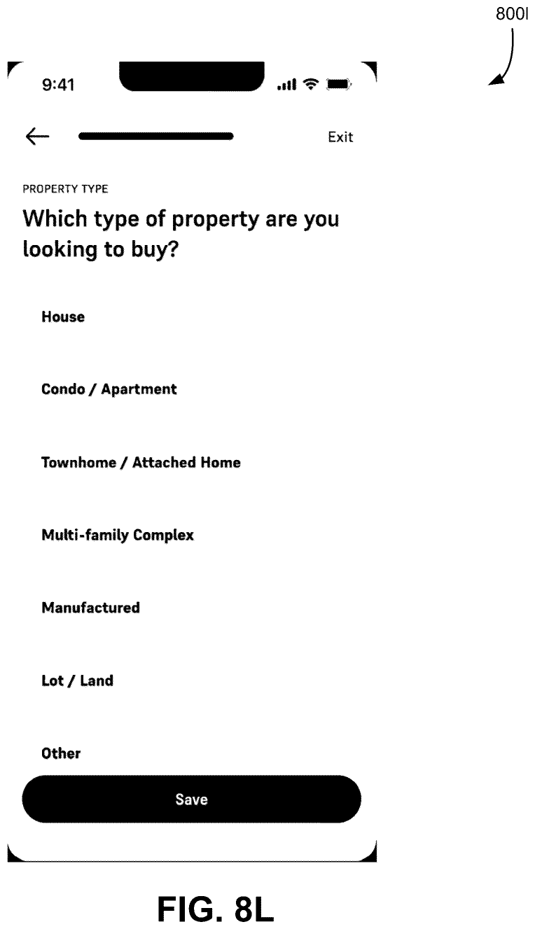

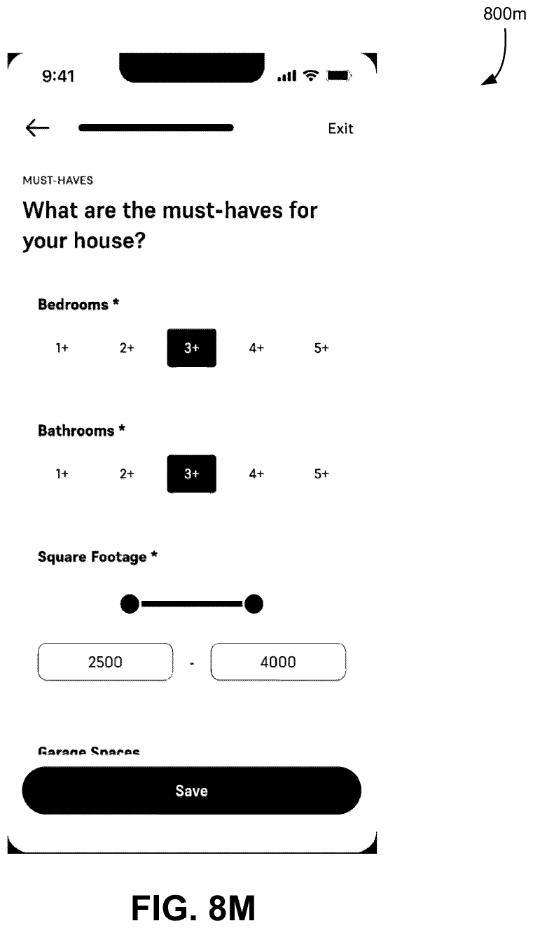

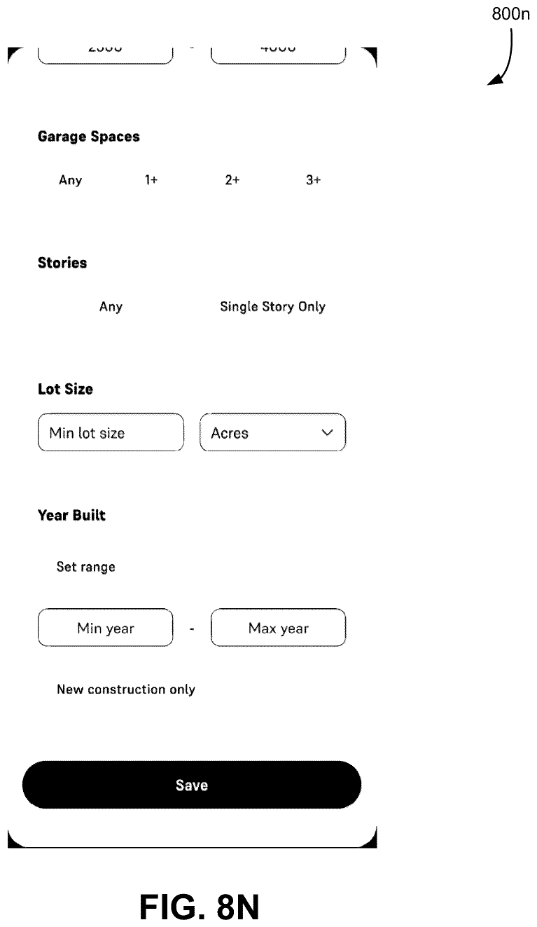

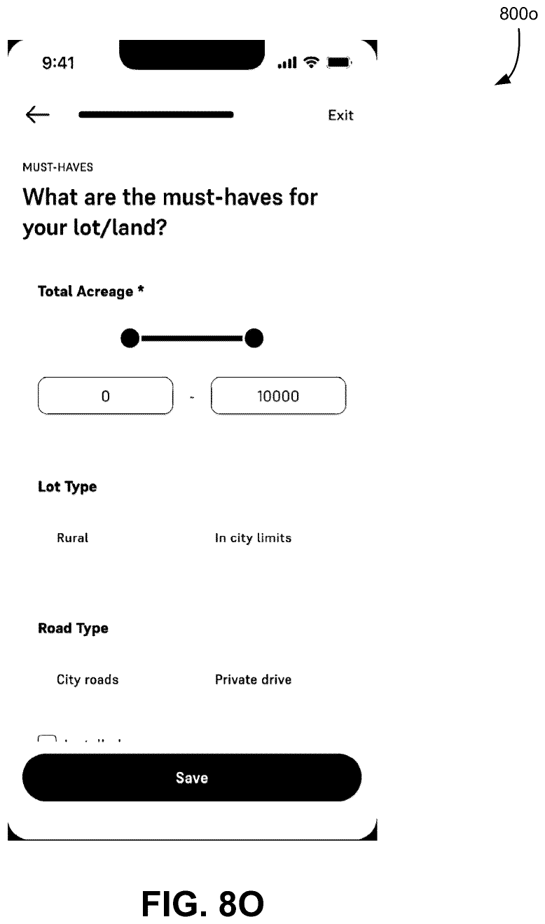

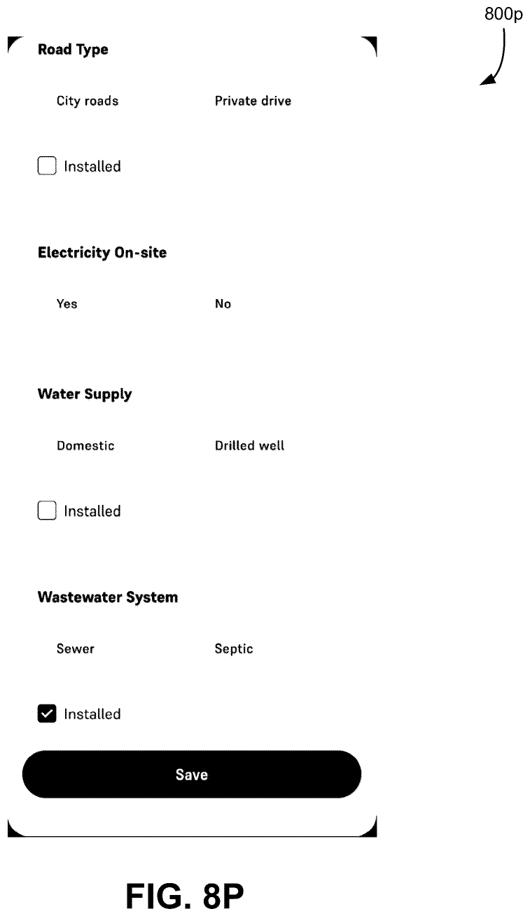

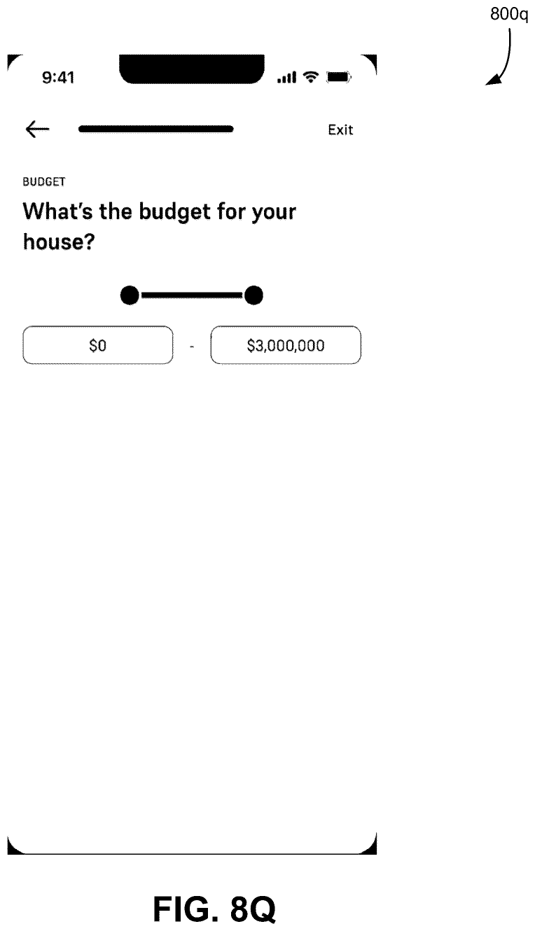

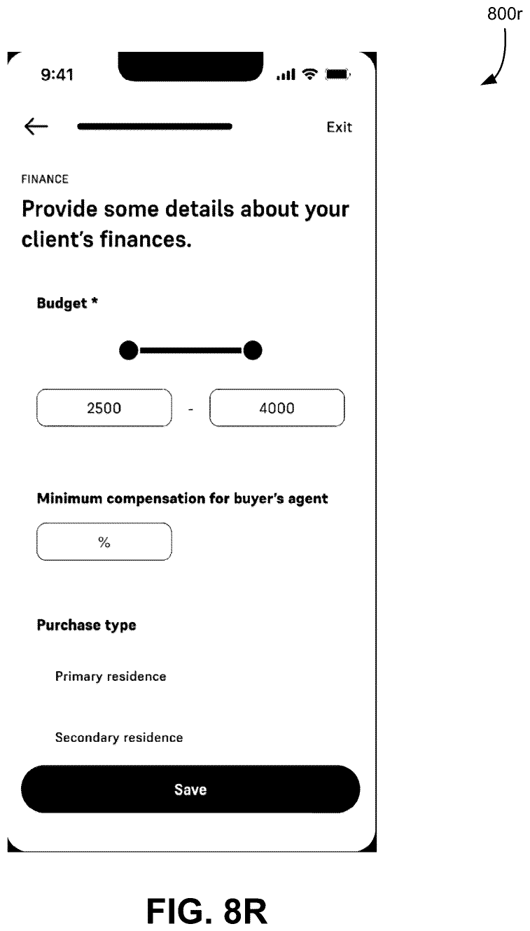

Various embodiments can prompt the user to input into the system what they are looking to do: buy or rent. The user in some examples can then post a want-ad in one of three types of designations, depending on what they are looking to do: Buy (Buy Ads), Long-Term Rentals (Rent Ads) or Short-Term Rentals (Stay Ads), as illustrated in view 800a of FIG. 8A.

### Buy Ads

In various embodiments, the system may enable a Want Users to create a wanted-to-buy ad listing when they are seeking to find a property to purchase. Some embodiments may require the Want User to go through and provide minimum or first criteria for their want-ad listing in order for the system to be able to automatically send Property Users the buy want-ad listings that match the criteria of the properties they have.

For property that contains a dwelling, in some examples the ad type, location, timeline, property type, and a budget range are all parameters that can be required by the system in order to finalize a wanted-to-buy ad listing (e.g., as first or required criteria). However, in other examples, any suitable elements can be required or no elements can be required. Additionally, in some examples, the desired bedroom count, bathroom count, and square footage of the home can be required to finalize and post the want-ad listing. The system can call these categories ‘Must-Haves.’ For vacant land want-ad listings, in some embodiments, the only required information that must be provided to finalize and post a want-ad listing are location, size of property and budget range, as illustrated in view 800b of FIG. 8B.

For Want Users that are professional agents representing buyer clients (or any type of representative user), in various embodiments the agent can manage the want-ads of many customers. To keep track of clients and be able to sort and arrange their client want-ads, the system, in some examples, can enable agents to designate what client each want-ad listing is for (e.g., by associating a client identifier to the want ad or item). This information can be private in various examples, such that it may not be displayed anywhere publicly. In some example, this feature can be selectively enabled for professional agents. In some cases, the system can enable agents to add new clients and the client details, including contact information and bio and the like. Pairing clients with their want-ad listings can be a desirable feature in some examples for agents to stay organized and to keep confidential client information stored in separate places to avoid comingling private details with other clients. Examples of these features are illustrated in views 800c, 800d, and 800e in FIGS. 8C-8E.

As part of the wanted-to-buy listing, the Want User, in various embodiments, may map the area they are seeking to find the property in, and can provide a nearby address, zip code, or point of interest, to further narrow the seller or property users that will see their want ad or item. The Want User can adjust the map to the vicinity of the provided place or zip code and can establish an area of interest by proximity (e.g., measured in mile increments) from an address or point on a map. The mapping feature in some examples create specific boundaries to show any Property Users the areas the Want User is looking to purchase property in, as illustrated in views 800f, 800g, and 800h of FIGS. 8F-811.

The Want User in various embodiments then can provide their preferred neighborhood and preferred high school if they want or need to find a property in a specific school or neighborhood area within the mapped area, as illustrated in views 800i and 800j of FIGS. 81 and 8J.

In some cases, the system may enable a Want User to provide some key details for their desired purchase. First, they can disclose what their ideal timeline of the purchase will be as this can allow for Property Users to quickly identify if the want-ad listing fits their timeline as well. By proactively disclosing what their timeline to buy is, this may foster new opportunities and agreements with Property Users looking for similar timing and it can allow for avoiding many contingency purchase situations, as illustrated in view 800k of FIG. 8K.

As part of the want-ad listing, the Want User in various embodiments can list what type of property they are seeking and can be open to as many property types as possible. Or, they can be specific to one type. The options in some examples can include House, Condo/Apartment, Townhome/Attached Home, Multi-Family Complex, Manufactured, Lot/Land and Other, or the like. The options can be selected together or selected individually depending on what the Want User is looking for or is open to, as illustrated in view 800l of FIG. 8L.

The Want User in various embodiments can then provide all the ranges of their preferred property characteristics (e.g., bedroom count, bathroom count, and square footage), as illustrated in views 800m and 800n of FIGS. 8M and 8N. As part of these selections, the Want User in some examples may also be able to provide key additional information for their want-ad listing, such as information that is encouraged but not required (e.g., second criteria). For dwellings, the additional details can include quantity of garage spaces, stories of the home, lot size, and year built of the structure or if they prefer new construction only.

For a vacant land want-ad listing, the Want User in various embodiments can add in their lot-size requirement as (it is a base must-have criteria in some examples), and then can select features they are seeking such as if it's a rural property or in-city, what infrastructure they'd like to have in their property including the type of road, type of water supply, and what type of wastewater system the property has access to or is approved for, as illustrated in views 800o and 800p of FIGS. 80 and 8P.

The Want User in various examples, can also provide their budget range as part of their want-ad listing (e.g., so the system can match the properties of Property Users to the Want User's stated price range), as illustrated in view 800q of FIG. 8Q.

In various embodiments, Want Users who are agents representing their buyer clients can also have the ability to state what their requested minimum compensation is for representing their buying client, requested to be paid by the seller should an agreement to purchase be executed and closed. By proactively stating their compensation request in the want-ad listing, this can ensures that the seller or selling agent understands they will be responsible for paying a commission to the representing agent as part of closing on any transaction, and the seller or selling agent will see the commission information disclosed as part of the requirements. And, for the agents representing buyer clients, it can allow them to advocate for being compensated should the Property User present a potential opportunity to the agent for their client, as illustrated in view 800r of FIG. 8R.

After all (or some in various examples) of the buyer's must-haves in the want-ad listing have been provided (e.g., first criteria), in various embodiments the Want User can elect to add additional feature information for what they need or want in a property, key features they want to have in their property purchase. These may generally be referred to as secondary or secondary criteria. This category of information can be labeled in the system as ‘nice-to-haves’. These features in various examples are not required to be detailed by the Want User, but utilizing this part of the platform to be as specific as possible can be desirable communicate precise details to anyone reviewing the listing, and it can result in more precise properties being proposed by Property Users.

The nice-to-haves feature list for properties with dwellings can be broken down into five categories in some embodiments: property features, layout features, exterior features, interior features and other features. For vacant land nice-to haves, the two categories of features can be related to views and characteristics of the property in some examples.

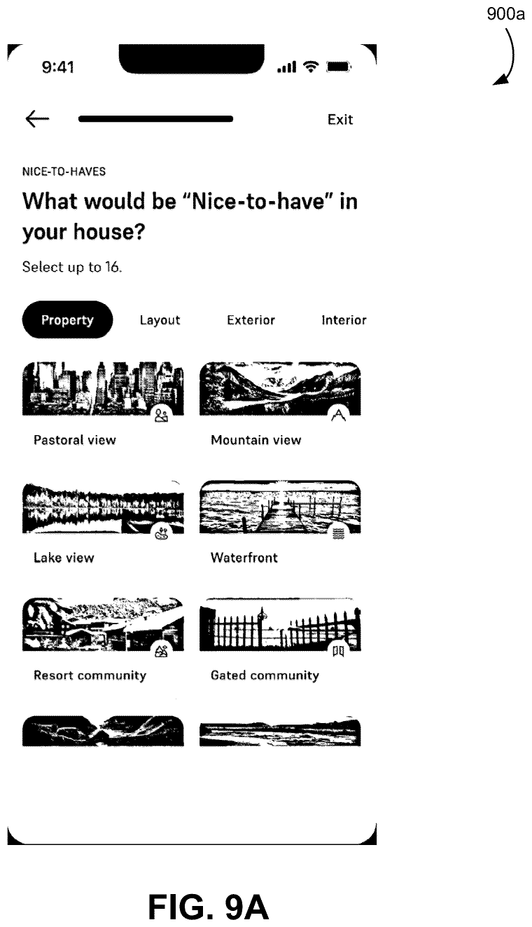

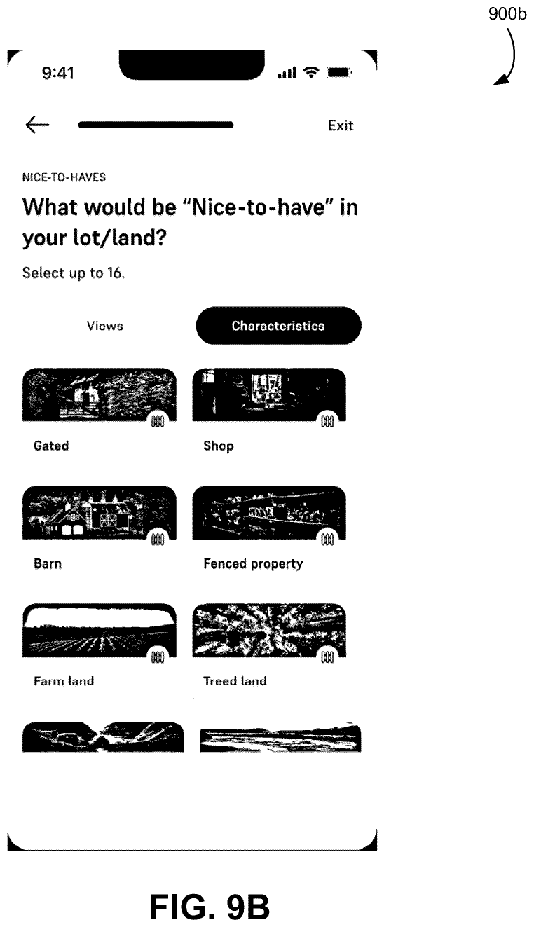

The nice-to-haves in various embodiments can include many features in each category for the user to provide detailed information of their wants & needs to Property Users. This step in the want-ad listing process may not be required in some examples as the system in some implementations will not send want-ad matches to Property Users based on the set of ‘nice to haves’ information, but the more information provided by the Want User can result in higher quality introductions and connections in some embodiments, as illustrated in views 900a and 900b of FIGS. 9A and 9B.

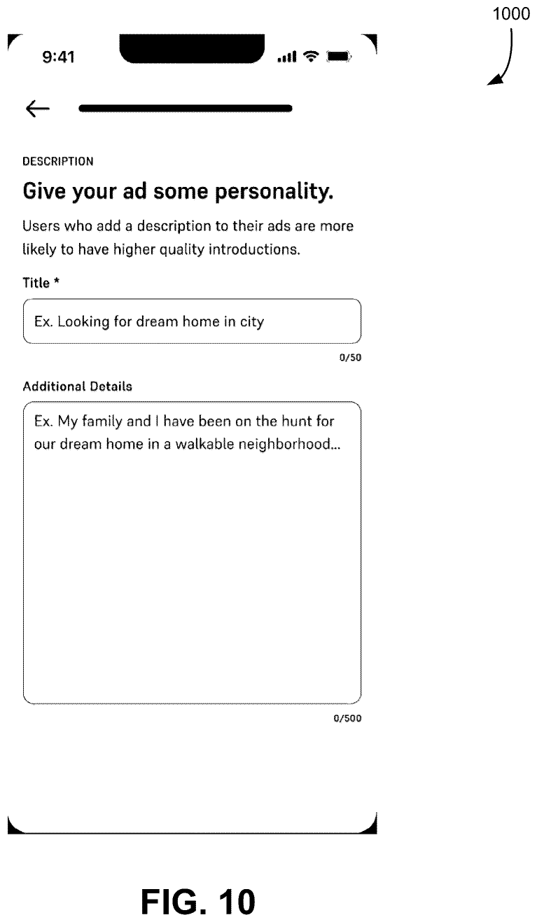

Before completing the buy want-ad listing, in various embodiments, the Want User can title their want-ad listing and can choose to write a narrative that will help explain what they are looking for in greater detail. The narrative can allow them to be as descriptive or as brief as they prefer, (e.g., up to the character limit), details which may include personal or professional context and parameters of their decision. Information may include but is not limited to the ideal condition of a property, what and why they are looking for a particular feature, architectural influences they prefer, reasons for purchase, a more specific location of the property, etc., as illustrated in view 1000 of FIG. 10.

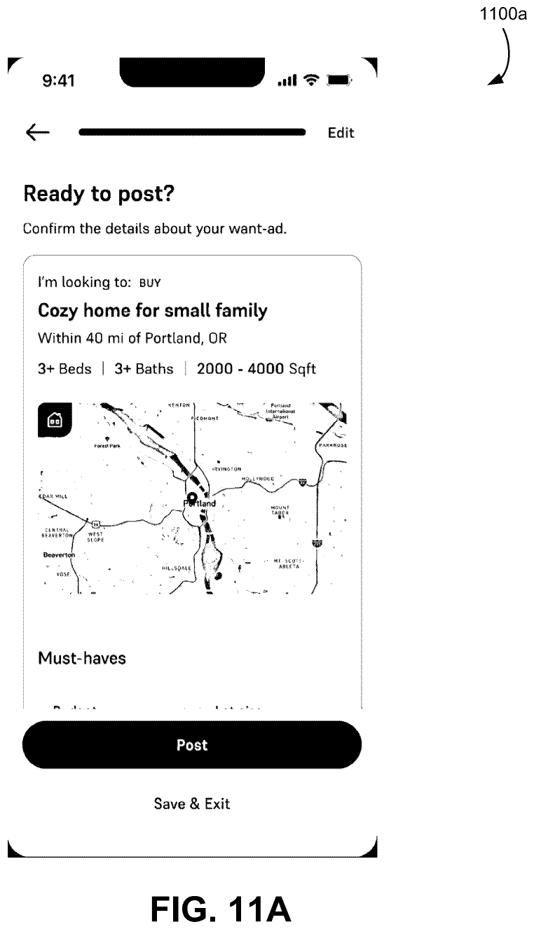

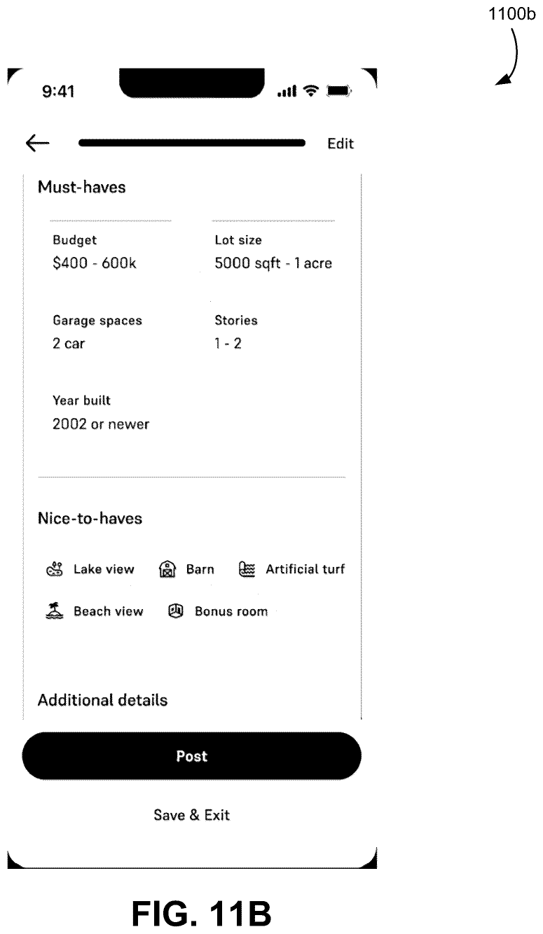

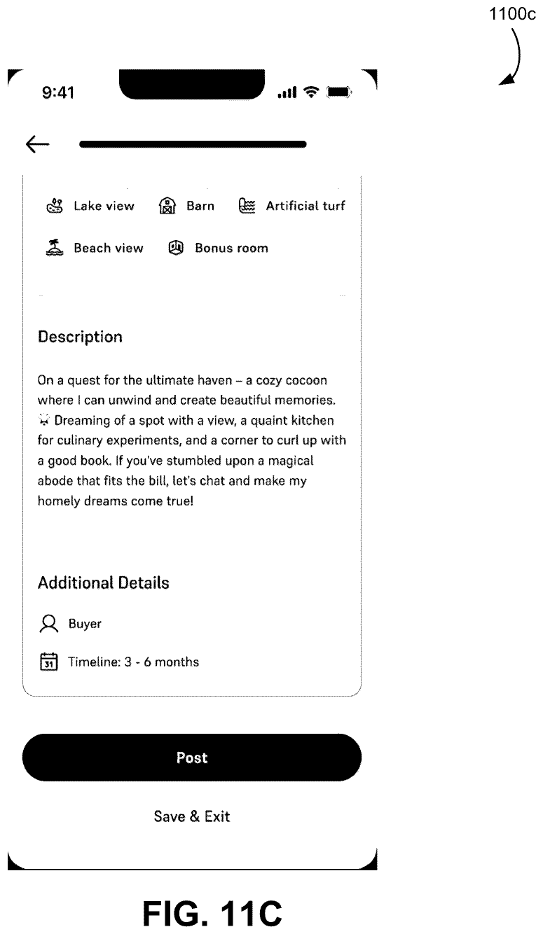

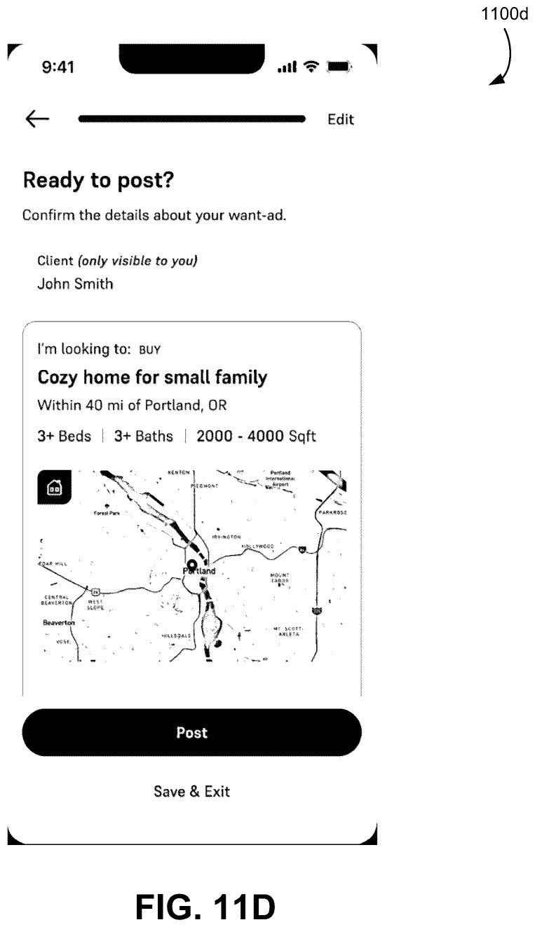

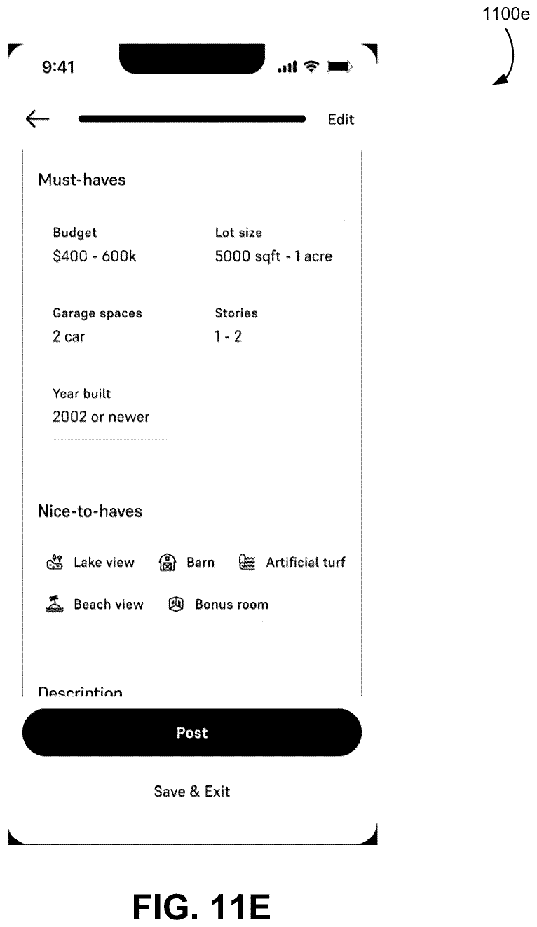

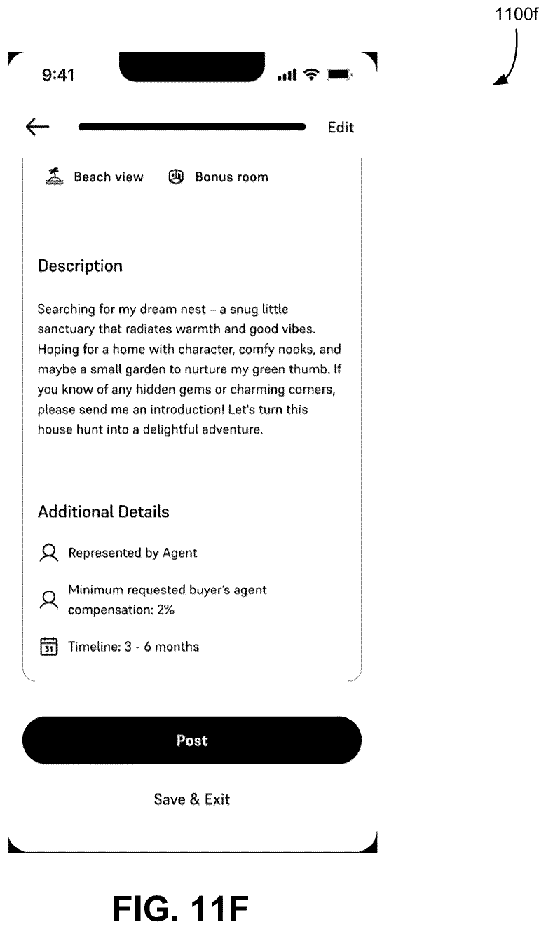

The Want User in various embodiments can be provided a view to review their post before it becomes public. As part of the review, they can, for example, review the ‘buyer information’ details where additional information is provided such as the timeline they are operating under as well if they are a buyer or a professional agent. The system in various examples can keep the identity of the user confidential at this stage, for example, to prevent any potential discriminatory activity as well as allowing the user to maintain their privacy until they and a Property User decide to connect privately. Once all the information and description and title for the want-ad listing is correct, the Want User can select ‘Post’ to make their want-ad live on the public want-ad listing marketplace, as illustrated in views 1100a-1100c of FIGS. 11A-11C.

For an agent posting the want-ad listing, in various embodiments, the agent user can review the post before it becomes public. But, in addition to verifying the standard information and description and title, the preview screen in some examples can show the agent what client file in the private dashboard the want-ad will be stored under, and they can have an opportunity to confirm the compensation category, as described above. The want-ad listing can identify that it was created by a professional agent and can list the minimum requested buyer's agent commission percentage. Once all looks correct, they can select ‘Post’ to make it live on the public want-ad listing marketplace, as illustrated in views 1100d-1100d of FIGS. 11D-11F.

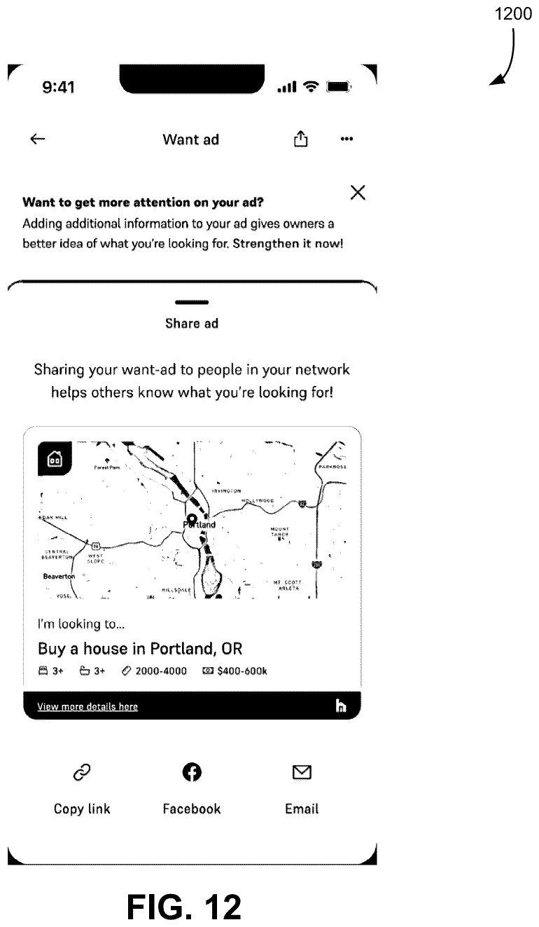

Once the buy want-ad listing is live, the system in various embodiments can provide the Want User an option to share the listing a variety of ways including via e-mail, the internet and on a variety of social media platforms, as illustrated in view 1200 of FIG. 12.

In various embodiments, at any time following the completion of the buy want-ad posting, the Want User can also provide more optional, additional criteria if they wish to add more context to the listing. The system in various examples calls this ‘strengthening the ad’. The Want User can provide this information at any time in various examples.

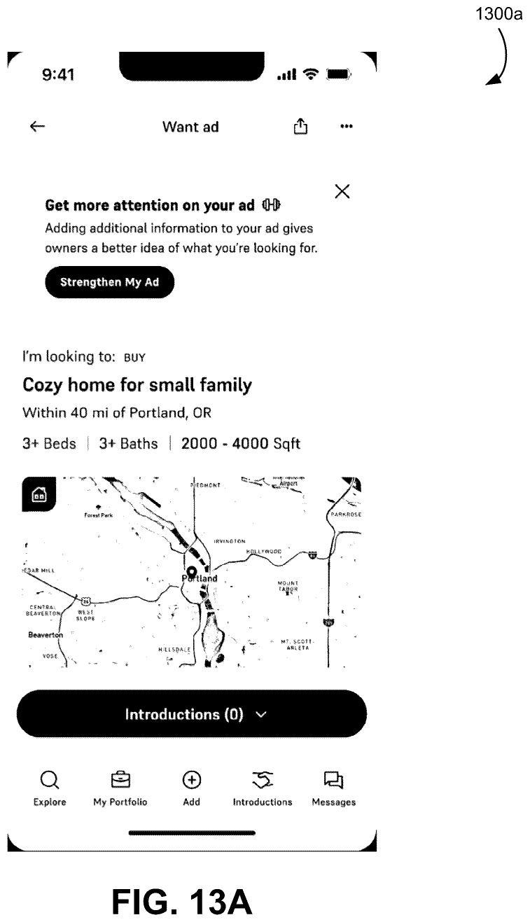

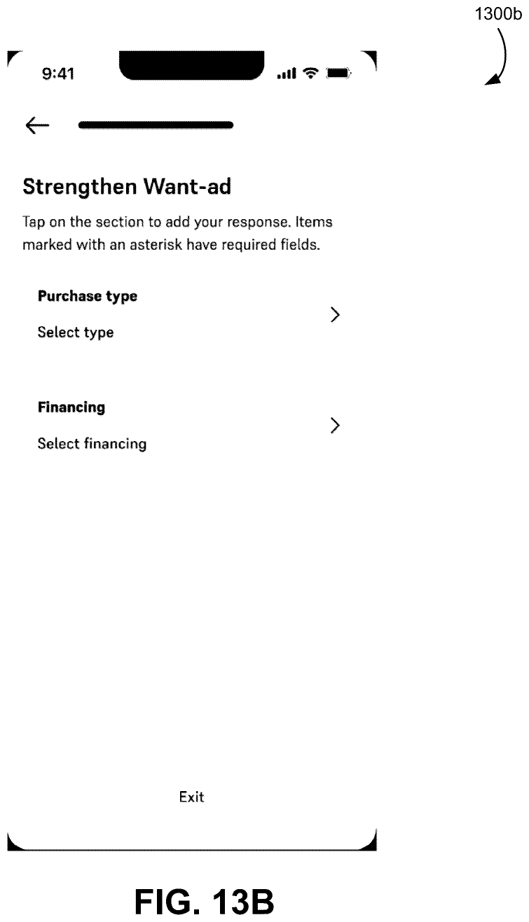

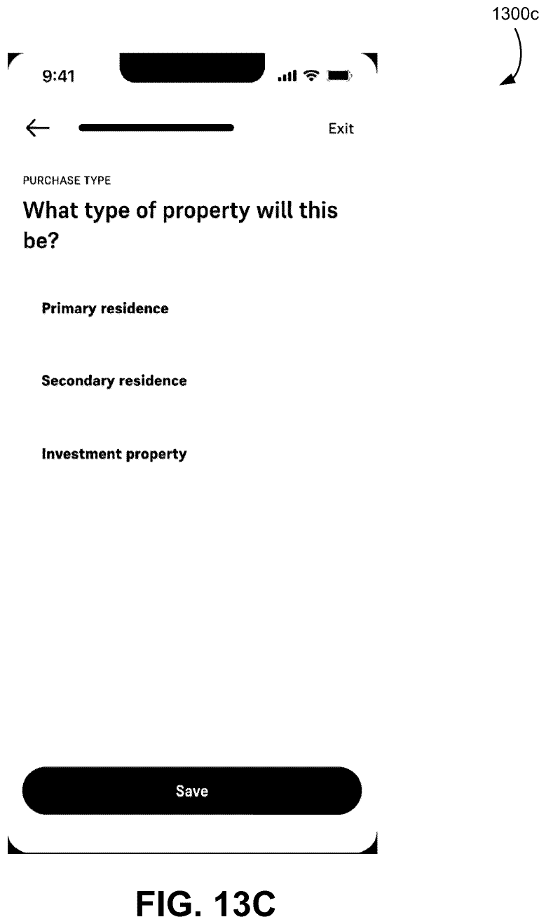

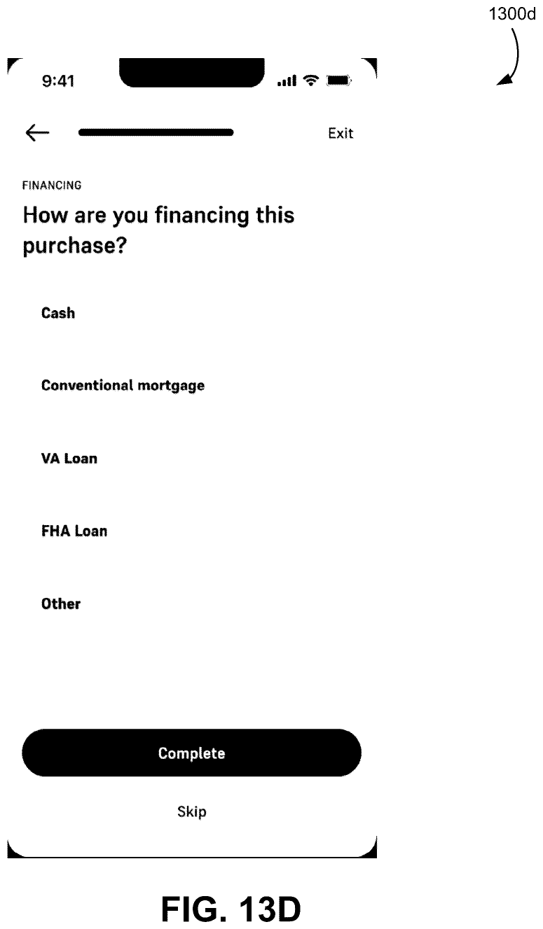

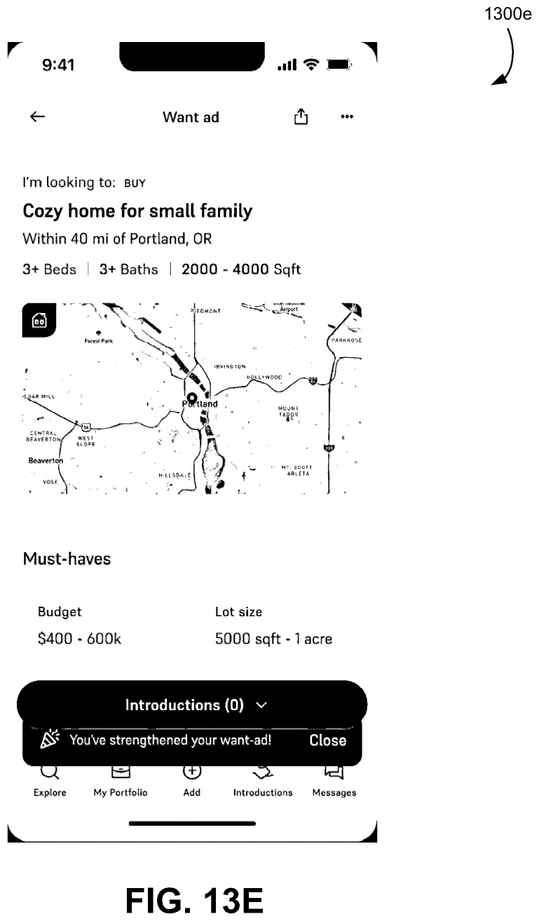

To do so, in various embodiments the Want User can select ‘strengthen my ad’ and can include additional information in their listing. The information may include but won't be limited to the type of purchase this will be for them (e.g., if it's a second residence, primary residence, or investment property, etc.), and how the buyer will be financing the purchase of the property (e.g., cash, conventional mortgage, VA loan, FHA loan, 1031 exchange or other). This information can be paramount in some examples for a Property User to decide if they want to propose their property to the Want User or not, as illustrated in views 1300a-1300e of FIGS. 13A-13E.

In various embodiments, both buyer Want Users as well as their agents can upload as many separate buy want-ads as they want to and in as many geographic locations as they need. In some cases, there may be no fee for a Want User to upload a want-ad listing in various examples.

### Long-Term Rent Ads Example(s)

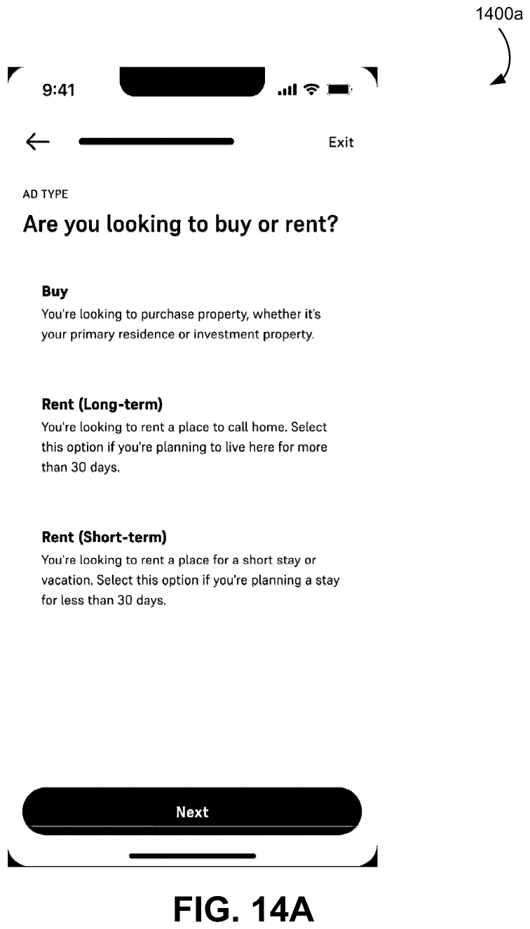

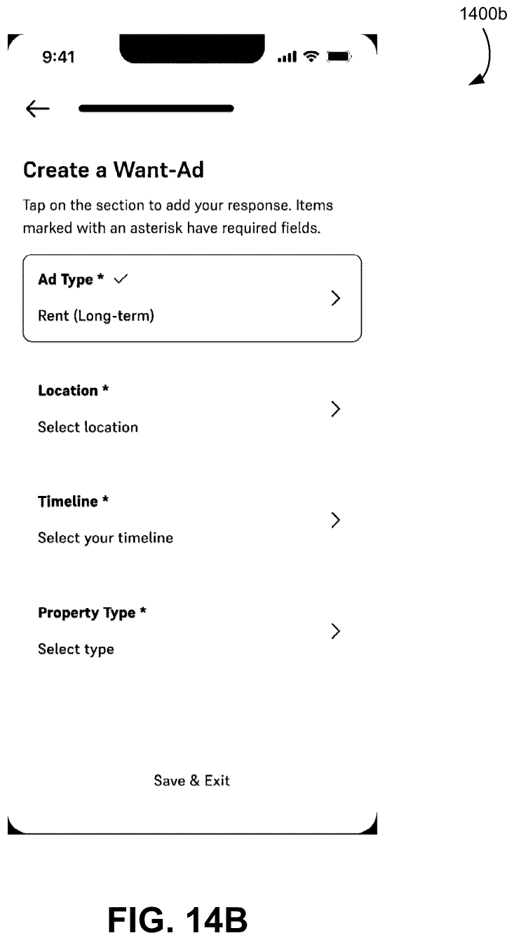

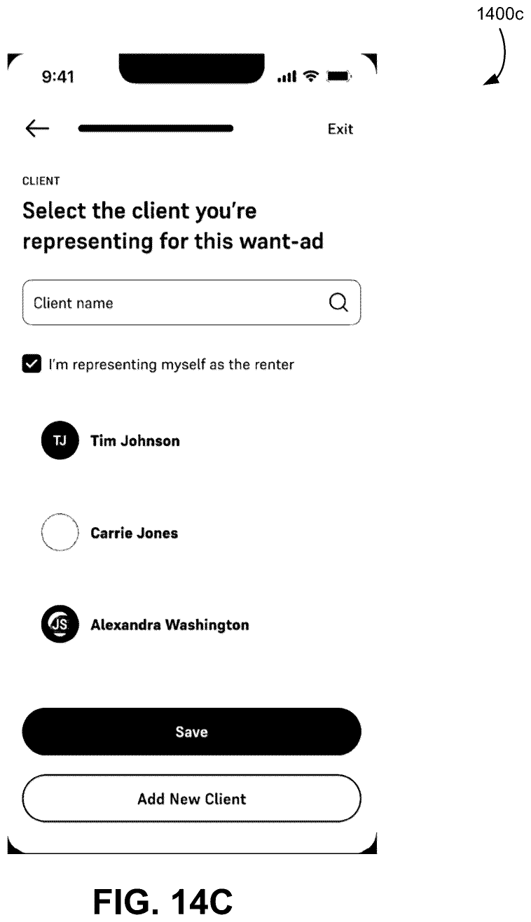

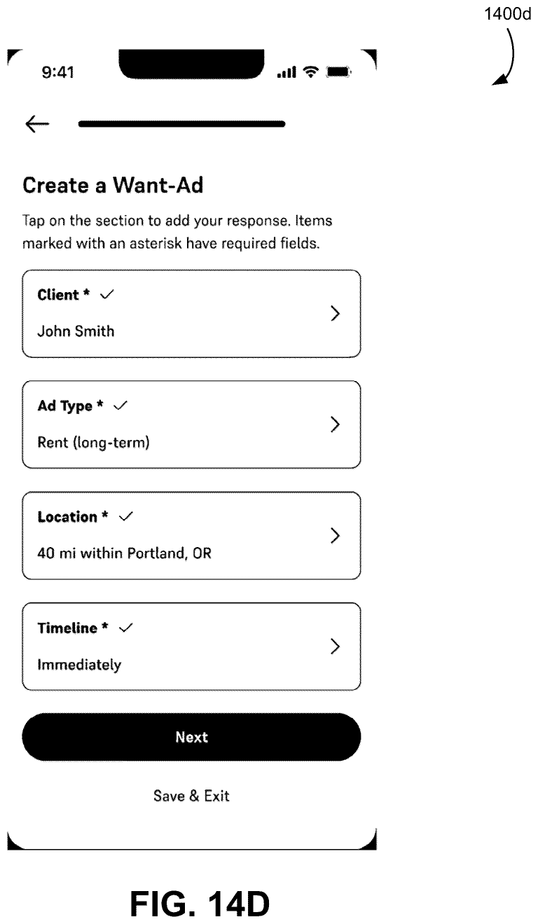

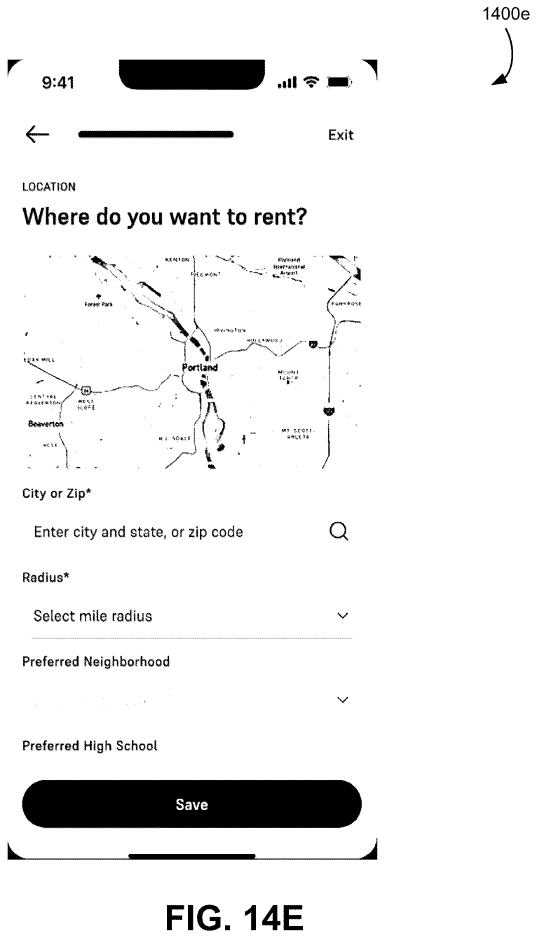

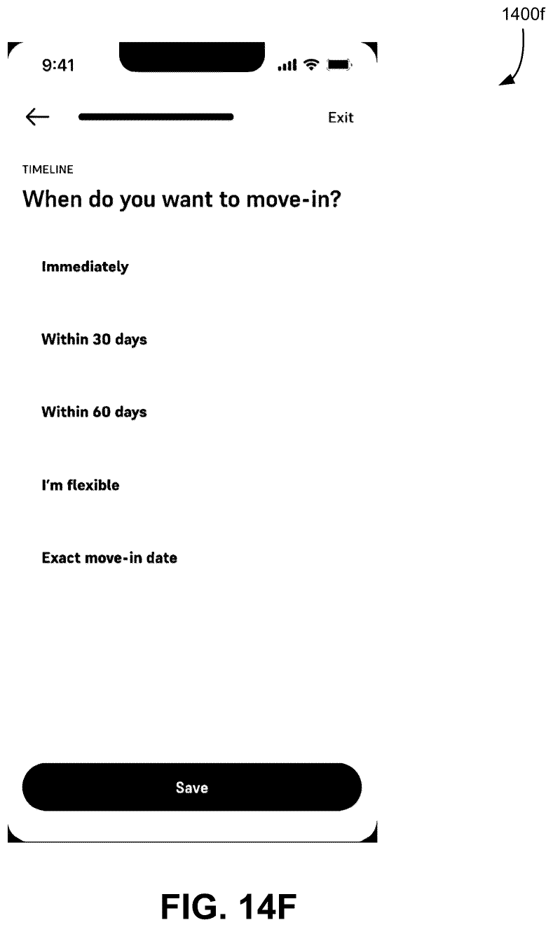

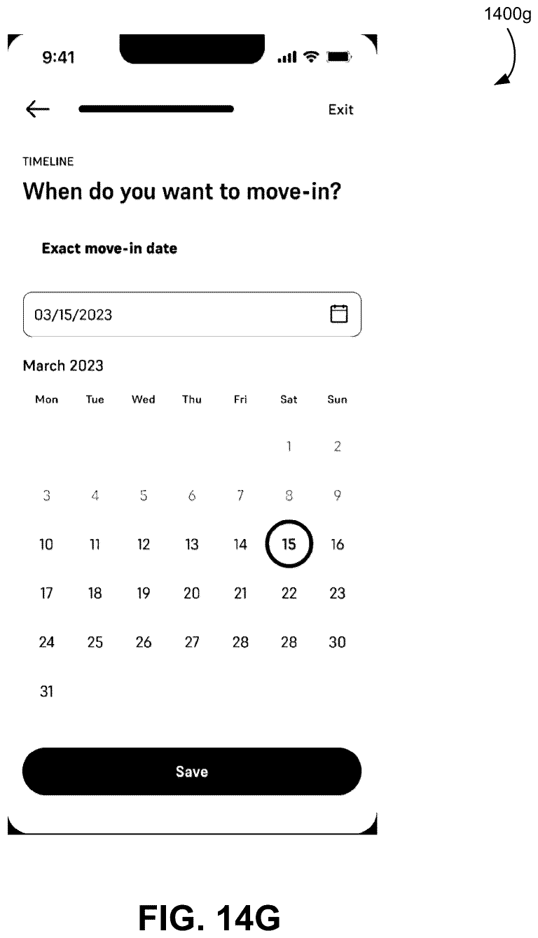

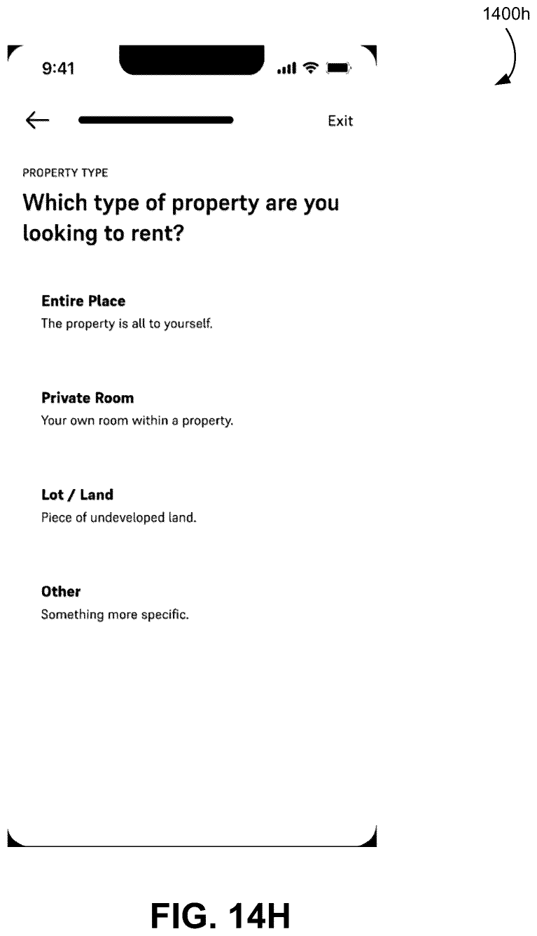

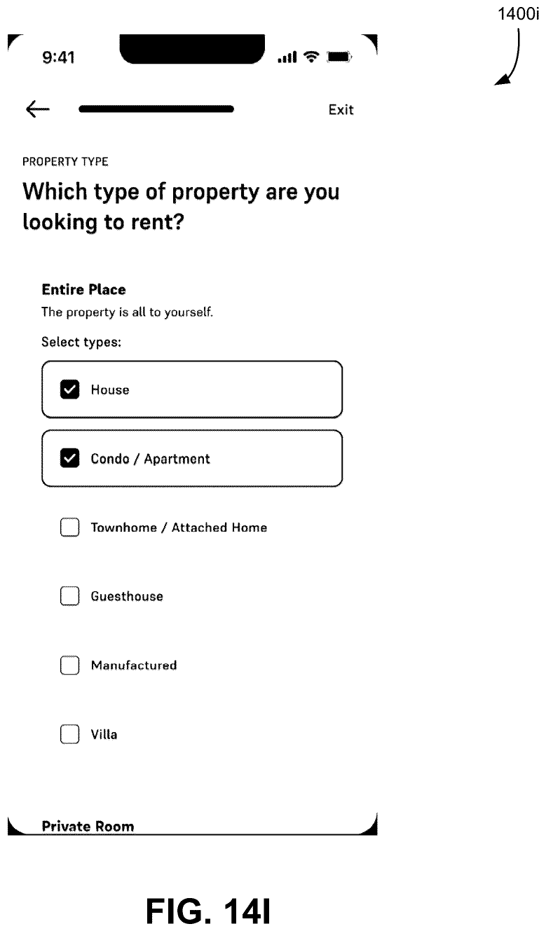

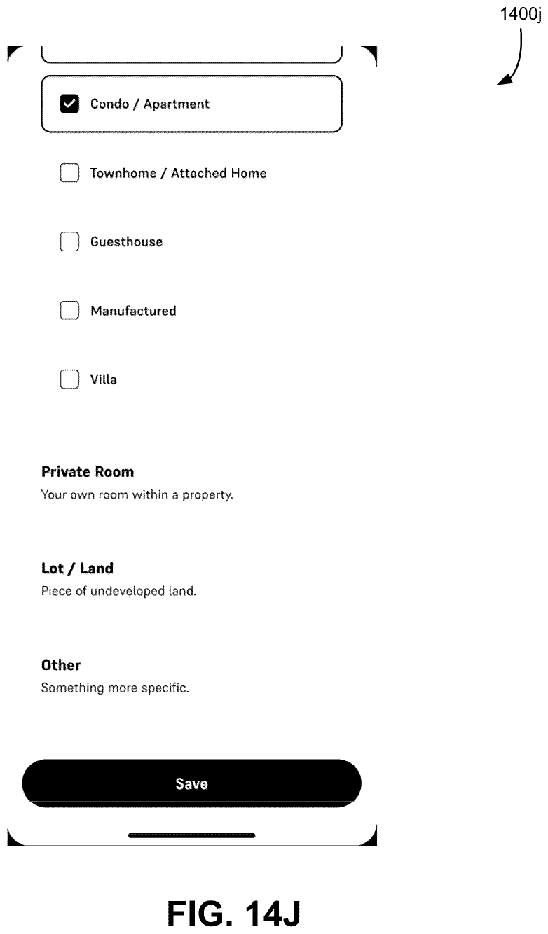

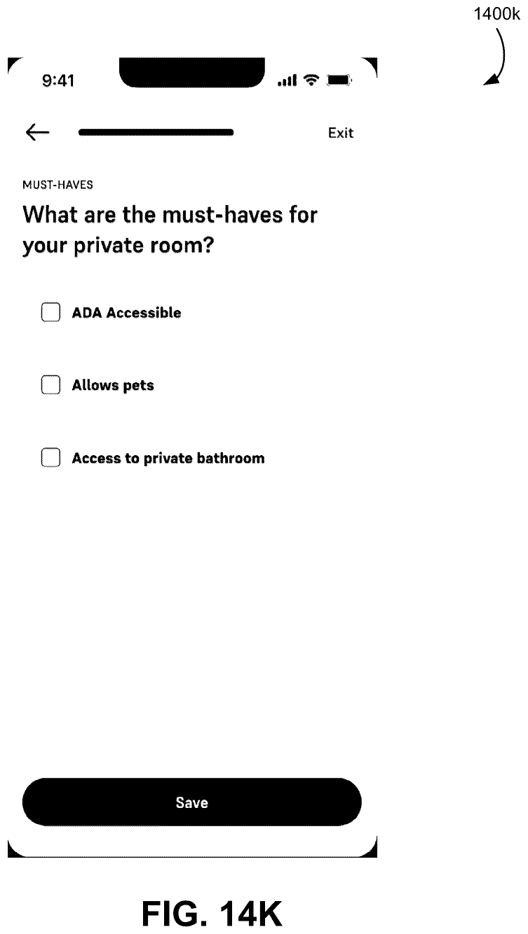

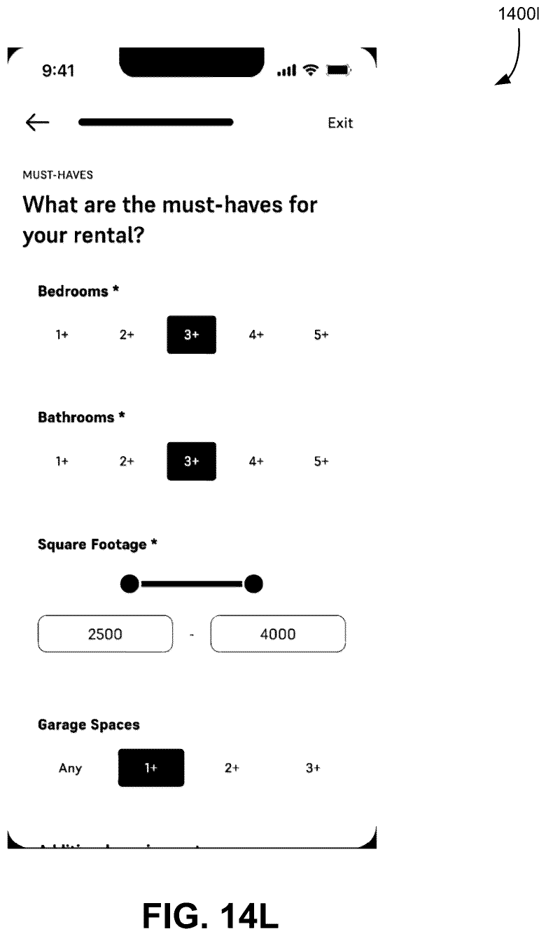

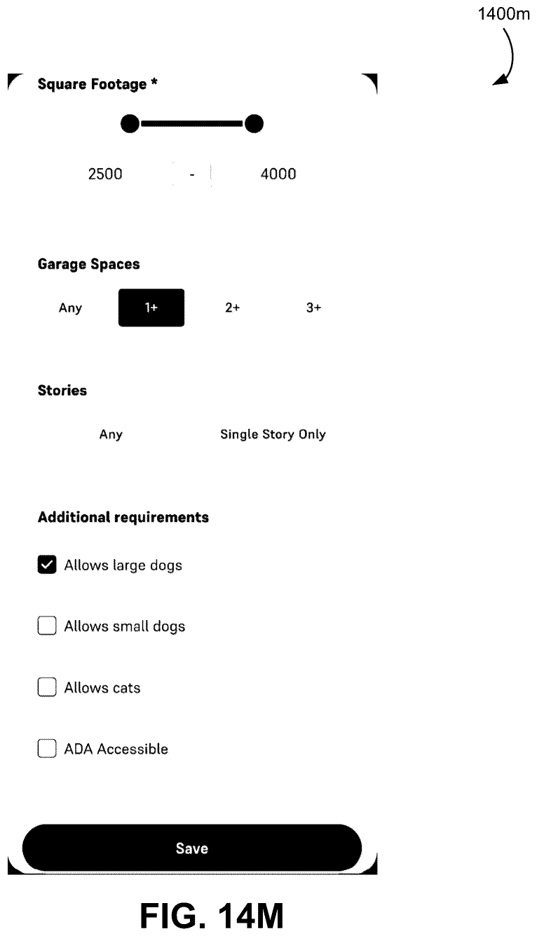

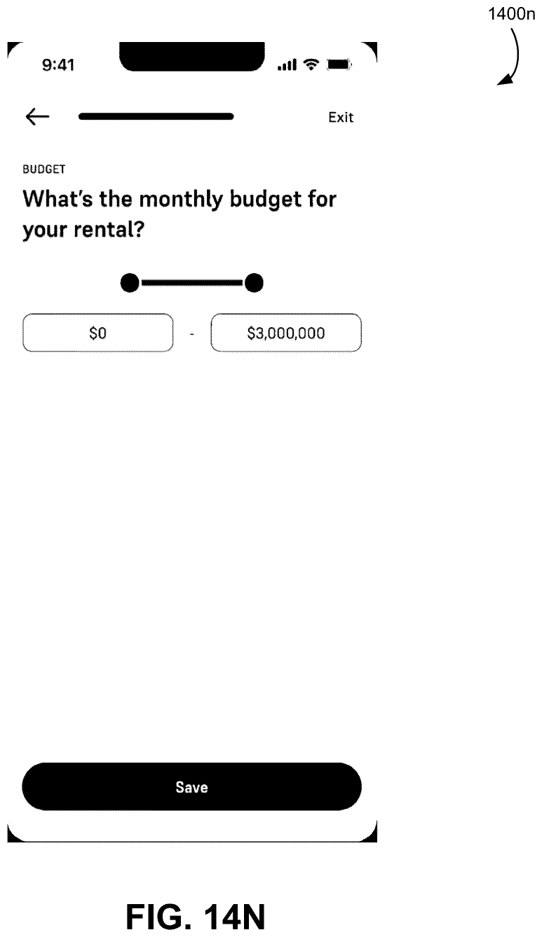

Similar to buy want-ad listings of various embodiments, long-term renters, and their agents (Want User) can create a rent want-ad listing when they are seeking a long-term rental (e.g., 30 days or longer). These frequently are primary residence rentals, often secured by a minimum of a one-year lease, as illustrated in view 1400a of FIG. 14A.

Like buy want-ad listings of various embodiments, the system of some examples can prompt the Want User to go through and provide minimum rental criteria so the system can send property owners, property managers or agents (Property Users) rental want-ad listings that match the specifications of their properties. For rental property with dwellings, in some examples the ad type, location, timeline for move-in, property type, and monthly budget are all parameters that the system may ingest (e.g., first or required criteria) in order to finalize a rental want-ad listing; however in some examples, any suitable minimum requirements can be set or no minimum requirements may be required. For land, the only required criteria for a rental want-ad listing in some examples is size of property, as illustrated in view 1400b of FIG. 14B. However in some examples, any suitable minimum requirements can be set or no minimum requirements may be required.

For agents and managers representing renters, in various embodiments they can manage the want-ad listings of many customers. To keep track and be able to sort and arrange their client's want-ads, the system may also prompt them to designate what client this long-term rental want-ad listing is for. The system in some examples can allow them to add new clients and other information, including the client's contact information and a bio. The client's name and information can be private and will not be displayed anywhere publicly in some embodiments, and this dashboard feature will only be for real estate agents and property manager users in various examples, as illustrated in views 1400c and 1400d of FIGS. 14C and 14D.

The Want User in various embodiments can map the area they are seeking to find the rental in, and can provide (e.g., a nearby address, point of interest, or zip code or the like) to create the area parameters in the listing. The Want User in various examples can adjust the map to a vicinity of the provided place, address, or zip code, establishing distance from the address or zip code in mile increments, in order to set the specific boundaries to show Property Users the areas they are looking to rent property in. The Want User in some examples can then choose to specify what their preferred neighborhood and/or high school area is in the mapped area, as illustrated in view 1400e of FIG. 14E.

The Want User in various embodiments can be prompted to provide the timeline of move-in. They can choose in some examples various suitable time frames (e.g., immediately, within 30 days, within 60 days), or if they are flexible or if they need it to be an exact move-in date for their needed rental. If they choose the exact move-in date, in some examples the system can provide the Want User a calendar feature to select the date, as illustrated in views 1400f and 1400g of FIGS. 14F and 14G.

The Want User in various embodiments can select what type of property they are open to renting. The property type with long-term rentals can include, for example, an entire place, a private room, vacant land or other or the like. The system in some embodiments can cater to a variety of renter circumstances. For example, if someone is looking for a roommate or just needs a single room, or if they desire to locate vacant land (to park an RV on, for example) or desire to find a full home. The user can select more than one property type in various examples if they are open to moving into different types of homes as well (e.g., house, condo/apartment, townhome/attached home, guest house, manufactured, villa, and the like). In various examples, more open they can be in their stated requirements, the more likely that they will get numerous property options presented to them by Property Users, as illustrated in views 1400h, 1400i, and 1400j of FIGS. 1411-14J.

If the Want User desires to find a private room for a long-term rental, in various embodiments they can be given the opportunity to select if they need an ADA accessible room, a room that allows pets, and/or if the private room has access to a private bathroom, as illustrated in view 1400k of FIG. 14K.

As part of the specifications of the long-term rental want-ad listing of various embodiments, the Want User may enter in the ‘must-haves’, including bedroom count, bathroom count, and square footage (e.g., first criteria). Additionally, renters may or may specify the number of garage spaces they need, if they are seeking a rental that accepts certain pets, if they need a single story and/or a place that is ADA accessible (e.g., second criteria), as illustrated in views 1400l and 1400m of FIGS. 14L and 14M.

The Want User in various embodiments can then (e.g., in some cases, be required to) enter the monthly budget range for their rental before proceeding, as illustrated in view 1400n of FIG. 14N.

Agents representing long-term rental clients in various embodiments can also state what their requested minimum compensation is to represent their rental client, paid by the owner or owner's agent should an agreement to rent be solidified and a contract signed. By proactively stating the compensation request in the want-ad listing, the agent representing the renter can ensure in various examples that the property owner or their agent understands that the property owner or landlord is responsible for paying a commission to the representing agent as part of signing any lease contract, and the Property User in various examples can see the commission information disclosed as part of the want-ad listing. For the agents representing rental clients, it can allow them to advocate for the professional services they are providing, as illustrated in view 1400o of FIG. 14O.

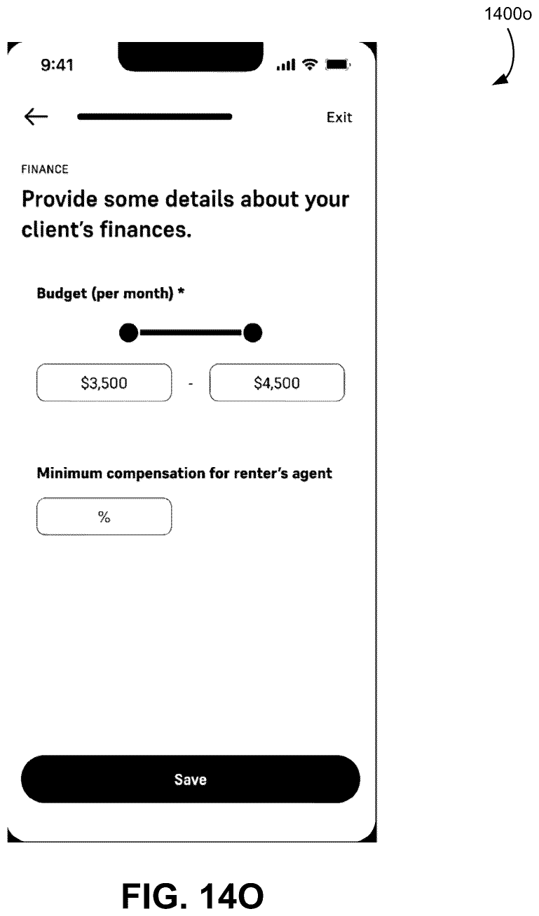

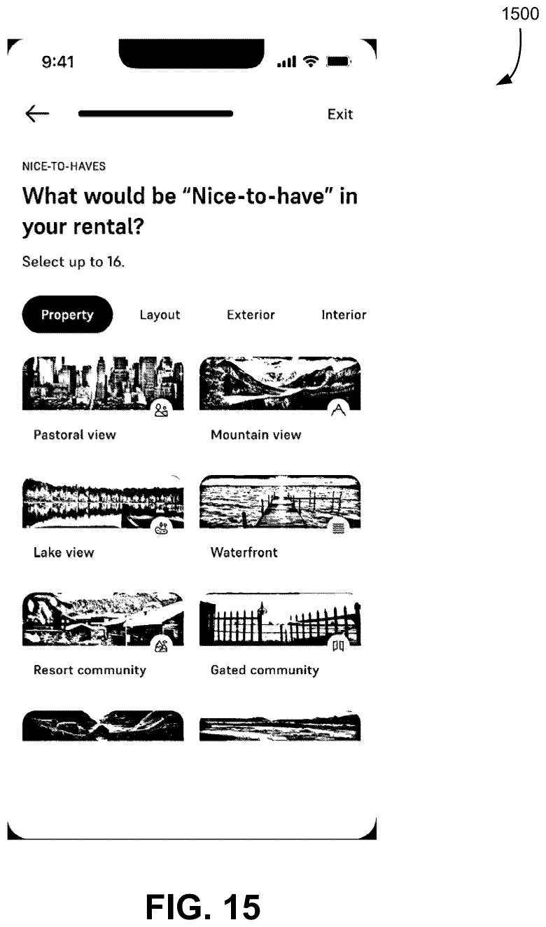

Like the buy want-ad listings of some embodiments, the long-term rental Want User in various embodiments can add more information and parameters for their rent-ad listing, details can, for example, further explain what features they are looking for in their desired long-term rental. This category of information can be labeled ‘nice-to-haves’ (e.g., second criteria). The feature list can be broken down into 5 categories in some embodiments: property features, layout features, exterior features, interior features, and other features. The system in various examples can list many features under each category for the user to provide additional information to any property owner or their agent. Features under the 5 categories for long-term rentals may include rental property amenities such as if the rental comes with a washer & dryer, pool, if the unit is part of a complex that includes a work-out facility, secured entry, etc. This step in the process may not be required in some examples because in some embodiments the system may not match any want-ads with an owner's properties based on the set of ‘nice to haves’ information, but in some examples it can result in more qualified introductions of potential rental properties to the Want User by Property Users, as illustrated in view 1500 of FIG. 15.

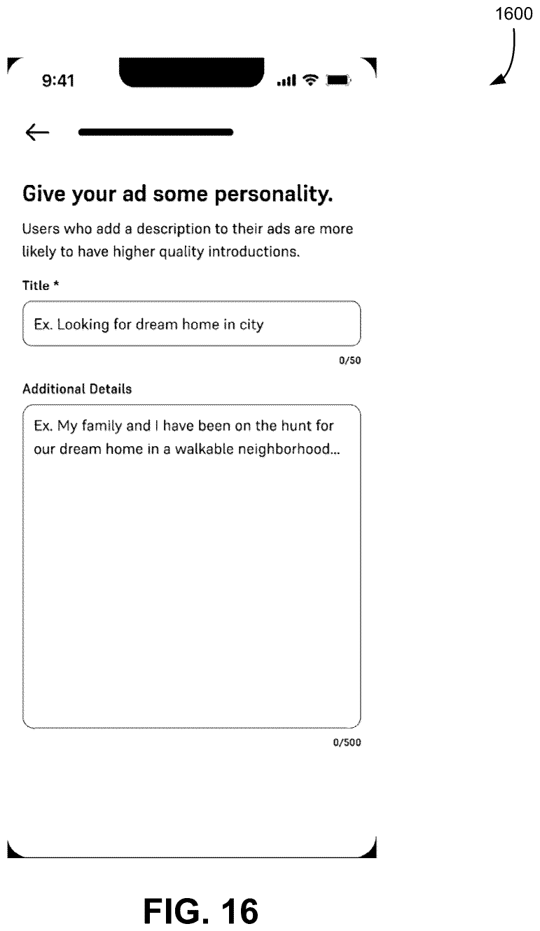

Similar to the buy want-ad listing process of some embodiments, the Want User in various embodiments may provide a title to their rental want-ad listing and can choose to write a narrative that can help explain what they are looking for in greater detail. The narrative can allow them to be as descriptive or as brief as they'd like, (e.g., up to the character limit), details which may include personal or professional context and parameters of their rental decision, as illustrated in view 1600 of FIG. 16.

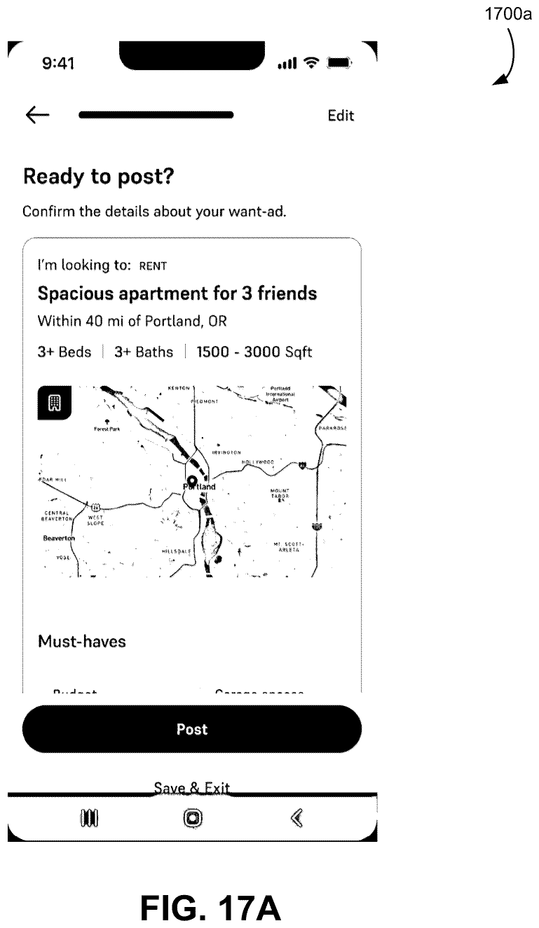

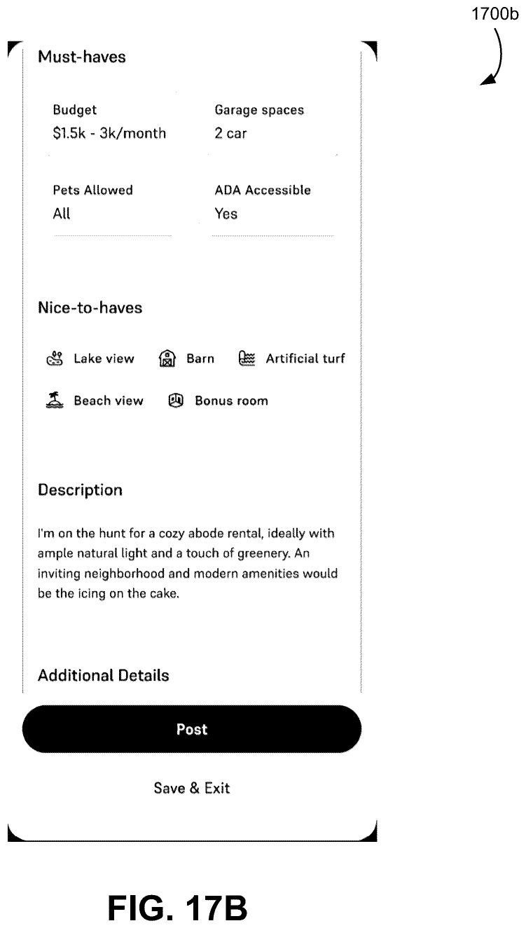

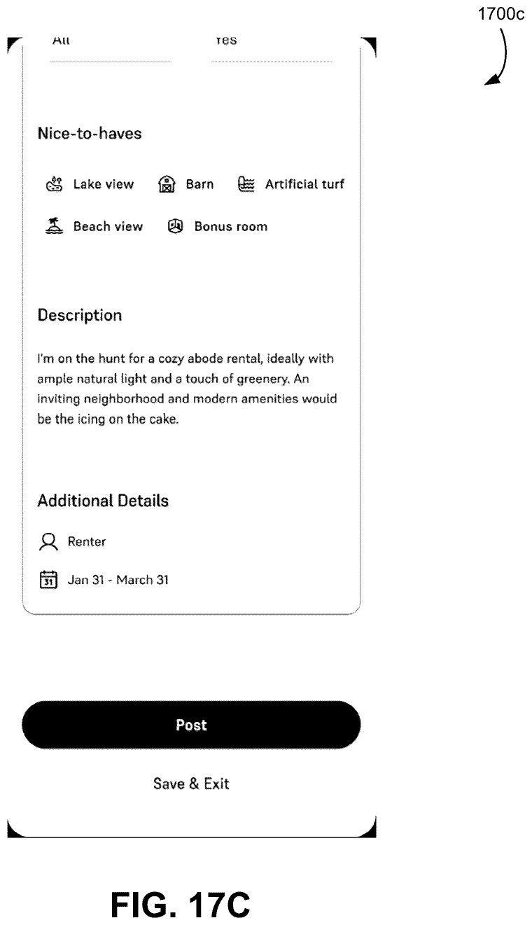

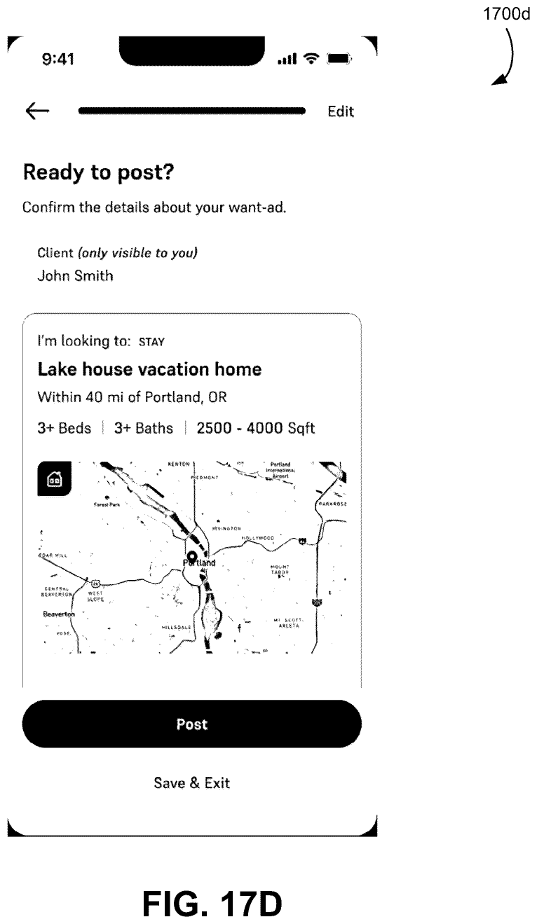

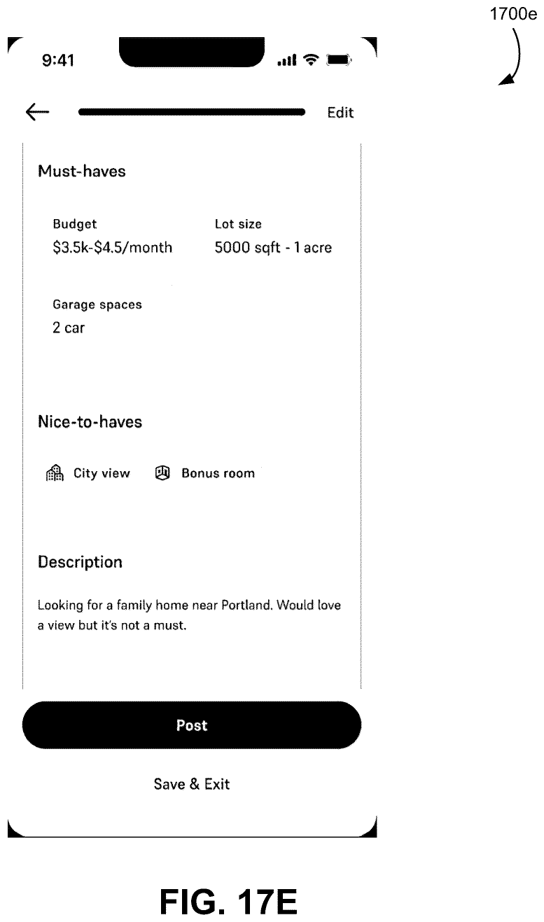

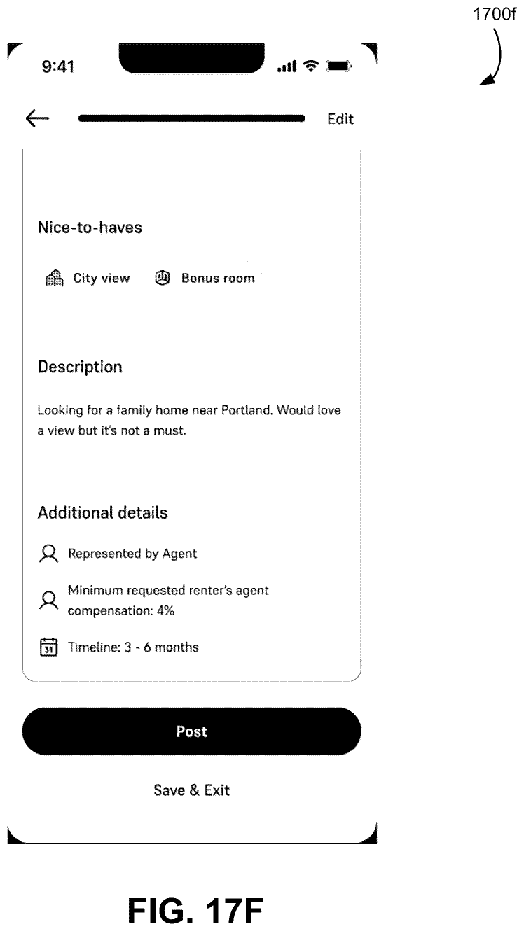

The Want User in various embodiments can be able to review their post before it becomes public. As part of it, in some examples they can review the ‘renter information’, where additional information can be provided such as the move-in timeline they selected and if they are a renter or a professional agent representing a renter. The system in various examples can keep the identity of the user confidential at this stage in the process in order to prevent any potential discriminatory activity as well as allowing the user to maintain their privacy until both parties decide to connect privately. Once all of the information looks accurate, they can select ‘Post’ to make it live on the long-term rental want-ad listing marketplace, as illustrated in views 1700a-1700c of FIGS. 17A-17C.

For an agent posting a want-ad for a renter client, in various embodiments they are able to review their post before it becomes public. The preview in some examples can show the client file the listing will be stored under in their private dashboard, the minimum requested renter's agent compensation percentage and it can identify that the listing was created by a professional agent. If all looks correct, they can select ‘Post’ to make it live on the want-ad listing marketplace, as illustrated in views 1700d-1700f of FIGS. 17D-17F.

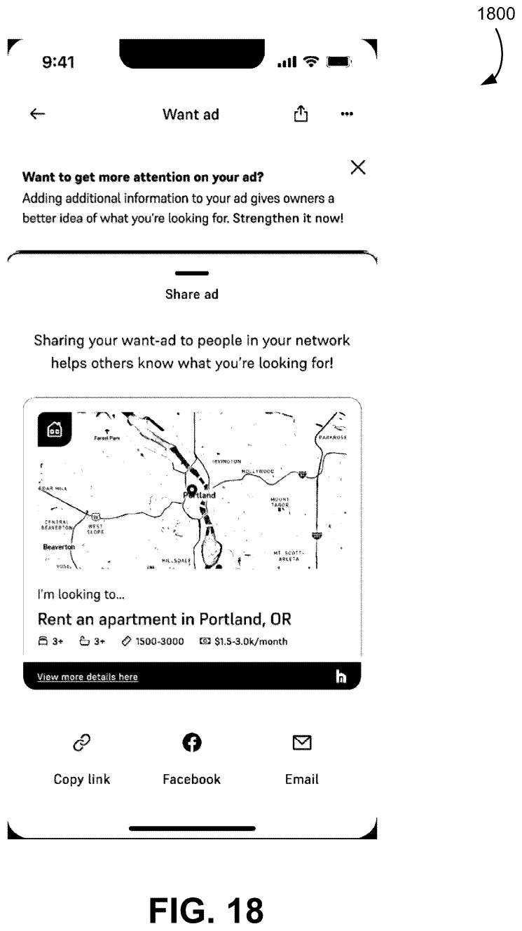

Once the long-term rental want-ad listing is live, the system in various embodiments can provide the Want User an option to share the listing a variety of ways including, for example, via e-mail, the internet and on a variety of social media platforms. The share title in some examples can differ than the custom title created by the Want User; for example, it can include the type of want-ad listing and area of want-ad listing, rather than the title of the ad itself, as illustrated in view 1800 of FIG. 18.

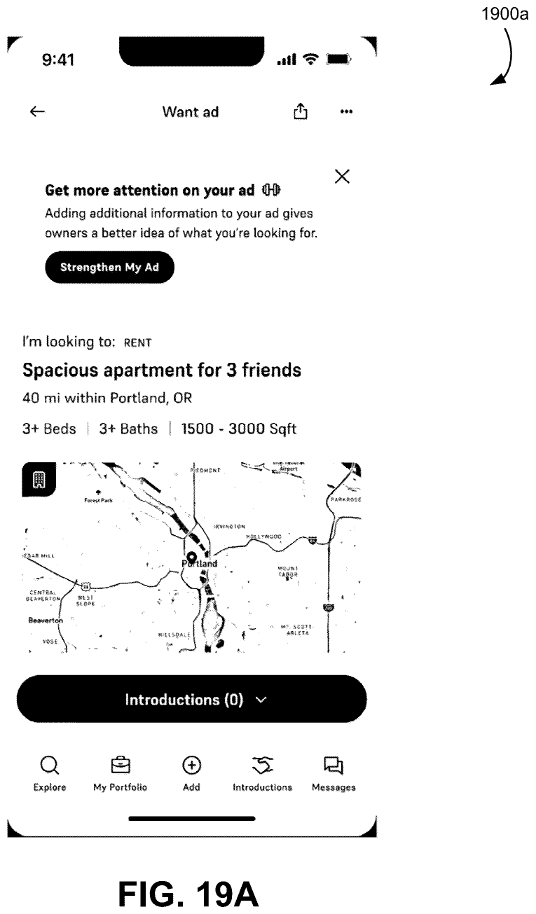

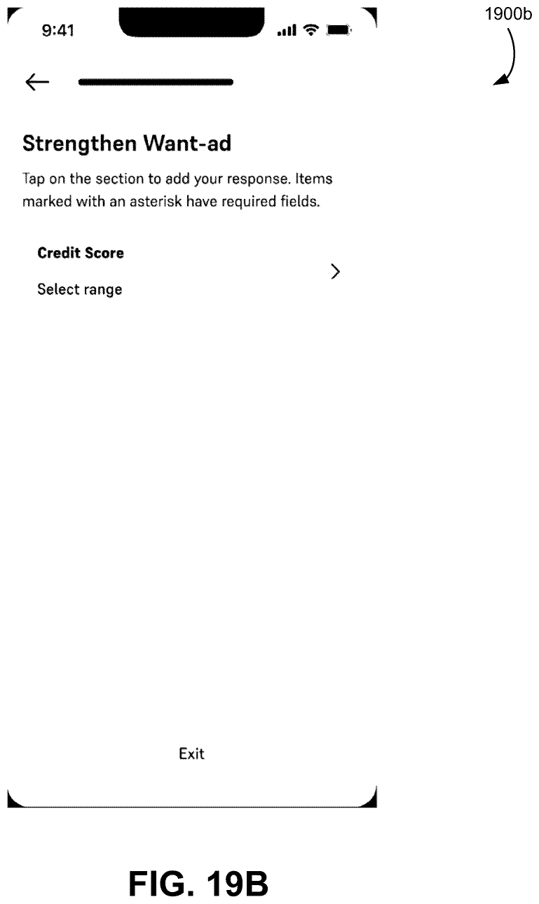

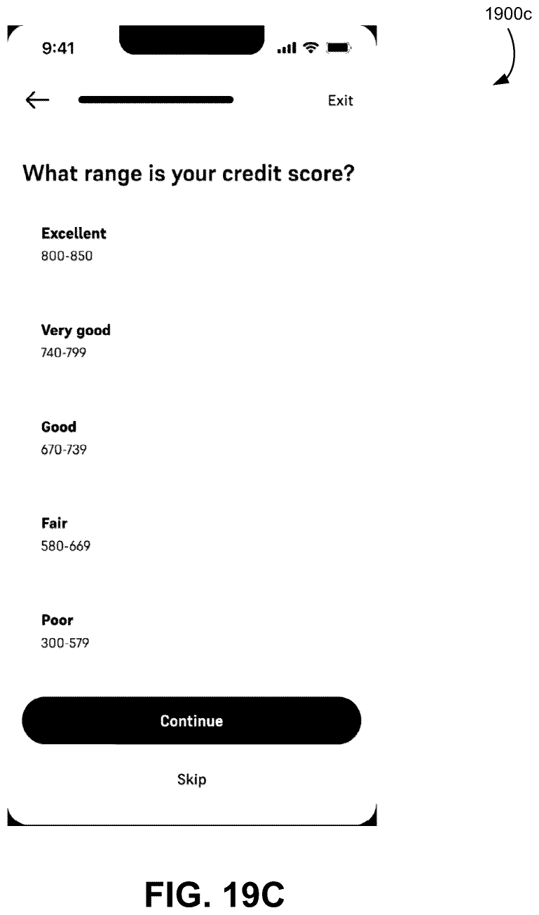

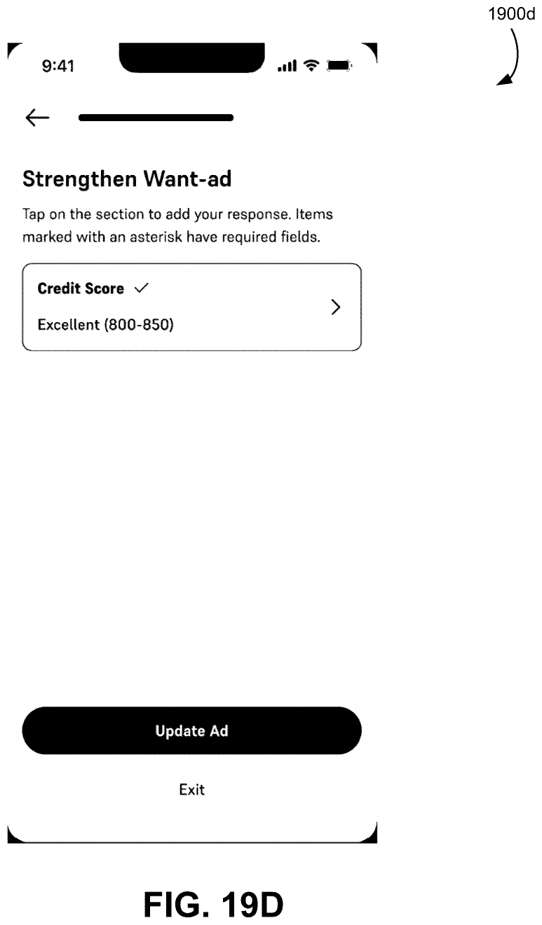

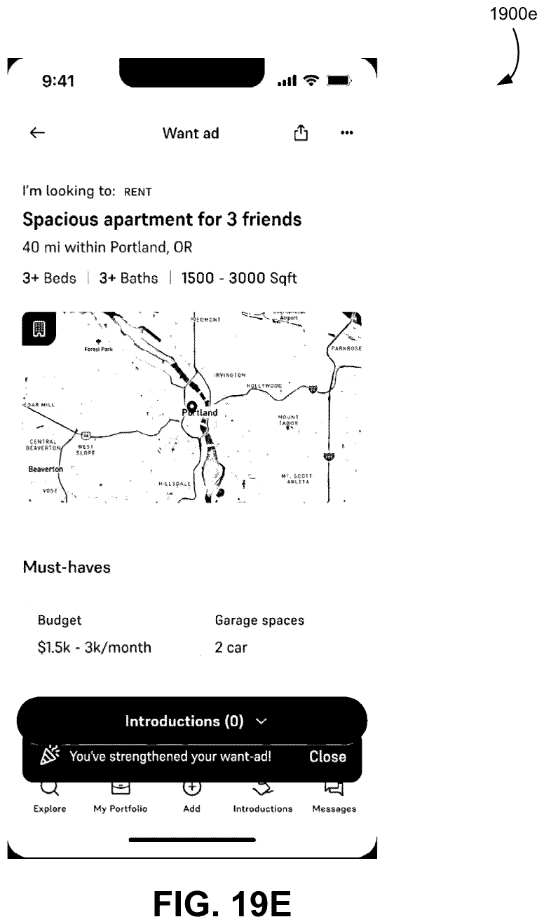

In various embodiments, at any time following the completion of their want-ad listing, the Want User can also provide additional, optional criteria if they wish to add context to the listing. This can be referred to as ‘strengthening the ad’. To do so, in some examples the Want User can select ‘strengthen my ad’ and can provide additional information in their listing. The information may include but won't be limited to their credit score and income. This information can be paramount in some examples for a Property User to decide if the renter would likely qualify for the rental should they propose it, as illustrated in views 1900a-1900e of FIGS. 19A-19E.

In various embodiments, both renter Want Users as well as agent Want Users can upload as many separate long-term rental want-ads as they need to and in as many geographic locations as they need. There is no fee for a user to upload a rental want-ad listing in various examples.

### Example Short-Term Stay Ads

Like long-term rental want-ads of some embodiments, short-term renters and their agents (e.g., Want User) in various embodiments can create a short-term stay want-ad listing for short-term stays (e.g., under 30 days). These can be referred to as ‘Stay Ads’. These can be rentals for vacation or temporary stays, often booked on a nightly or weekly basis.

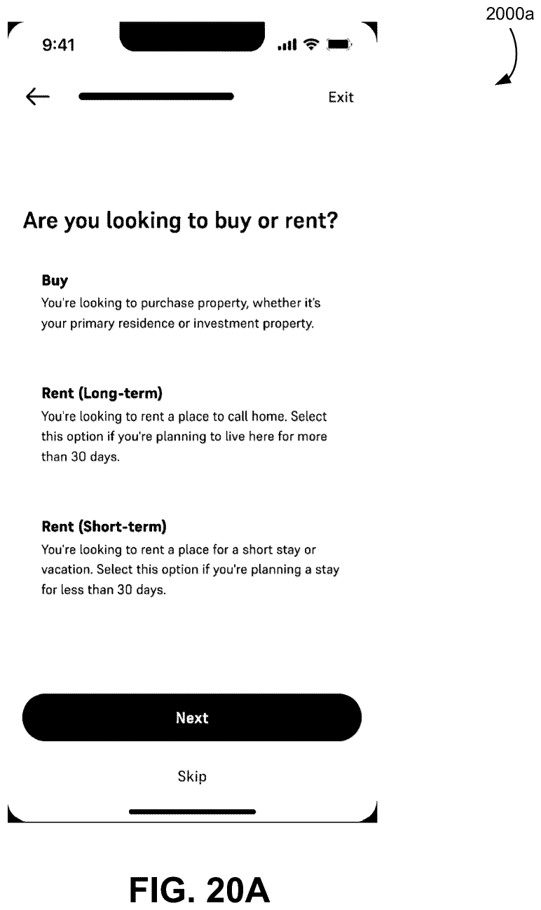

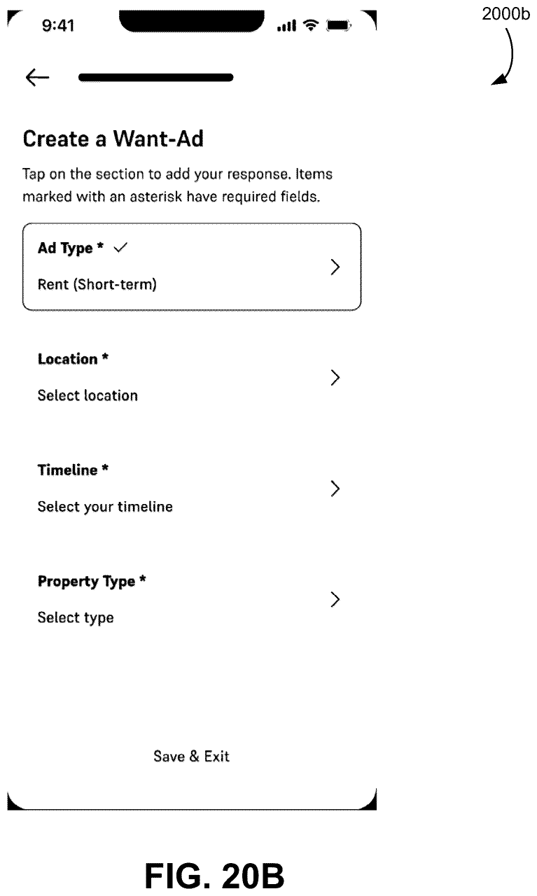

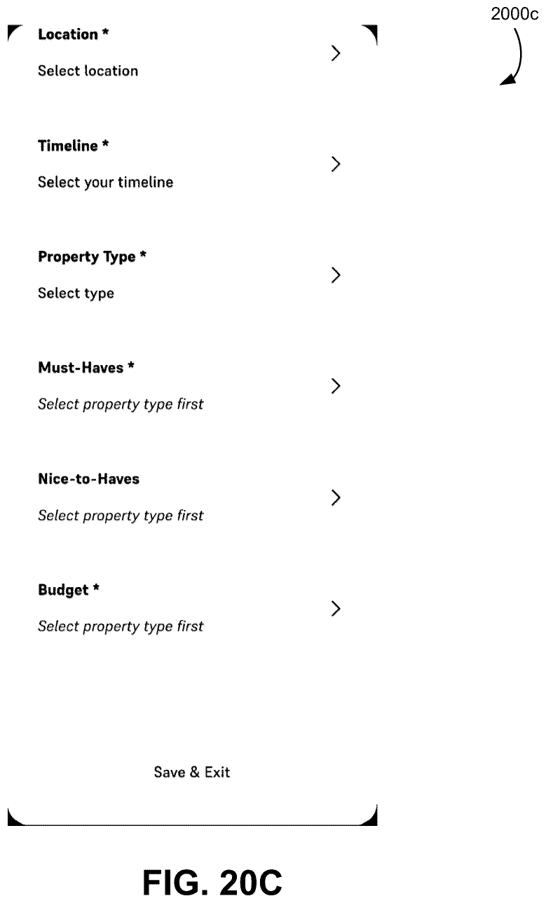

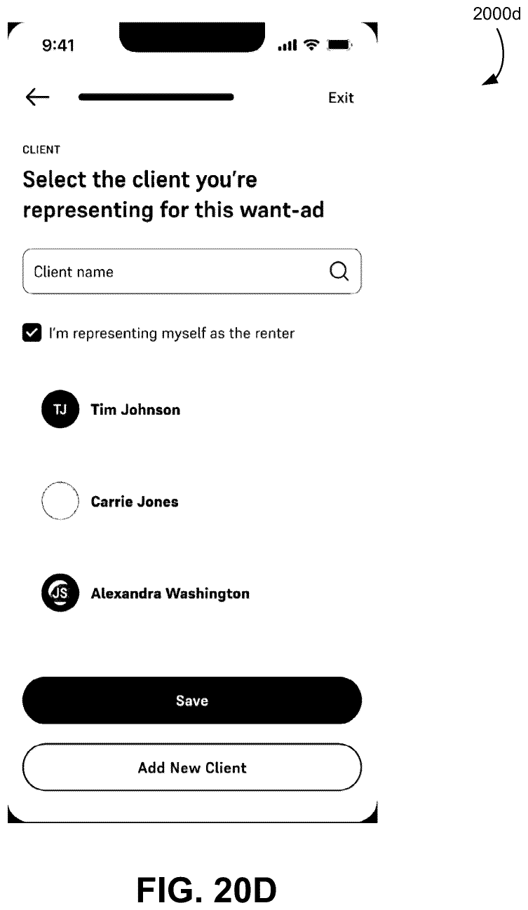

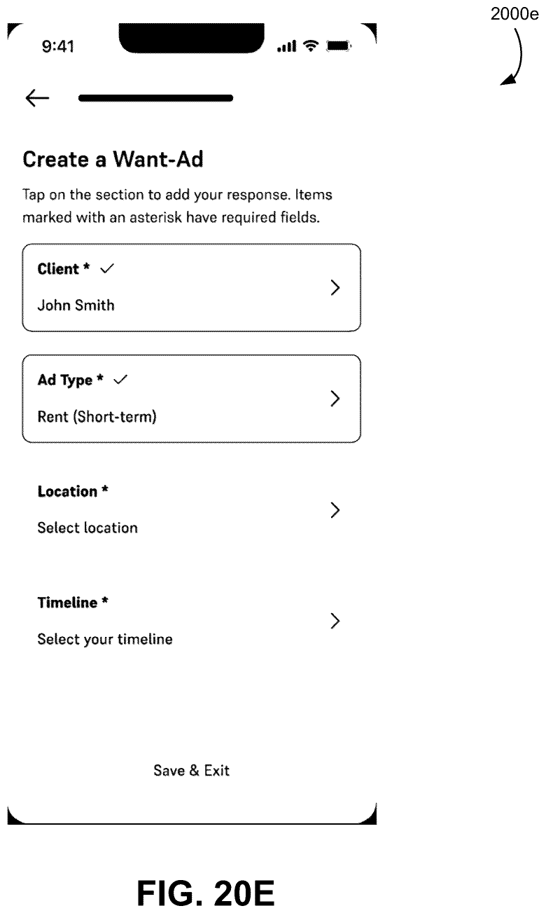

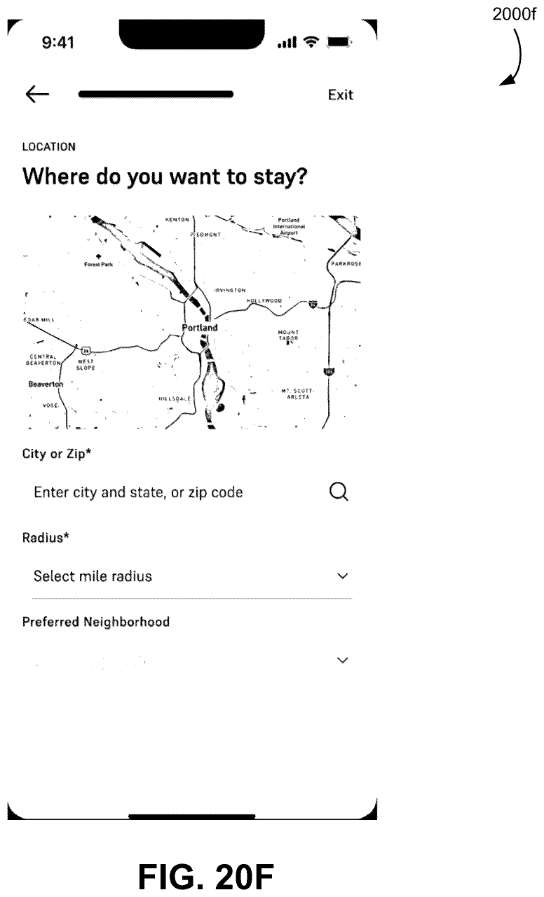

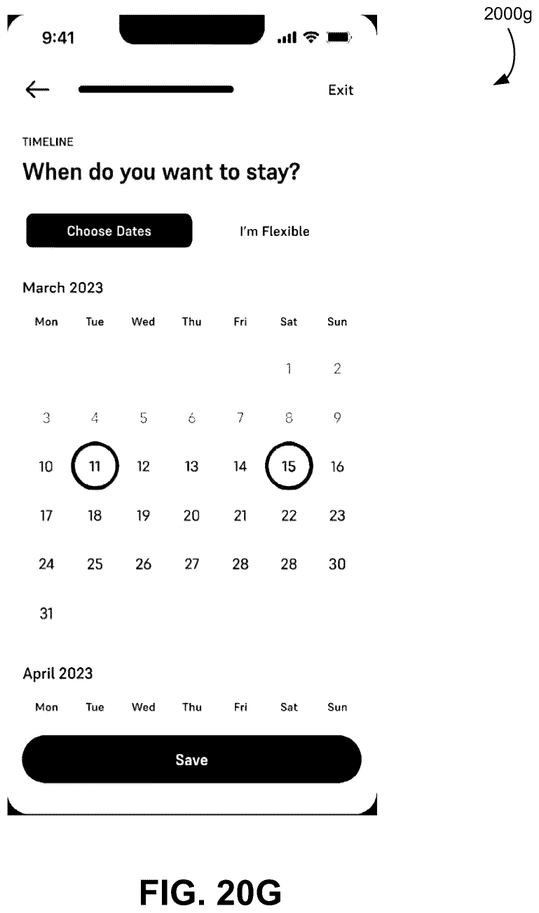

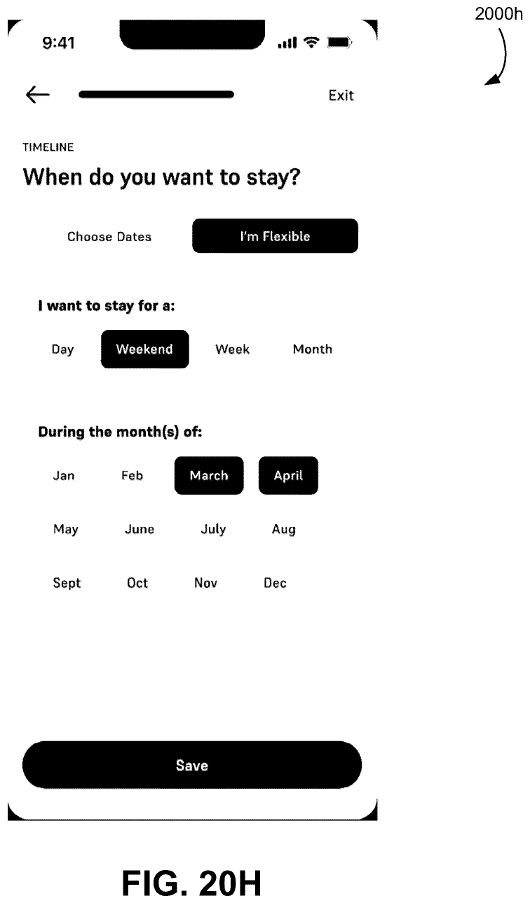

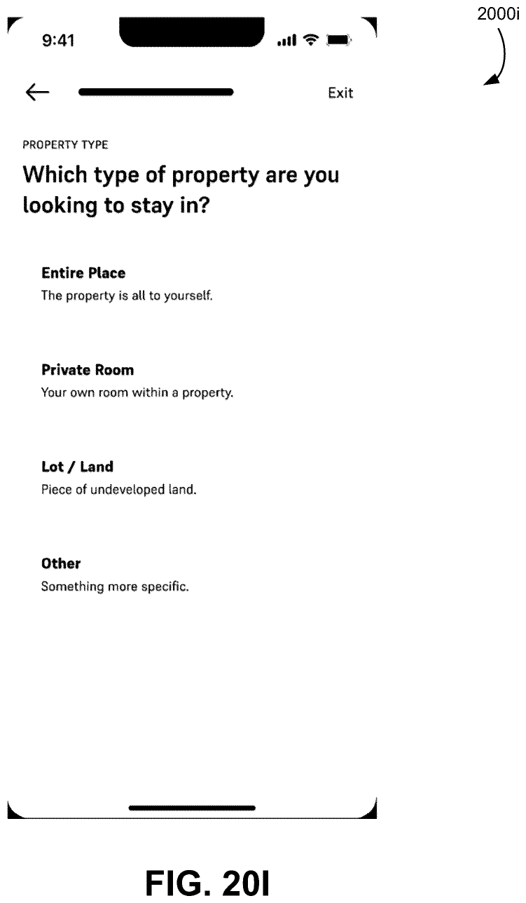

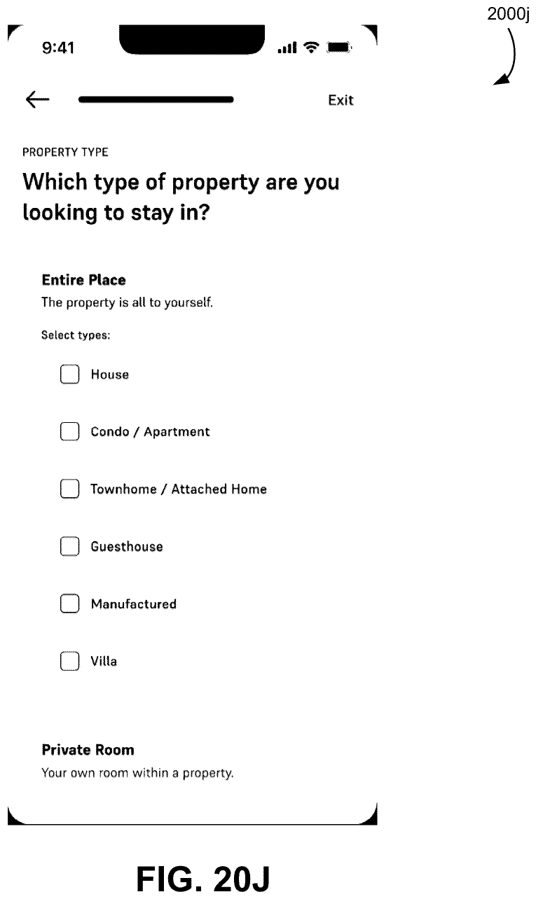

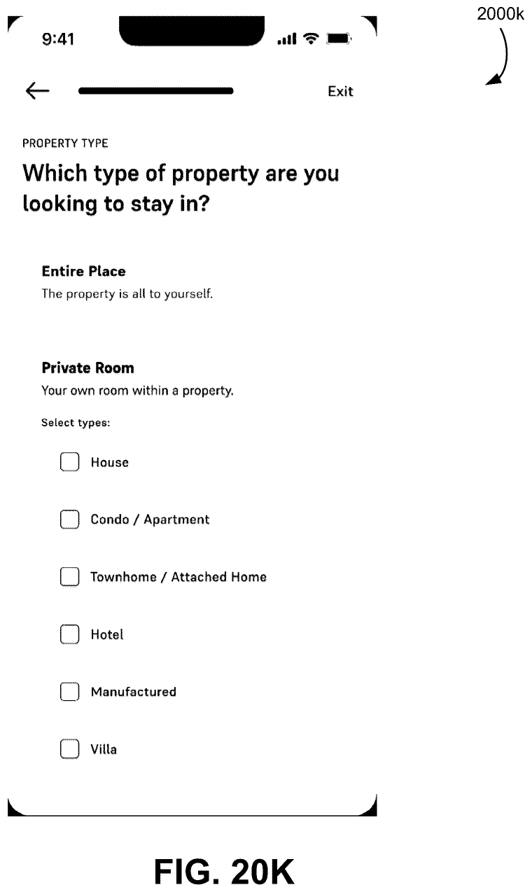

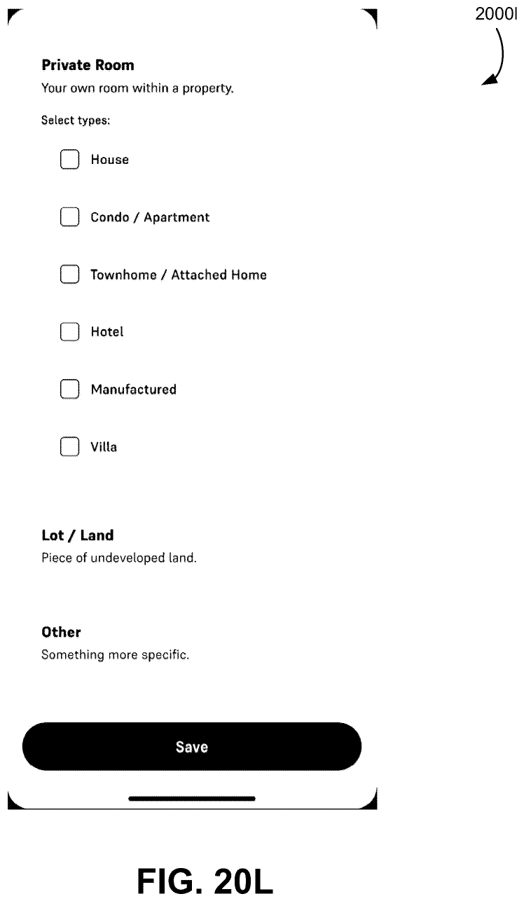

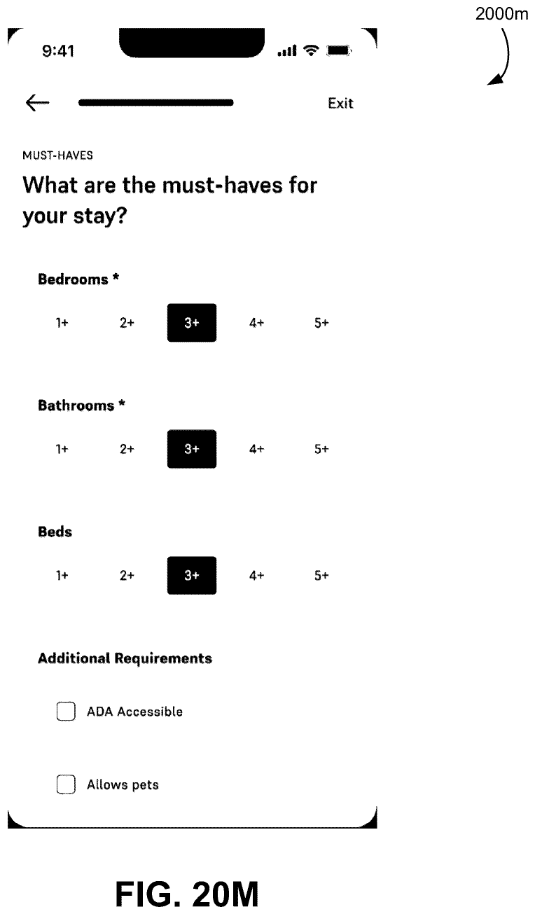

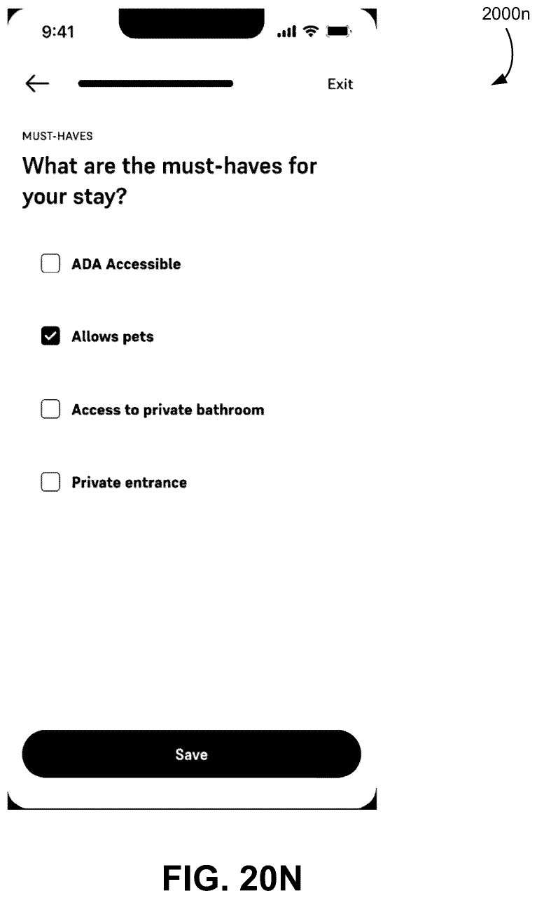

In various embodiments, required criteria for the stay ad can be the same or different as the long-term rental ads: for example, some embodiments can require the Want User to go through and provide the minimum stay criteria in order for the system to be able to send property owners or property agents (Property Users) short-term stay ad listings that match the criteria of their properties. In some examples, ad type, location, timeline, property type, and nightly budget are all parameters may be required by the system to finalize a stay want-ad listing; however, various suitable parameters can be set as minimum stay criteria or minimum stay criteria can be absent. Additionally, the desired bedroom/bed count, bathroom count, and square footage—known as ‘must-haves’ in some example—may also be required in some examples to be populated to finalize and post the want-ad listing, as illustrated in views 2000a-2000c of FIGS. 20A-20C.

For agents representing short-term renters, in various embodiments the agent can manage many customers and their want-ad listings. To keep track of them and be able to sort and arrange their client want-ads, the system in some examples can ask them to designate what client this short-term stay want-ad listing is for. The system in various examples can allow them to add new clients and their information, including, for example, the client's contact information and bio. This information in various embodiments can be private and not be displayed publicly, and this feature in some examples will only be for professional agents, as illustrated in views 2000d-2000e of FIGS. 20D-20E.

The Want User in various examples can be able to map the area they are seeking to stay in, and can provide, for example, a nearby address, zip code, or point of interest to create the area parameters in the listing. The user in some examples can adjust the map to a vicinity of the provided address, point of interest or zip code, establishing distance in mile increments, to set the specific boundaries to show any property owners or agents the areas they are looking for property to stay in, as illustrated in view 2000f of FIG. 20F.

With short stay want-ad listings, in various embodiments the system can allow or require the Want User to enter in specific date ranges for the stay (‘choose dates’) or the user can choose that they are flexible with their travel dates (‘I'm flexible’), and in various examples they can also designate their travel dates by month and if they are looking to stay a day, a weekend, a week or a month, as illustrated in views 2000g-2000h of FIGS. 20G-20H.

The Want User in various embodiments can select what kind of property they are seeking to stay in or at, too. A short-term renter can select from an entire place, a private room, vacant land or other for their short-term stay want-ad listing, as illustrated in view 2000i of FIG. 201.

The Want User in various embodiments can select more than one property type if they are open to stay in different types of properties, such as an entire place (house, condo/apartment, townhome/attached home, guest house, manufactured, or villa), as illustrated in view 2000j of FIG. 20J.

In various embodiments, if the Want User selects a ‘private room’ they will be able to select from house, condo/apartment, townhome/attached home, hotel, manufactured, or villa. They can also choose in some examples to seek to rent a vacant lot or space to park a mobile home or recreational vehicle. The Want User in various examples can select all that they may be interested in, and the more open they are the more likely they will get meaningful matches presented to them by the system, as illustrated in views 2000k-2000l of FIGS. 20K-20L.

In various embodiments, the Want User can be required to enter the ‘must-haves’ criteria before the system will allow the stay want-ad listing to be published; however, in some embodiments, ‘must-have’ criteria is not required for publication. The must-haves for stay want-ad listings in some examples can include what number of bedrooms or beds and number of bathrooms the Want User needs. The user can then designate if they need the rental to allow pets, if they need it to be ADA accessible and if they need to have access to a private bathroom or entrance. In some examples they can state or will be required to state the nightly budget for their stay, as illustrated in views 2000m-2000o of FIGS. 20M-200.

The Want User in various embodiments is able to add additional information and parameters describing what features they are looking for in their desired stay. This category of information can be labeled as ‘nice-to-haves’. The feature list in some examples can be broken down into 5 categories: property features, layout features, exterior features, interior features, and other features. Under the categories, the selections for the Want User may include choosing from amenities that would be offered at short term rental properties, amenities that may include benefits such as a fitness facility, pool, spa, on-site restaurant, or many other potential features of a property catering to short-term renters.

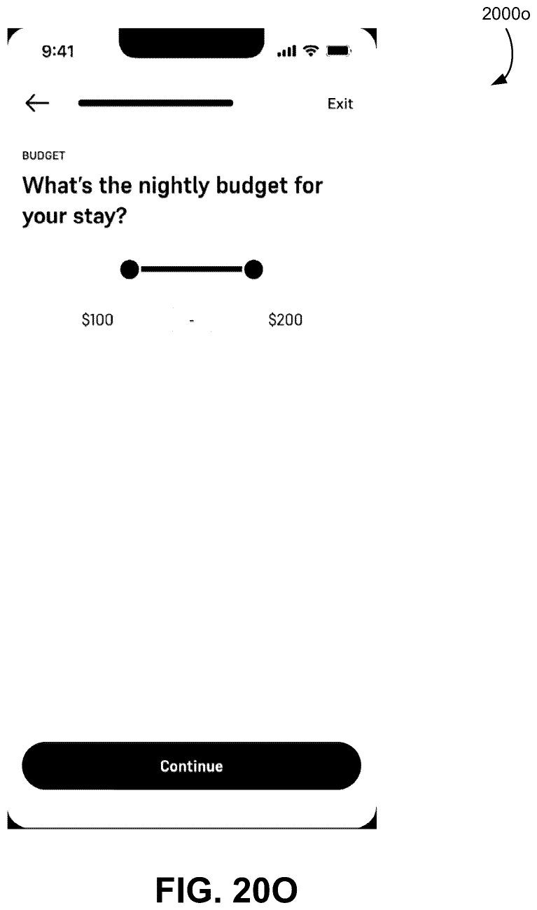

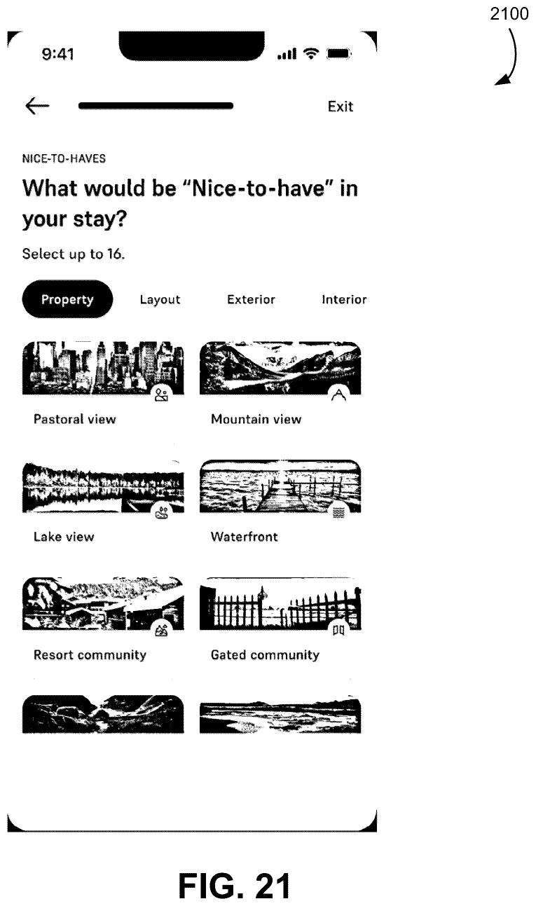

The system in various embodiments can list many sub features under each nice-to-have category for the Want User to provide additional information to any Property User. This step in the process is not required to finalize and post a listing in various examples, as illustrated in view 2100 of FIG. 21.

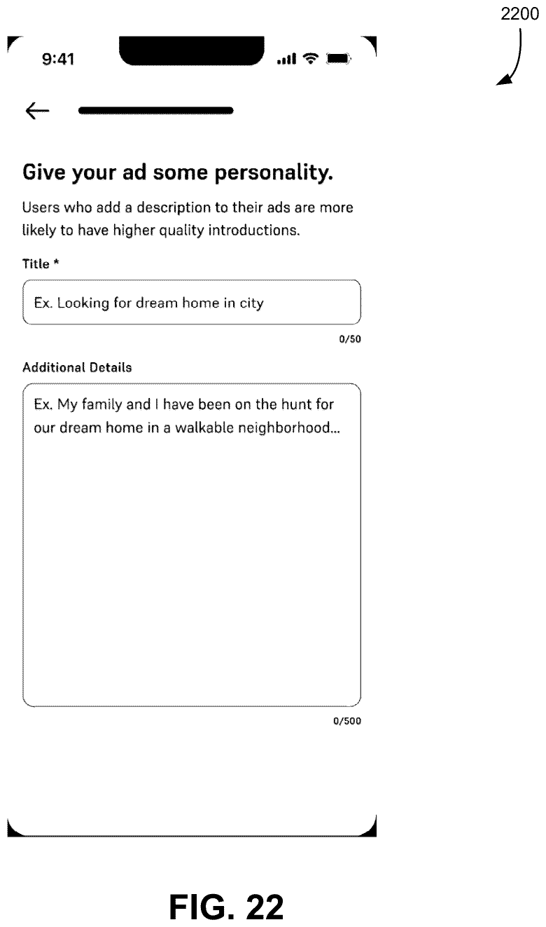

Like the wanted to long-term rent want-ad listing process of some embodiments, the Want User seeking a short-term stay in various embodiments can provide a title and can provide a description of their want-ad listing. This area may be a place where the Want User can detail the perfect situation or parts of the stay that are most important. The content could be general or very specific, and the Want User in some examples can have the option to be as personal or as limited in the details of the description as they choose, including if the stay is a vacation, special occasion, etc., as illustrated in view 2200 of FIG. 22.

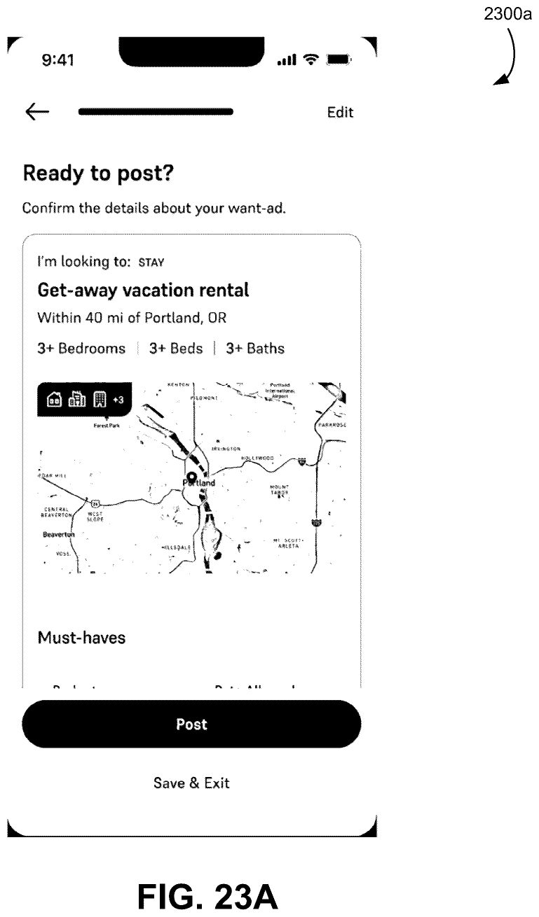

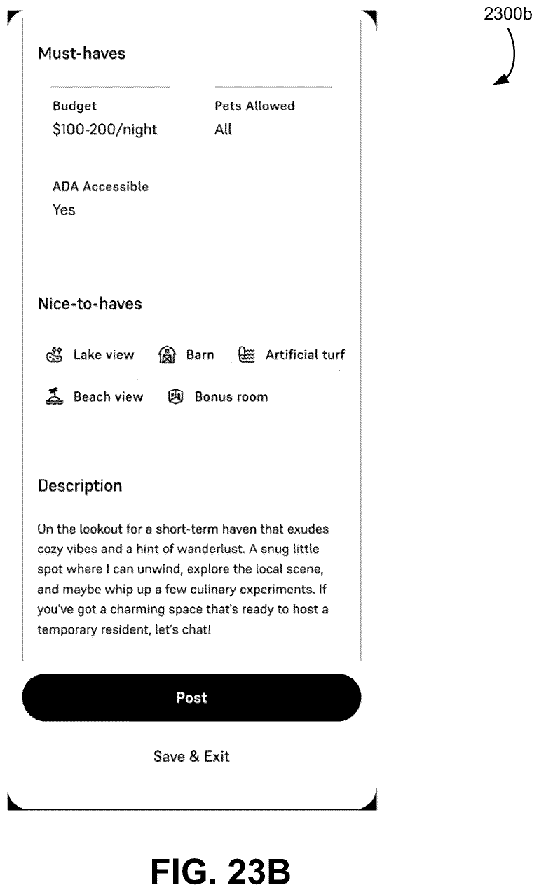

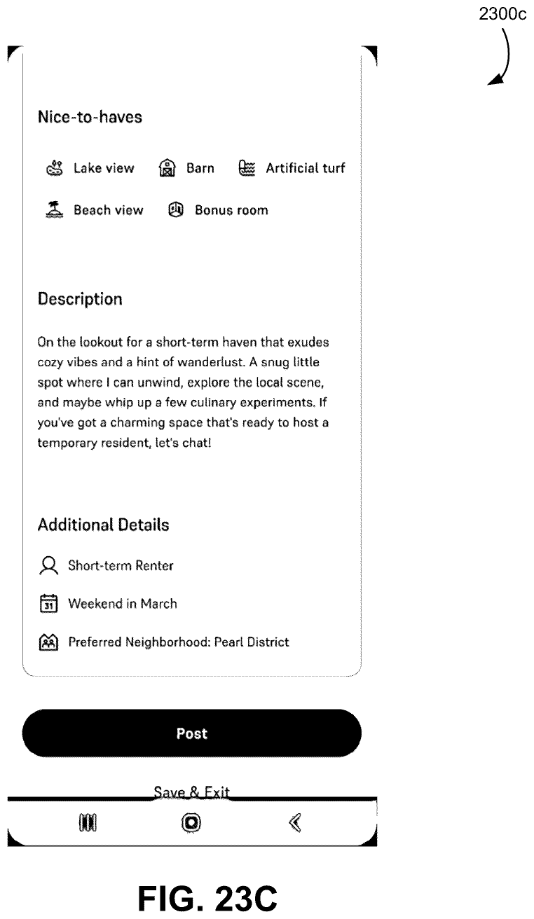

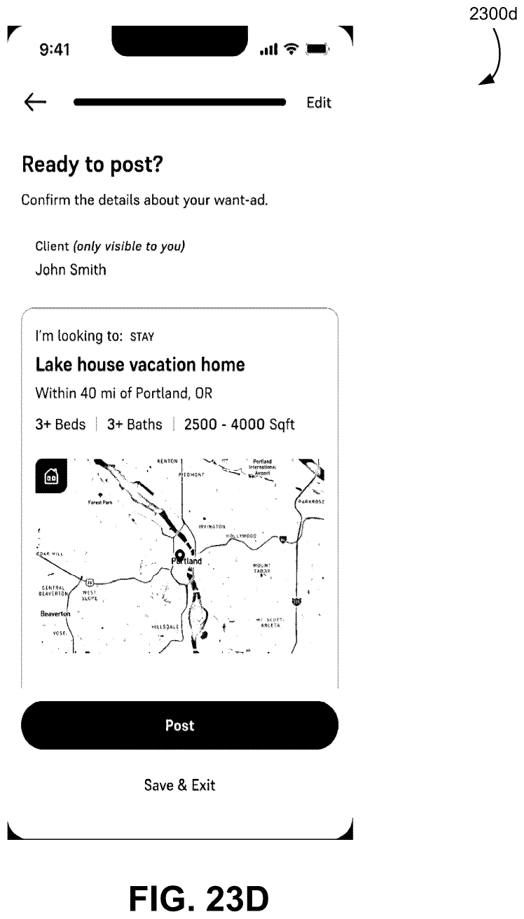

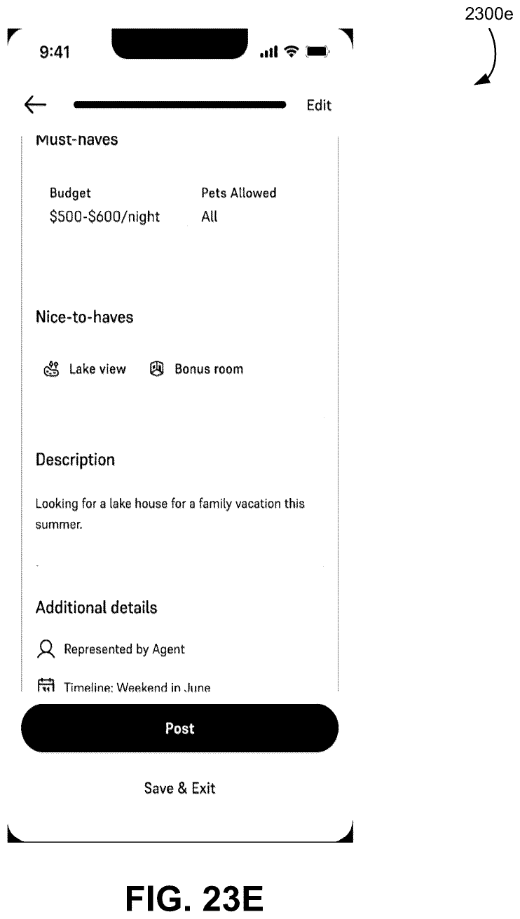

The Want User in various embodiments will be able to review their post before it becomes public. As part of it, in various examples they can review the ‘renter information’, where additional information can be provided such as their desired dates of stay and if they are a renter or an agent representing the short-term renter. The system in various examples can keep the identity of the user confidential at this stage in the process, for example, to prevent any potential discriminatory activity as well as allowing the user to maintain their privacy until both parties decide to connect privately. Once all of the information looks correct they can select ‘Post’ to make it live on the stay want-ad listing marketplace, as illustrated in views 2300a-2300c of FIGS. 23A-23C.

For an agent posting a stay want-ad listing, in various embodiments they will also be able to review their post before it becomes public. The preview in various examples can show what client file the ad will be stored under in the private dashboard, and the ad in various examples can identify that it was created by a professional agent. If all information looks correct, they can select ‘Post’ to make it live on the stay want-ad listing marketplace, as illustrated in views 2300d-2300e of FIGS. 23D-23E.

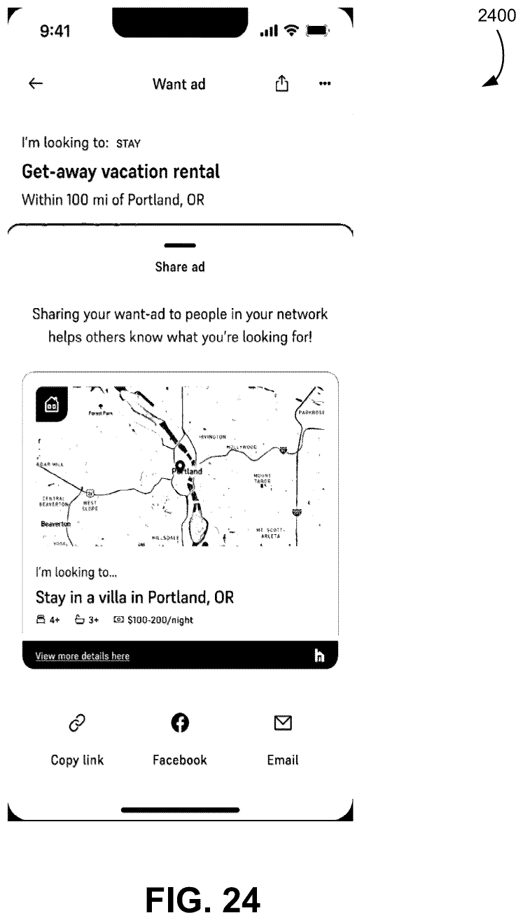

Once the stay want-ad listing is live, in various embodiments the system can provide the Want User an option to share the listing a variety of ways including via e-mail, the internet and on a variety of social media platforms, as illustrated in view 2400 of FIG. 24.

In various embodiments, both standard Want Users as well as agent Want Users can upload as many separate stay want-ads as they need to and in as many geographic locations as they need. There is no fee for a Want User to upload a stay want-ad listing in various examples.

Property User Example: The Property Owner (Seller/Landlord) & their Agents

The system in various embodiments provides the owner of real property or their agent (Property User) a system to connect to buyers, renters or their agents who may represent them (Want User).

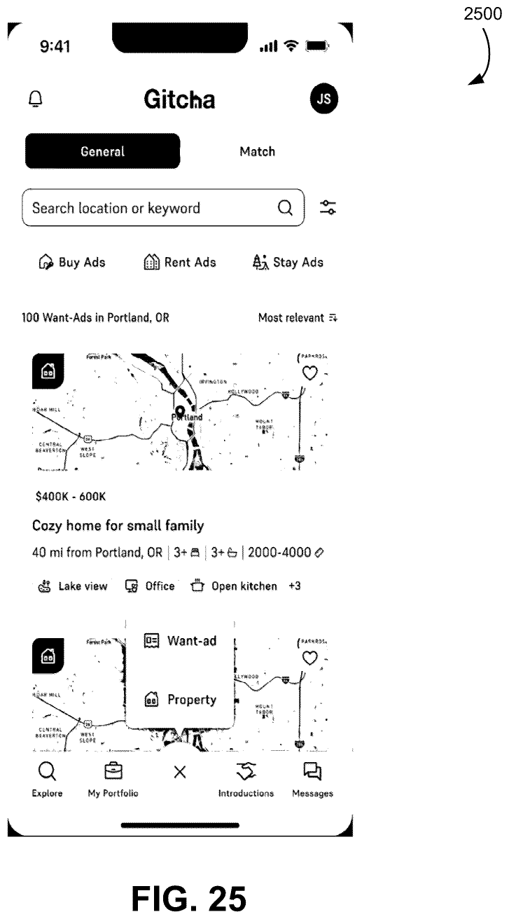

If the Property User is a property owner acting as a seller or landlord, or an agent acting on behalf of the property owner, and they'd like to store a new property on their dashboard, in various embodiments they can click on ‘add’ and then click on ‘property,’ as illustrated in view 2500 of FIG. 25.

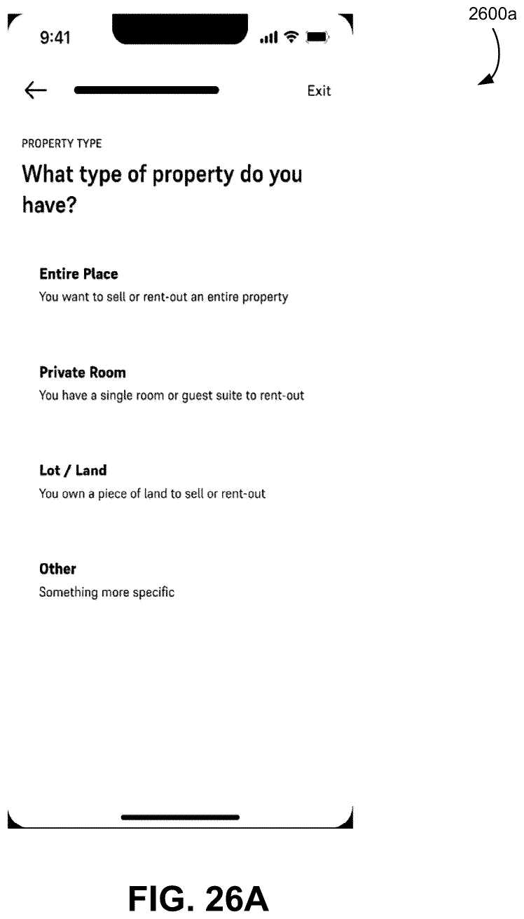

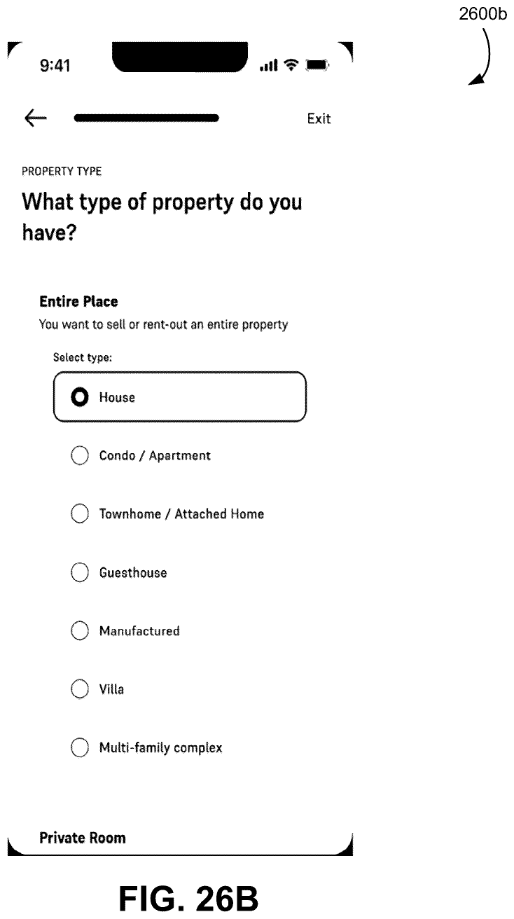

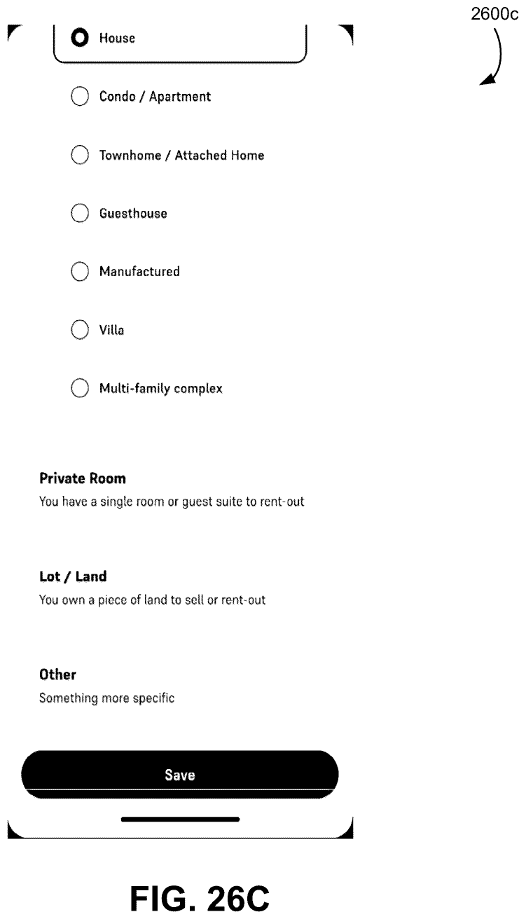

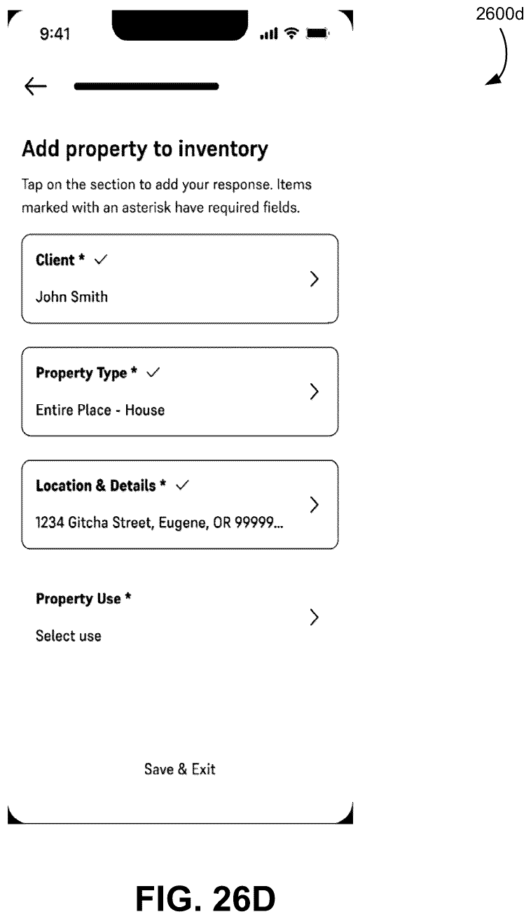

They system in various embodiments can allow the Property User to store real property specifications privately in their own user dashboard as their ‘Inventory’, a place where the details of property they own or represent can be saved. The property in various examples can be real property such as an entire place (house, condo/apartment, townhome/attached home, manufactured, multi-family complex or villa), a stand-alone guest house, vacant land, a private room inside a place, or other, depending on what they are planning to do with the property (sell or rent out on a long-term or short-term basis), as illustrated in views 2600a-2600c of FIGS. 26A-26C.

For Property Users who are agents representing a property owner or landlord, the agent in various embodiments can have the ability to first designate which client the property belongs to. This can allow the agent to keep each Inventory separated in their professional dashboard. Because agents may frequently handle multiple properties of many different clients, the systems in various examples provides professionals with an organization system to prevent comingling of private information between clients. The agent can designate in some examples if they are personally the client/owner of the property that they are storing. Once they designate the client the Inventory belongs to, the ‘add property to inventory’ screen can display the client's name at the top, as illustrated in view 2600d of FIG. 26D.

Should the agent need to add a new client to their dashboard to store the Inventory, in various embodiments they can click ‘add new client’ and the system can allow them to add new clients and their information, including the client's contact information and bio, as illustrated in view 800e of FIG. 8E.

Once Inventory is loaded into a Property User's dashboard, in various embodiments the system can start providing automated matches to any want-ad listings that may match the location and specifications of the respective Inventory. For the system to be able to do so, in some embodiments the system requires that the Property User provide specific minimum specifications of the property as well as designating what the use of the property will be.

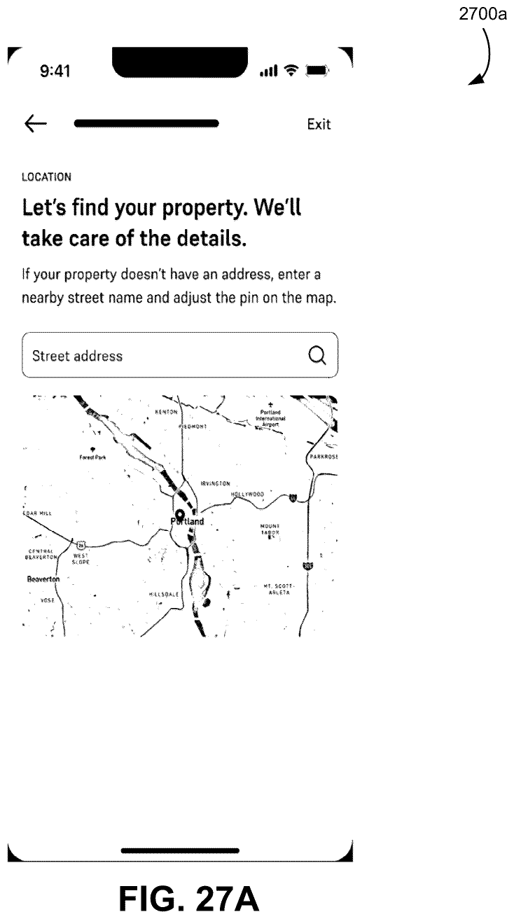

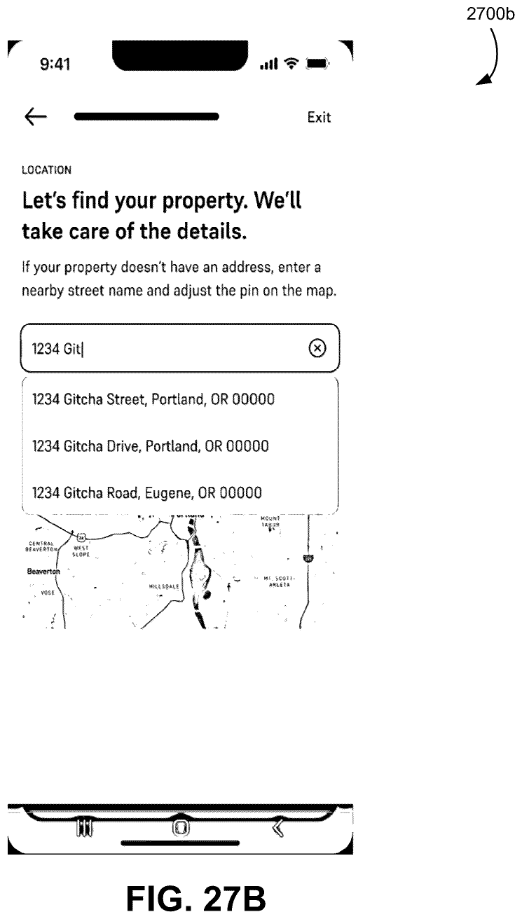

A first step to store Inventory in various embodiments can be providing the exact address of the home or property. The system can have the Property User enter the address and in some examples can populate the map location through third-party software or in another suitable way. If the address does not come up or is inaccurate, in various examples the user can manually write in the address and drop a pin on the map, as illustrated in views 2700a-2700b of FIGS. 27A-27B.

Once the property address is confirmed, in various embodiments the system can bring up the property's exact location, specifications that are of public record and can note if the property is currently on the active public for-sale market. If the property is on the active for-sale market, the specifications of the public for-sale listing, including the number of bedrooms and bathrooms, the square footage, the stories and the lot size in addition to the current asking price can auto populate in various examples. The Property User can verify the information in some embodiments, and if the information provided is not accurate, the Property User can manually fill in the correct information in some examples.

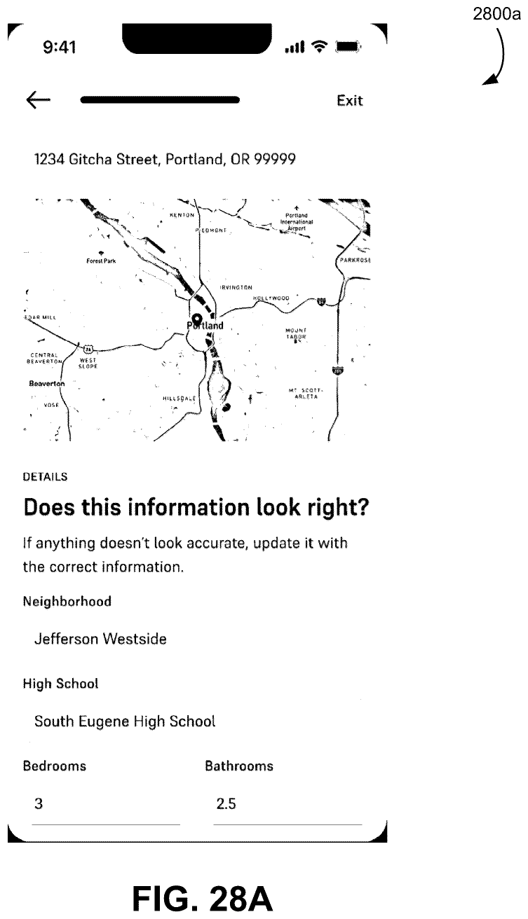

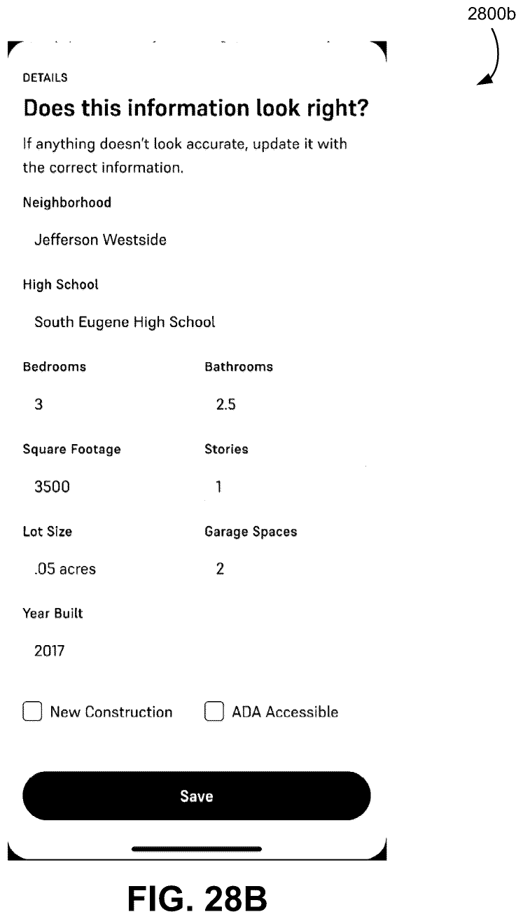

In various embodiments, the Property User can identify the High School area and neighborhood that the property resides in, which is often key criteria for Want Users, and in some examples can add the amount of garage spaces, if it's ADA accessible and/or if it's new construction, and then can click ‘save’ to move to the next step (e.g., in required data fields), as illustrated in views 2800a-2800b of FIGS. 28A-28B.

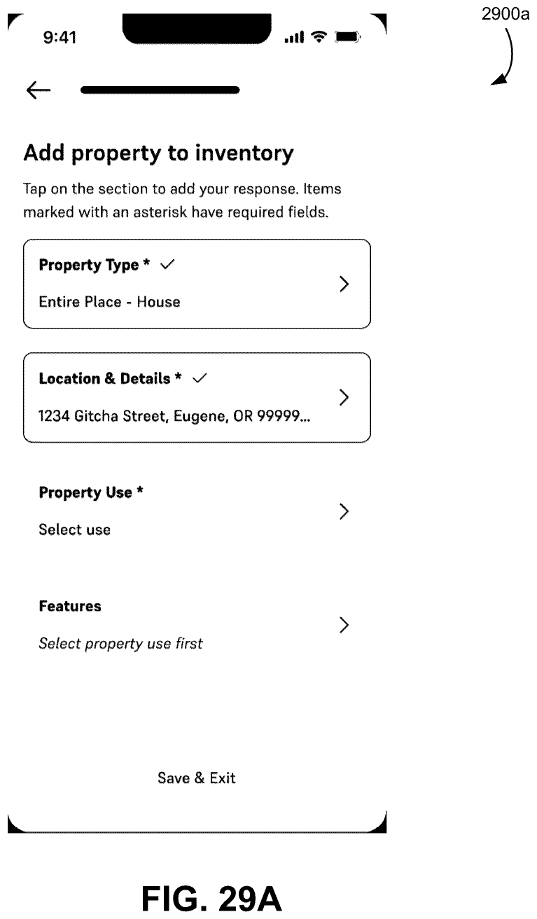

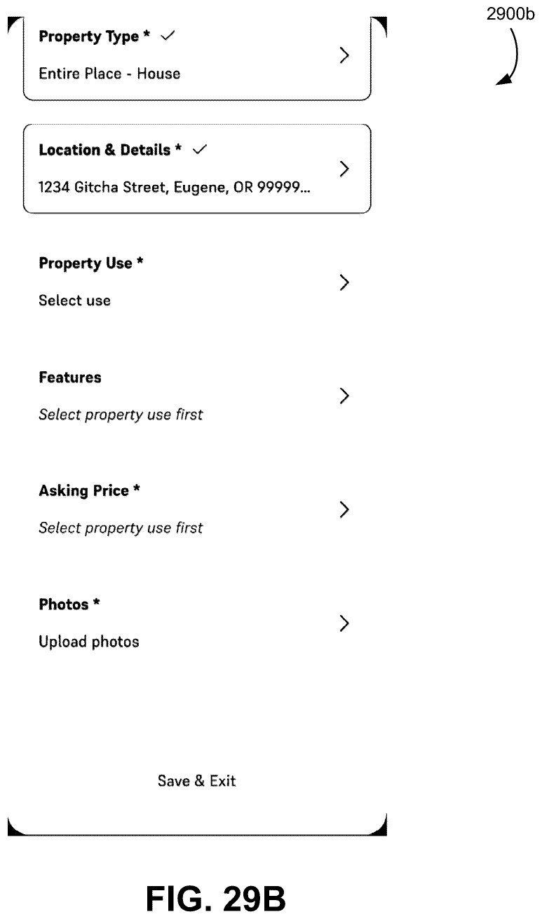

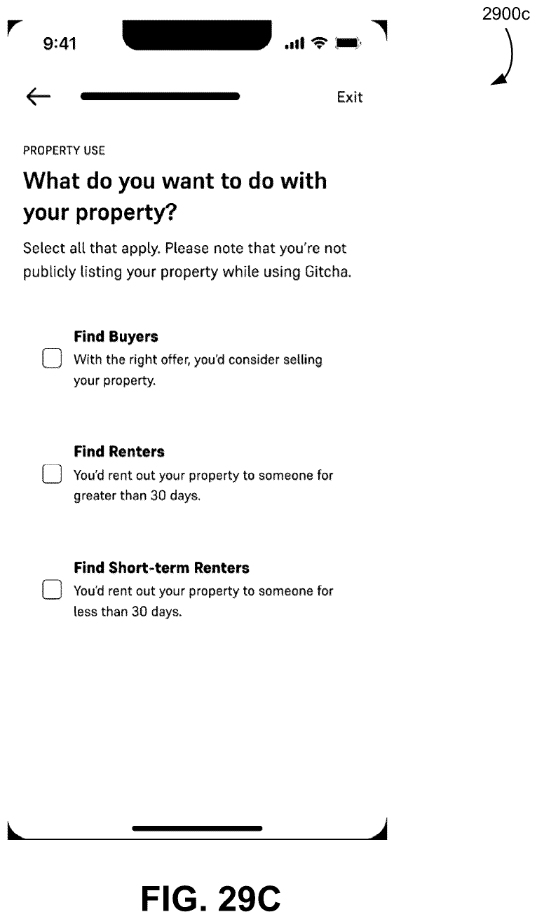

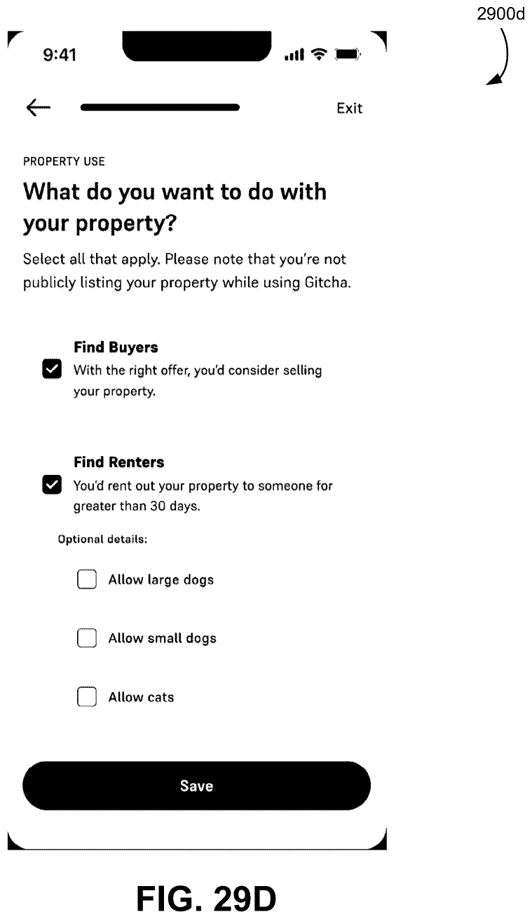

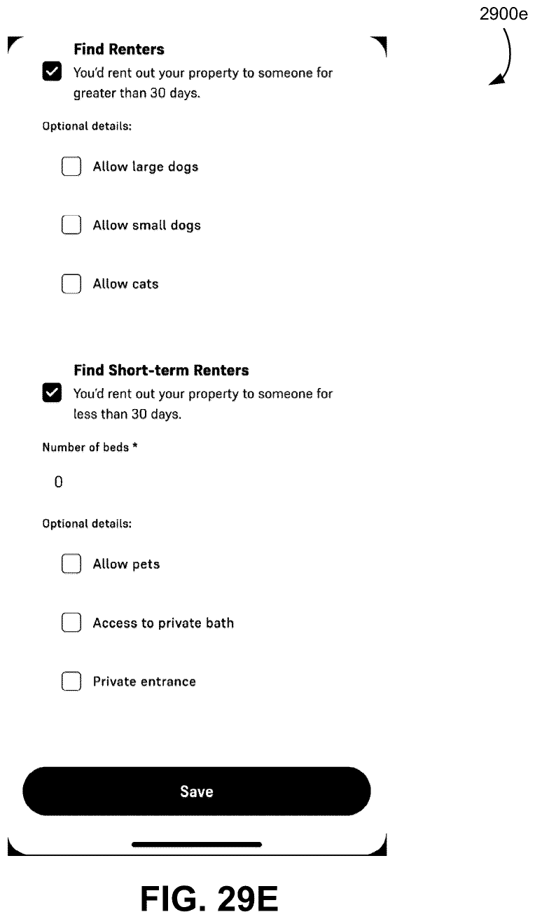

In some embodiments, before a Property User can fully save a property into their private dashboard, the Property User must indicate to the system what they want to do with their property, for example: find buyers, find renters, and/or find short-term renters. The Property User can select all that apply in various examples. If the Property User is open to renting out their property on either a long-term or short-term basis, they can be required in some embodiments to verify if they allow dogs, cats or other pets. If they are open to offering their property to short-term renters and they are planning on offering a private room, in some embodiments they will need to verify if it has access to a private bath or not and if it features a private entrance. On short-term stays, the Property User can designate how many beds are available for their renters, as illustrated in views 2900a-2900e of FIGS. 29A-29E.

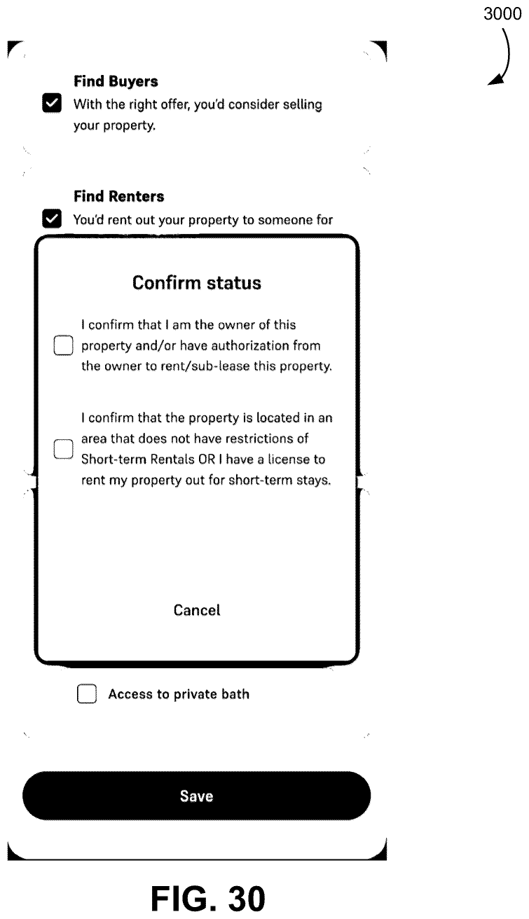

Before the system will store the Inventory, in some embodiments the system will require the Property User to confirm that they have authorization to rent/sub-lease out the property. They system in various examples can ask the Property User to confirm if they are leasing their property to short-term renters, whether their area has no overnight rental restrictions or if they have a license to rent out the property on a short-term basis, as illustrated in view 3000 of FIG. 30.

Before the Property User can store their Inventory to their private dashboard, in some embodiments the system can ask for the asking price of the property. Providing an asking price—whether it be an asking price for sale, a monthly rental price for long-term rentals, or nightly rental price for short-term stays—can be a required field in various examples. Since this information can be privately stored in various examples and may not be a public listing, in various embodiments the asking price can be edited at any time. But, including it will can allow the system in various examples to send want-ad listings that match with the stated price of the property.

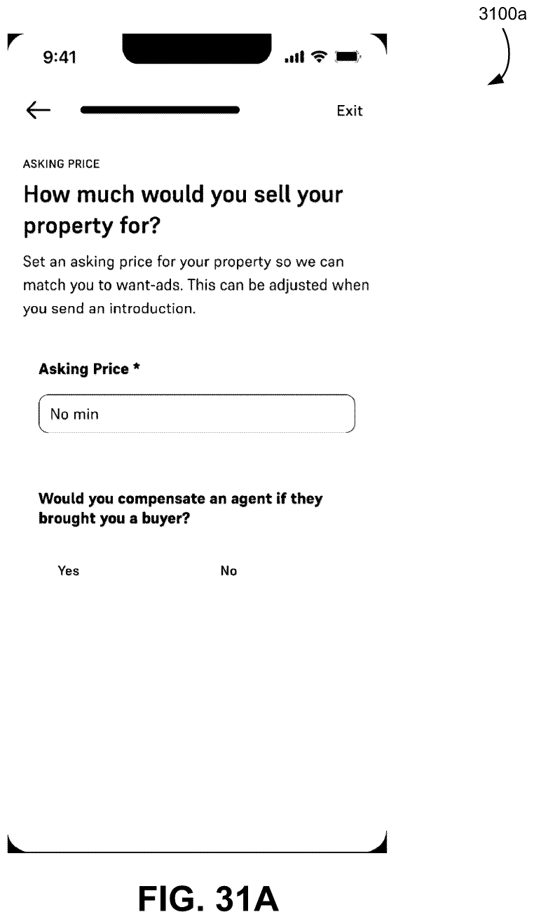

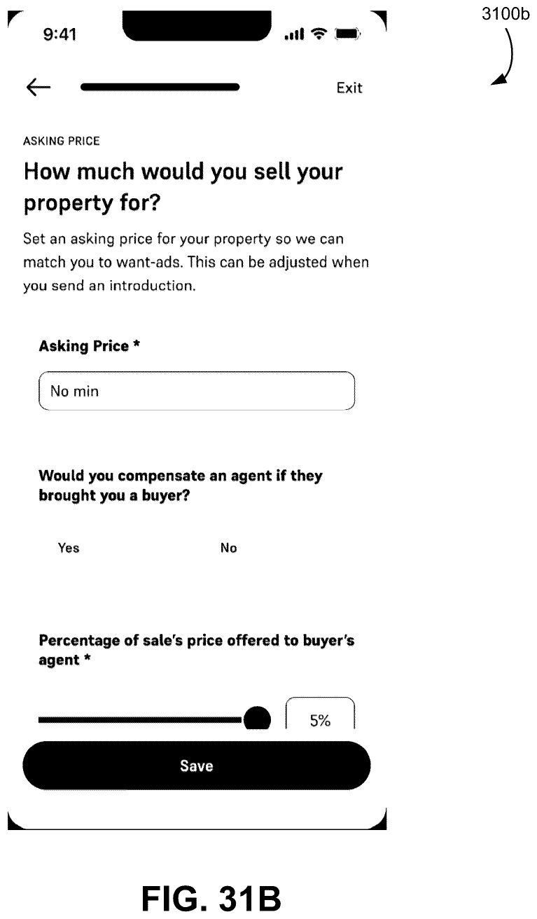

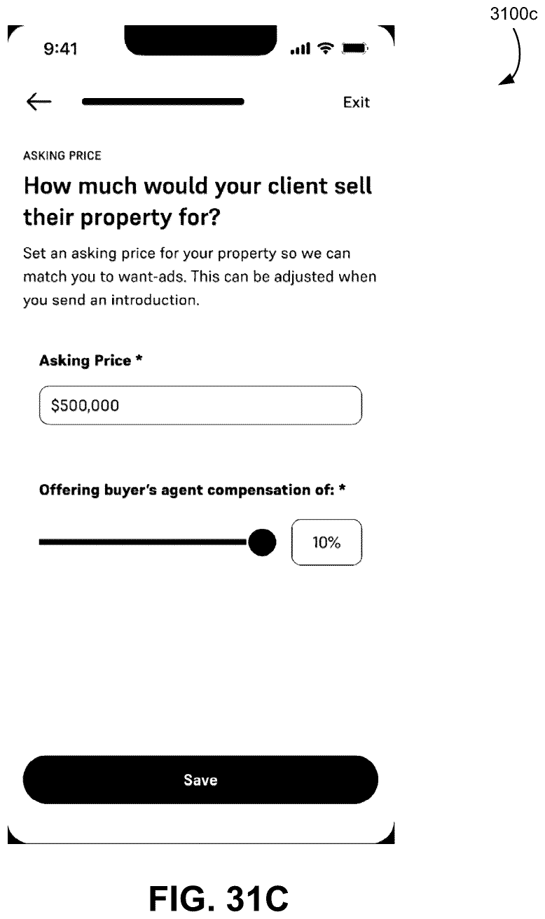

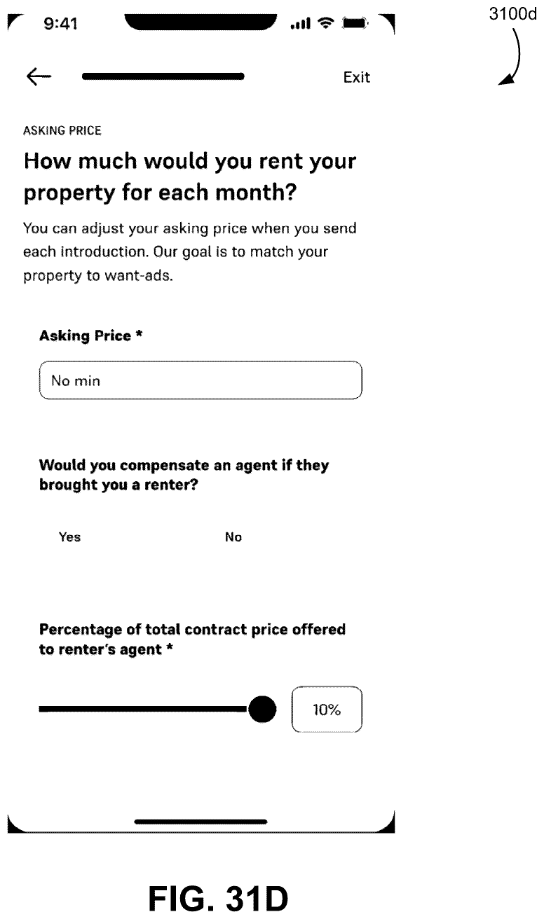

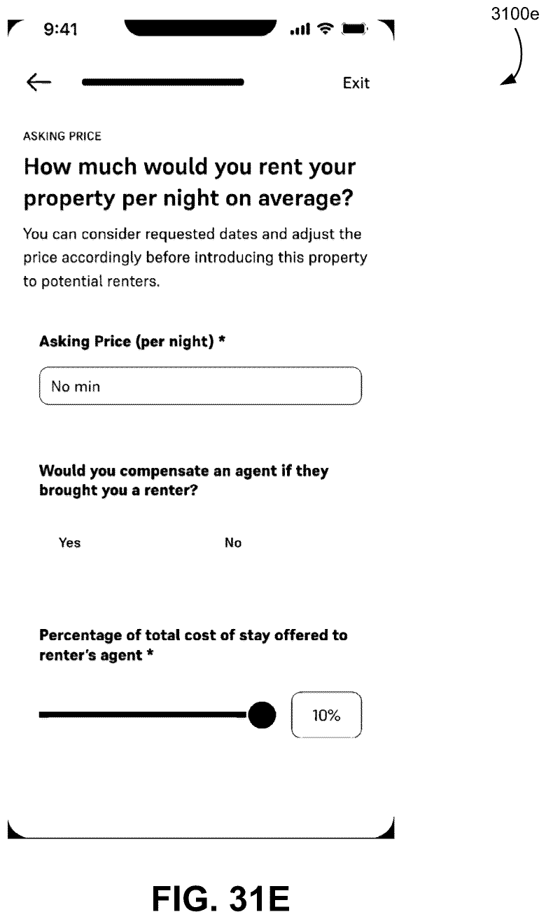

If a Property User is open to selling the property, in various embodiments they can select what their asking price would be, and they can be asked if they would be open to compensating a buyer's agent if they brought a buyer. Should the Property User select ‘yes’, in some examples they can be asked to state what percentage of the sales price they would offer to an agent of a Want User, as illustrated in views 3100a-3100c of FIGS. 31A-31C. If the Property User is an agent, in various embodiments the system automatically show the compensation field that to be populated, and it can ask the agent to identify what the compensation will be to an agent representing a Want User.

If the Property User is seeking to rent out the property on a long-term basis, in various embodiments the asking price can be in monthly dollars. If the Property User is seeking to rent out the property on a short-term basis, the asking price can be nightly in some examples. In both rental cases and in some embodiments, the Property User can offer to pay a commission percentage of the contract price if they choose, and if they offer a commission they can select ‘yes’ that they will compensate an agent who brings a renter, and they can then select what percentage of the contract price, as illustrated in views 3100d-3100e of FIGS. 31D-31E.

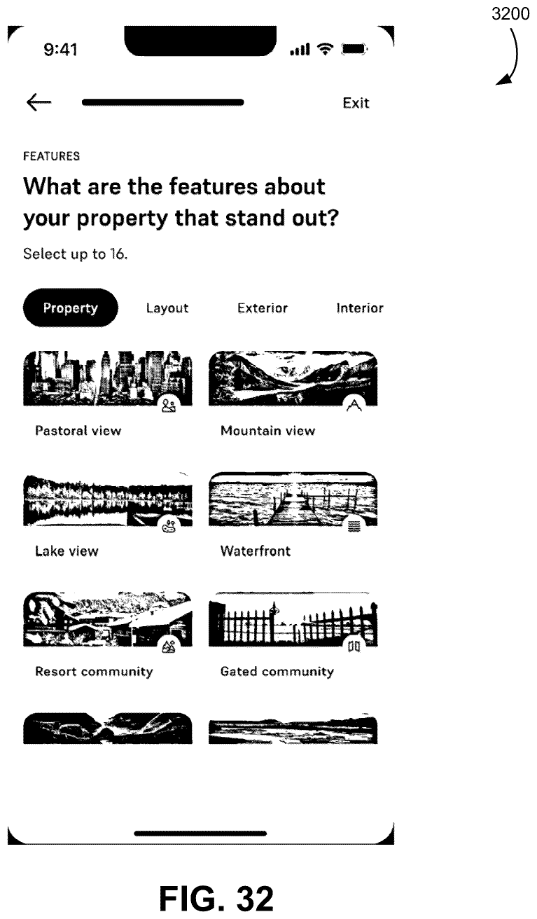

Once the required features of various embodiments are entered into the system, the Inventory can be further detailed in some examples through one or more steps. In a first example just like the ‘nice-to haves’ features in a Want User's want-ad listings of some embodiments, the corresponding features of the 5 categories of property features, layout features, exterior features, interior features, and other features can be selected by the Property User. In various embodiments, the systems will not match these features to the nice-to-haves of want-ads as part of an automated matching system, but property features can be a component of the Property User's Inventory data entry in some examples to provide pertinent details to potential future buyers and renters, as illustrated in view 3200 of FIG. 32.

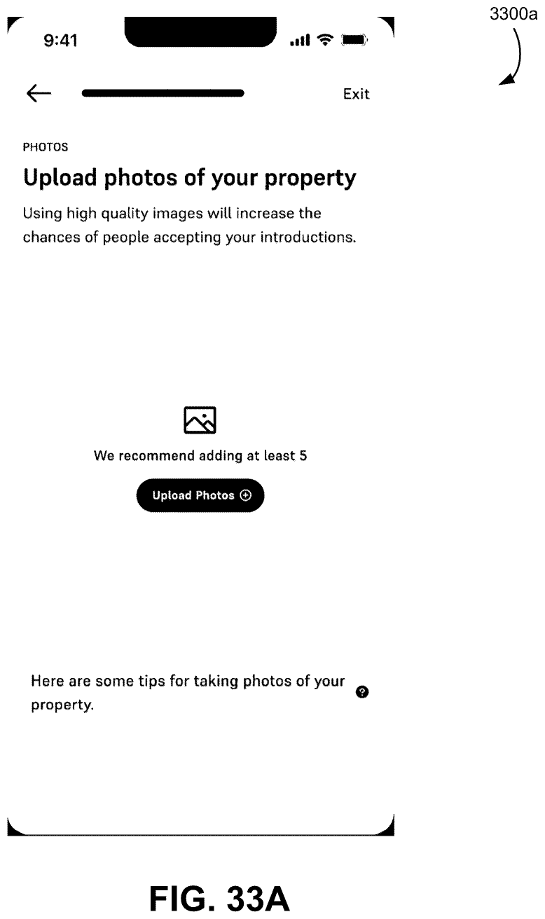

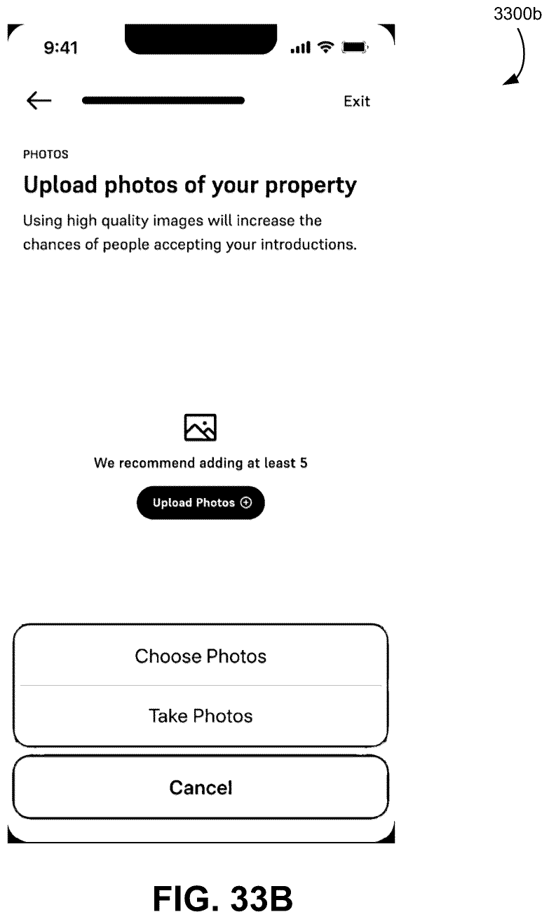

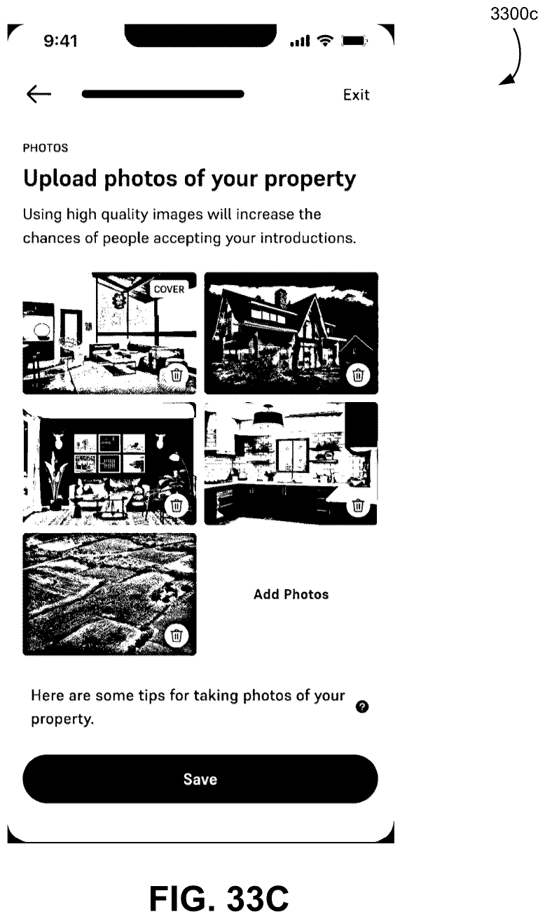

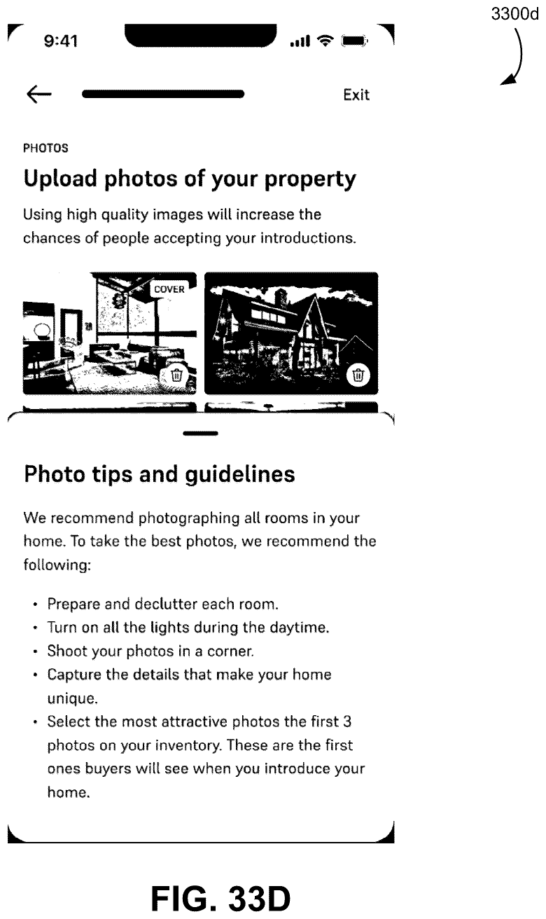

In another example, the Property User can load photos of the property onto the system in various embodiments. For example, the user can either load existing photos or they can take a photo from their mobile phone if using the mobile application of the system. They can designate which photo will be the cover image and can reorder them as needed in various examples, as illustrated in views 3300a-3300d of FIGS. 33A-33D.

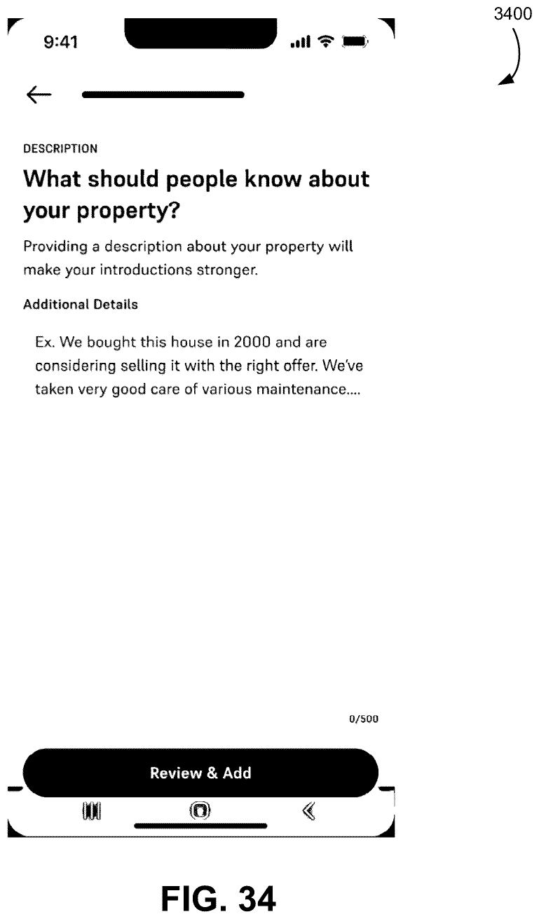

In another example, the Property User can provide a description of their property to make their Inventory more detailed. The user in various embodiments can provide as many or as little details as they see fit. Should they spend time developing a quality narrative about their property, the more likely that the right buyers, renters, or their agents will have more interest when the property is introduced to them. In some embodiments, there will not be a title field like some examples of the want-ad listings on the platform as the address can be the designation of each property, as illustrated in view 3400 of FIG. 34.

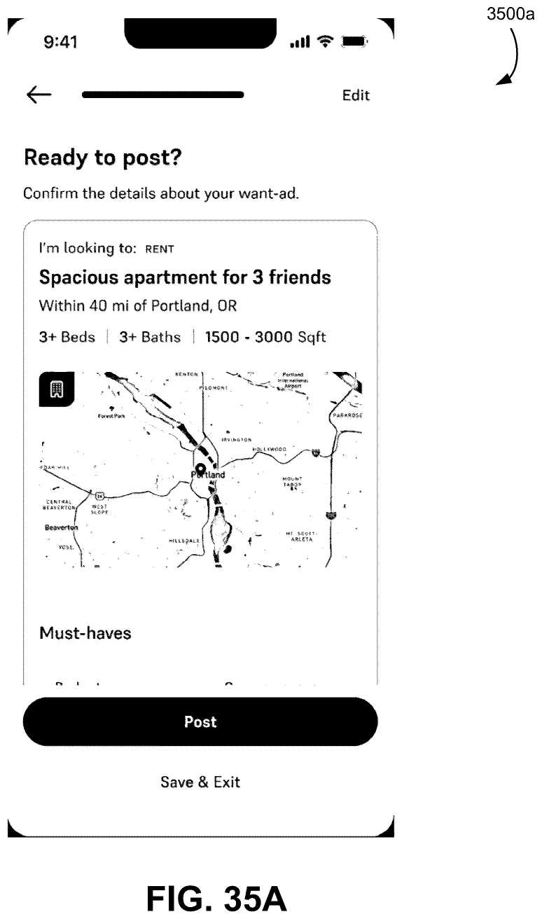

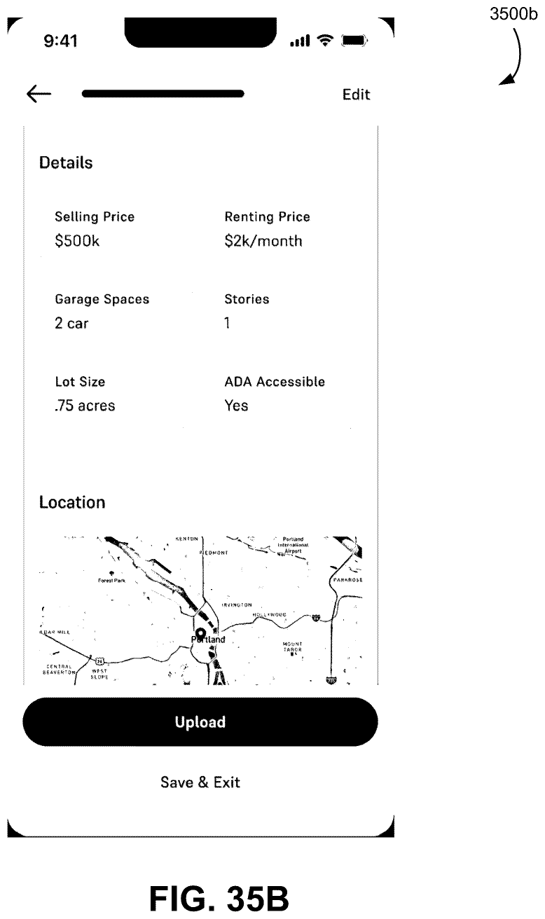

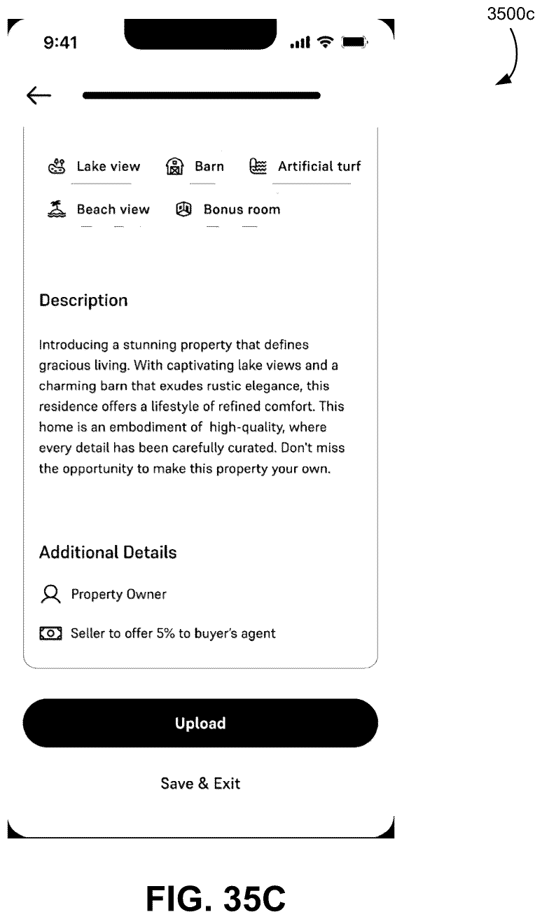

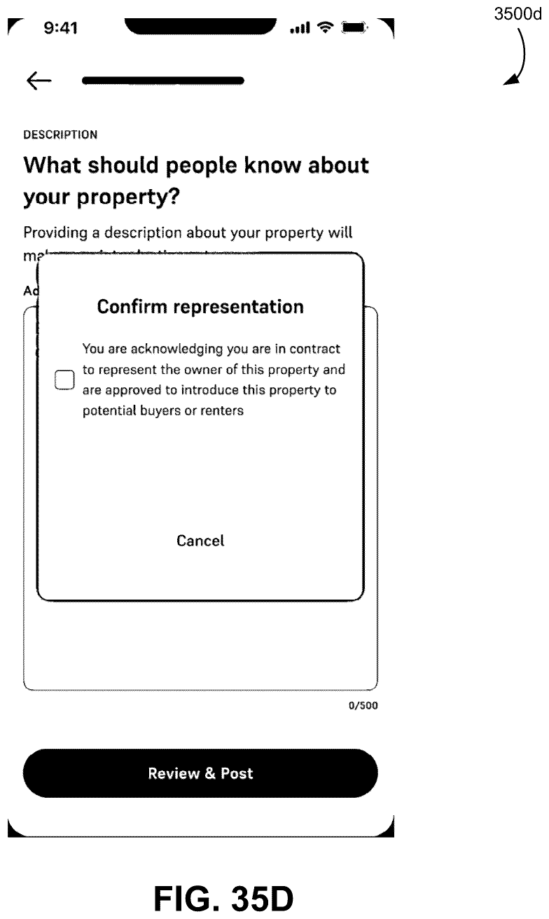

In various embodiments, once the full details of the property have been entered by the owner or their agent, the Property User can review all details of their property for accuracy in the preview screens. Once the address, specifications and photos are all verified by the user, they can click ‘upload’ to store the property into the Inventory section of their private dashboard, as illustrated in views 3500a-3500c of FIGS. 35A-35C.

Should the Property User be a professional agent and the property is to be for sale/introduced to buyers, in some embodiments the agent Property User can be required to confirm that they are in contract to represent the owner of the property before a final upload to their agent Inventory dashboard can occur, as illustrated in view 3500d of FIG. 35D.

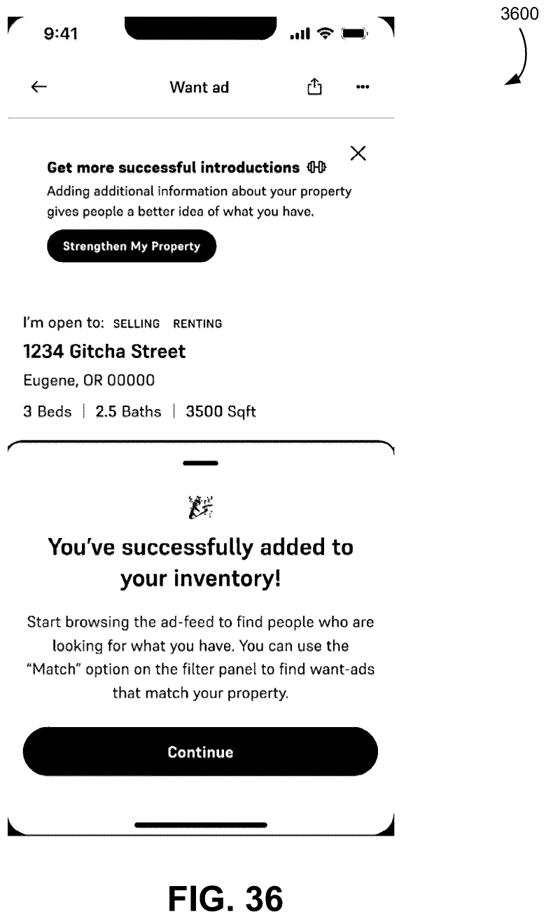

Upon a successful upload, the system of various embodiments can provide the Property User verification that the Inventory has been successfully stored in their private dashboard and the system can provide directions on how to start searching for Want Users who may be seeking a property similar, as illustrated in view 3600 of FIG. 36.

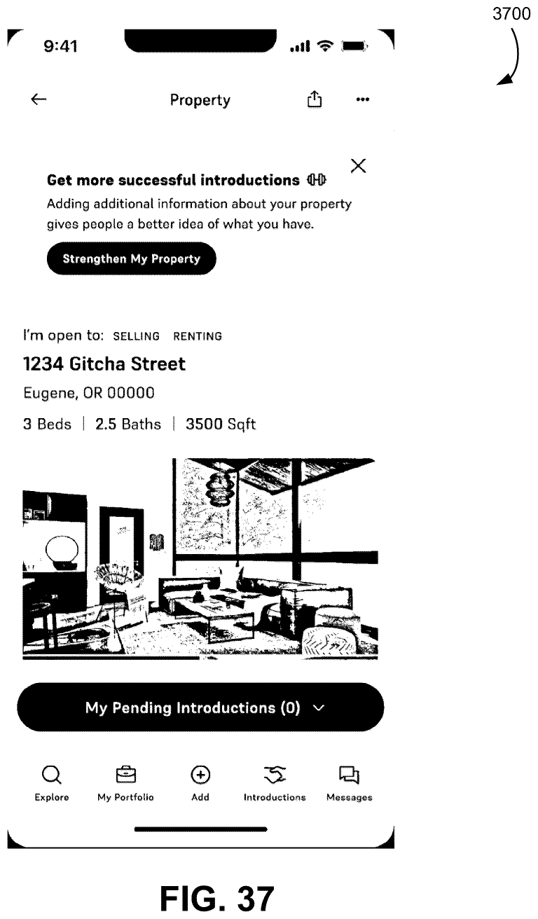

Once the Inventory is added, the system in various embodiments can allow the Property User to enhance the details of their property by clicking ‘strengthen my property.’ By selecting this, the Property User can provide more information, information that can be disclosed to potential buyers that may make their property more attractive, as illustrated in view 3700 of FIG. 37.

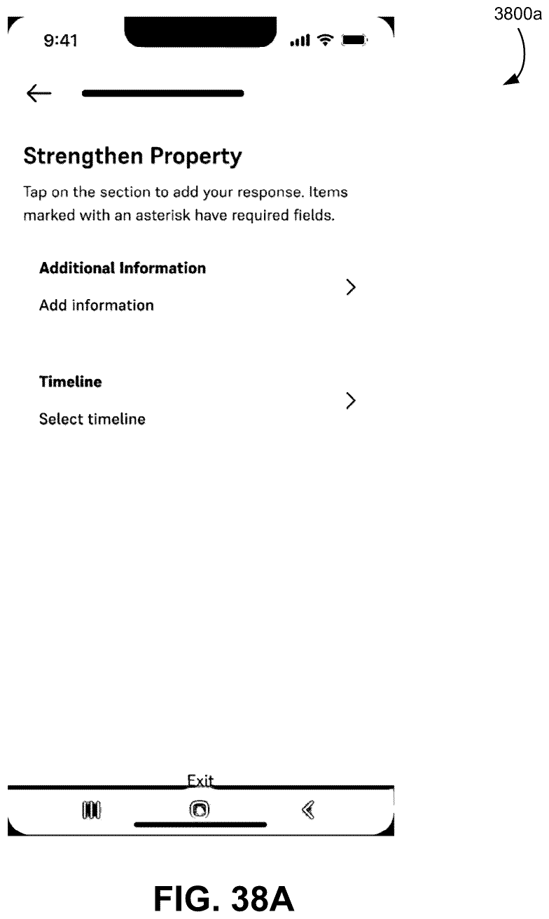

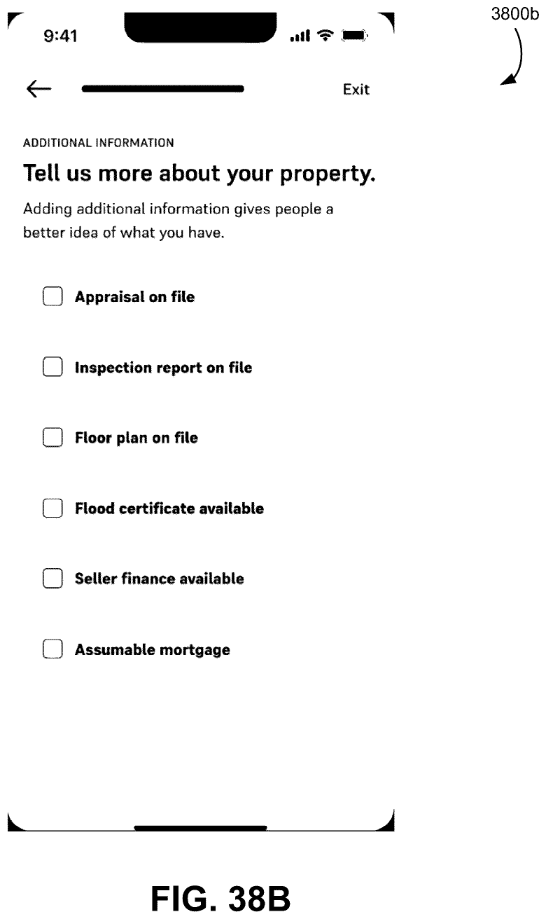

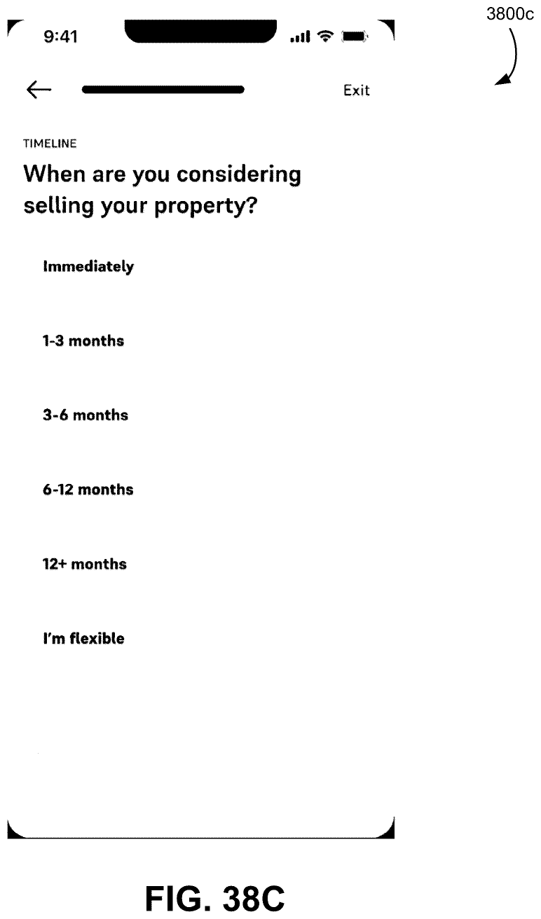

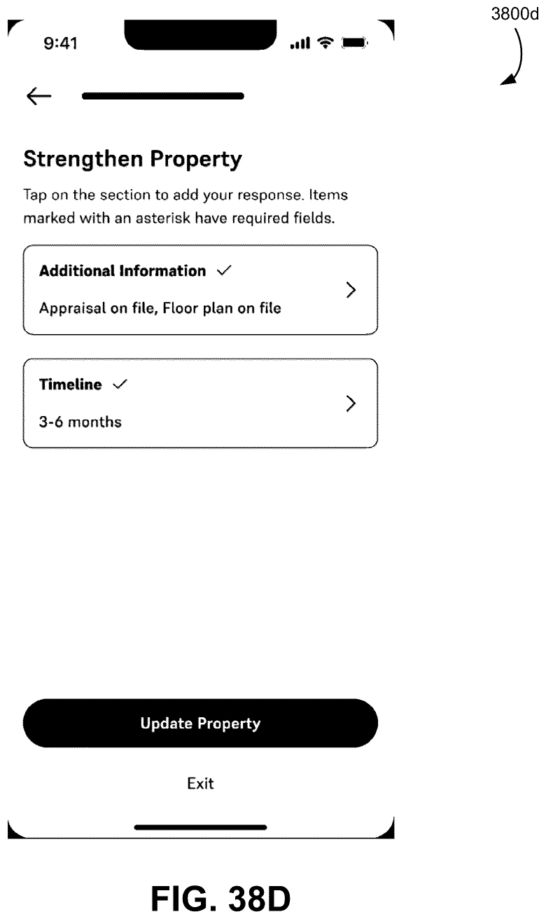

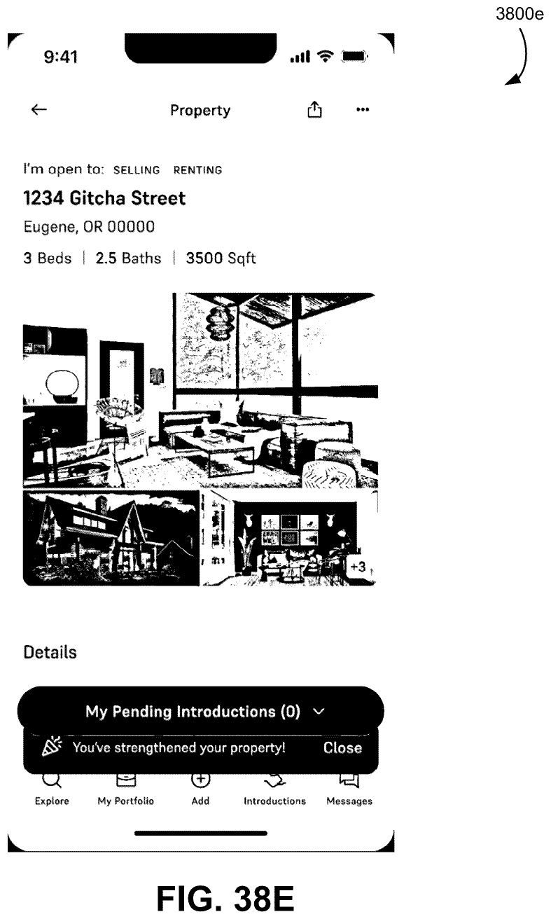

This optional information of various embodiments can be intended to provide assurance that the Property User has helpful documentation to provide that will help keep any potential transaction swift and transparent. The Property User, when utilizing the ‘strengthen my property’ feature, can add more information that includes documents related to appraisals, inspections, floor plans and other certifications, as well as if there are special financing options available. In various embodiments, they can also include more information related to their estimated timeline for selling or renting out their property. By offering items of disclosure and by providing additional context to a buyer or renter it can proactively quell any concerns from a Want User and may strengthen the trust between parties before they even begin communicating, as illustrated in view 3800a of FIG. 38A.

Another piece of information for Want Users can be when the property would be available to be purchased or rented. For the buyer, if the Property User stated they are looking to sell at a point in the future, it may encourage buyers to make offers without contingencies or, at minimum, the Want User can determine if the timeline fits their ideal timeline, too. By proactively offering flexible timeline details from the beginning, it may lead to more connections between buyers and sellers. The Property User looking to sell their property can select in some embodiments: ‘immediately, 1-3 months, 3-6 months, 6-12 months, 12+ months or that they are flexible with the timing. In various embodiments, once the Property User fills in both the additional information and/or timeline, they can review and select ‘Update Property,’ as illustrated in views 3800b-3800e of FIGS. 38B-38E.

The system in various embodiments can provide the Property User directions on how to privately introduce their property to one or more Want Users should they believe what they have is a potential fit to the want-ad listing's parameters.

Example of Connecting Property Users to want Users Via an Introduction System

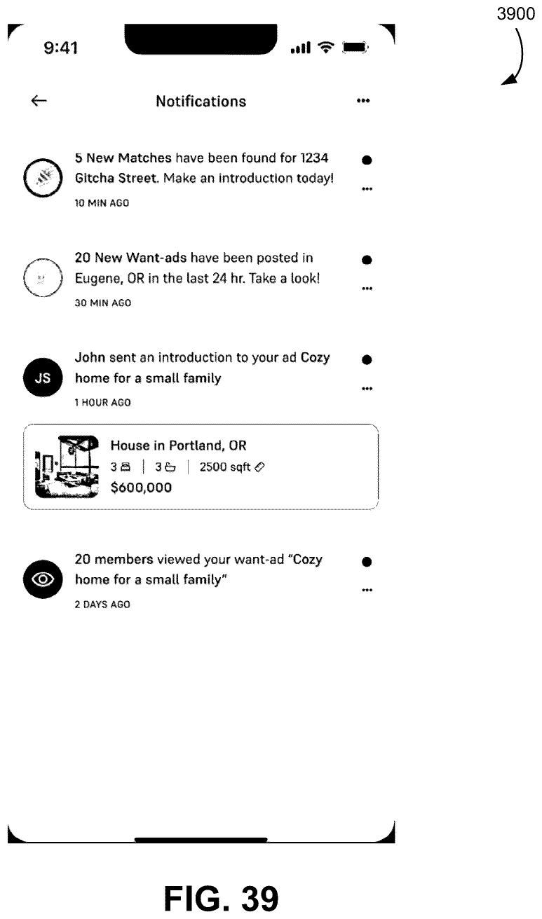

In various embodiments, the system can notify Property Users when a Want-Ad listing matches the parameters of the real property that is stored in their inventory. The Property User can get frequent market updates via the notifications tab in various example, as illustrated in view 3900 of FIG. 39.

Property Users in various embodiments can also manually search the (e.g., national) want-ad listings from the home screen of the system, where they can sort and filter want-ad listings by Want Users desired specifications, location, and price range, or they can enter in a key word to get started. Want-ad listings can be manually searchable and sortable on the home screen in some embodiments by anyone wanting to find want-ads that match their property profile specifically.

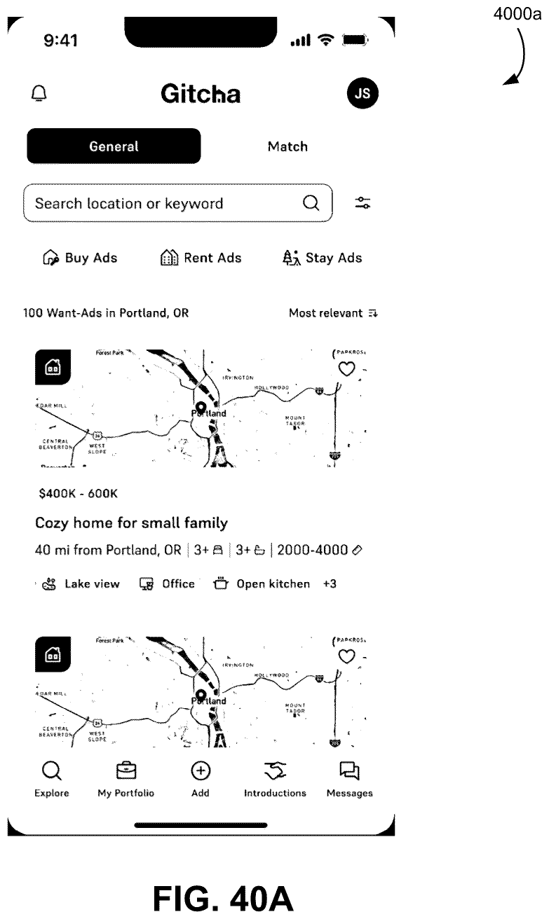

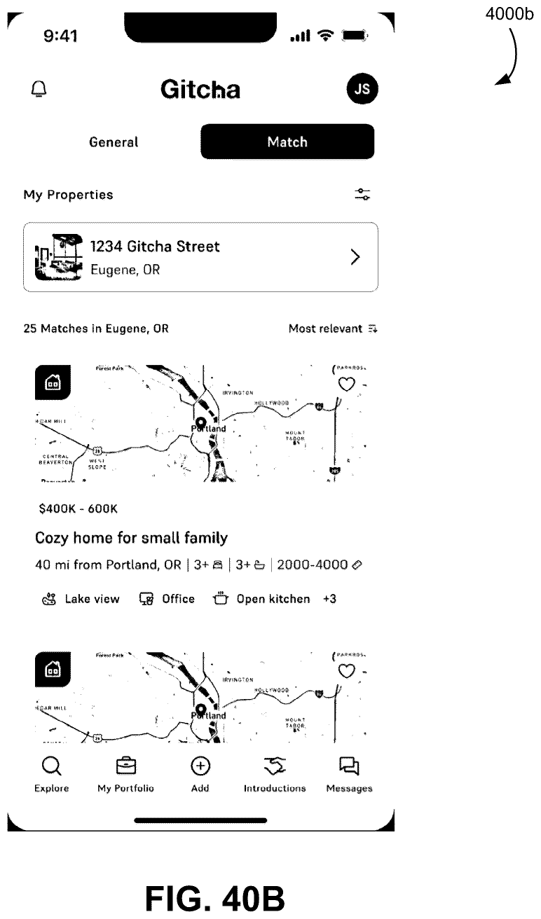

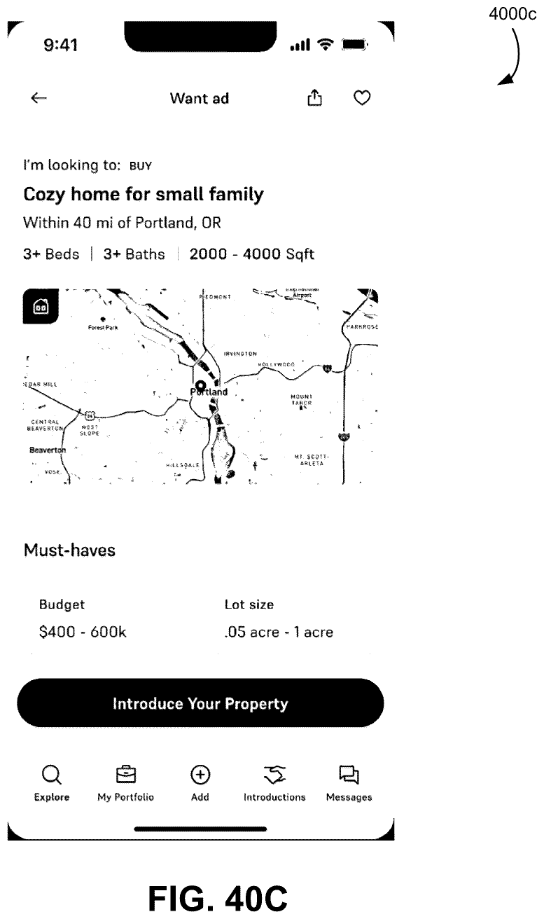

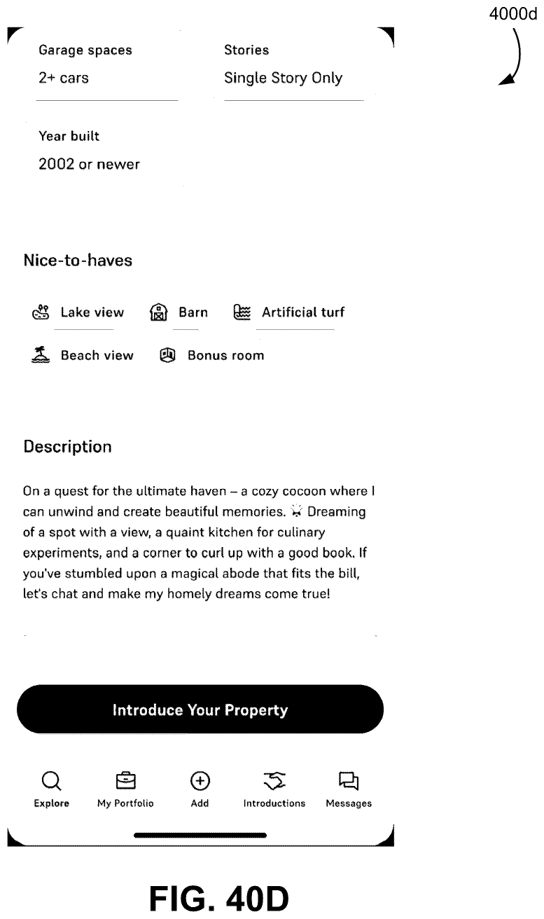

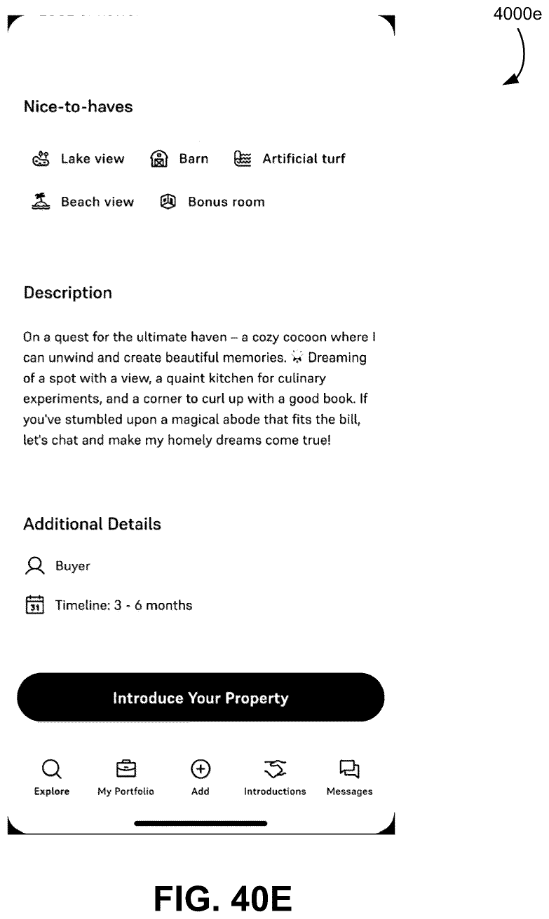

The ability for Property Users to view some or all want-ad listings allows them to utilize system in various desirable ways. In a first example, Property Users can conduct a general search in various embodiments to review the prices Want Users are willing to pay in the current market and what Want Users are looking for in features, specifications, and the location of properties. If the Property User loads their property into their inventory, in various examples they can enjoy automated want-ad listing matches sent to them by the system, too. This can provide Property Users helpful context and information as they contemplate the potential use of one of their properties and as they try and determine the value of their home. The ability to measure real-time Want User demand can be one of the strengths of various embodiments of the platform, as illustrated in view 4000a of FIG. 40A.

In another example, after reviewing want-ad listings and determining listings that might fit what they have, the Property User can attempt to contact the Want User through the Introduction System. The Introduction System can be designed in various embodiments to seamlessly and privately connect Property Users (Sending Party) and Want Users (Receiving Party).

In various embodiments, the Introduction System can provide buyers, renters, and their agents the ability to control communication with an owner or agent through a (e.g., three-step) process comprising of preview, review and connect. Because various embodiments of the system are a want-ad listing platform, a marketplace full of the demand for property, it can be desirable for there to be a safe, convenient, expedient, and private way for those with the want & need to connect with those that have the want & need. Various embodiments of the Introduction System disclosed herein can provide that.

To get started using the Introduction System in various embodiments, the Property User can either find a want-ad listing through a general search or they can select ‘match’ on the top of the screen to show (e.g., all) want-ad listings that match to a specific property stored in their inventory. They can select which property under ‘my properties’ so the system can show them all publicly posted want-ads that closely match their property.

The system can then display the pertinent want-ad listings that match the criteria entered, where the user can review want-ad listings for those that might match their property specifications and location, as illustrated in view 4000b of FIG. 40B.

After the Property User identifies a want-listing that matches the property they are looking to sell or rent out, in various examples they can send out an introduction to the Want User via an Introduction System and can become the ‘Sending Party.’

Through various embodiments of an Introduction System, the Sending Party can privately propose or share their property to the Want User—e.g., a potential buyer, renter, or their agent-who created the want-ad listing (Receiving Party). They can start that process in some examples by selecting ‘introduce your property’ on the want-ad listing. In various embodiments, at the beginning of the process, the Sending Party and Receiving Party will not have their identity disclosed to each other, which can allow both users to preserve their privacy in the early stages of the process, as illustrated in views 4000c-4000e of FIGS. 40C-40E.

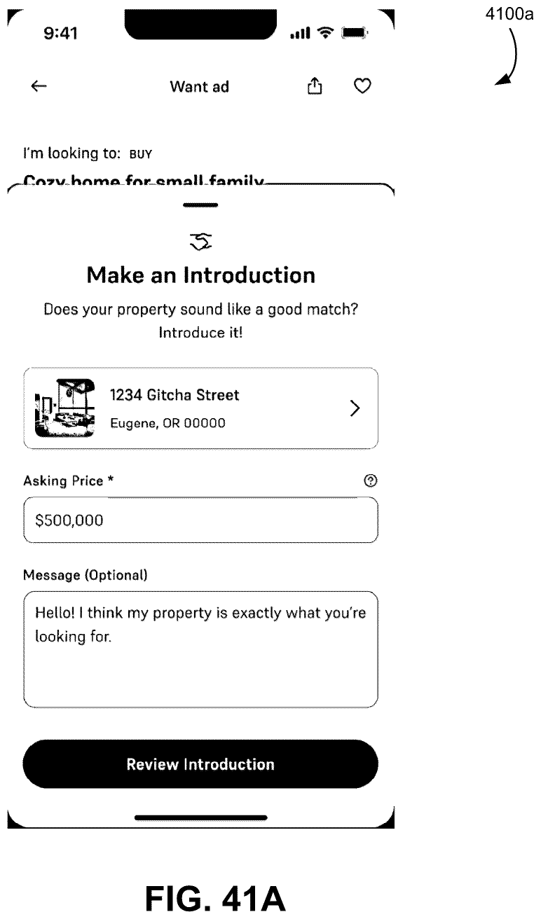

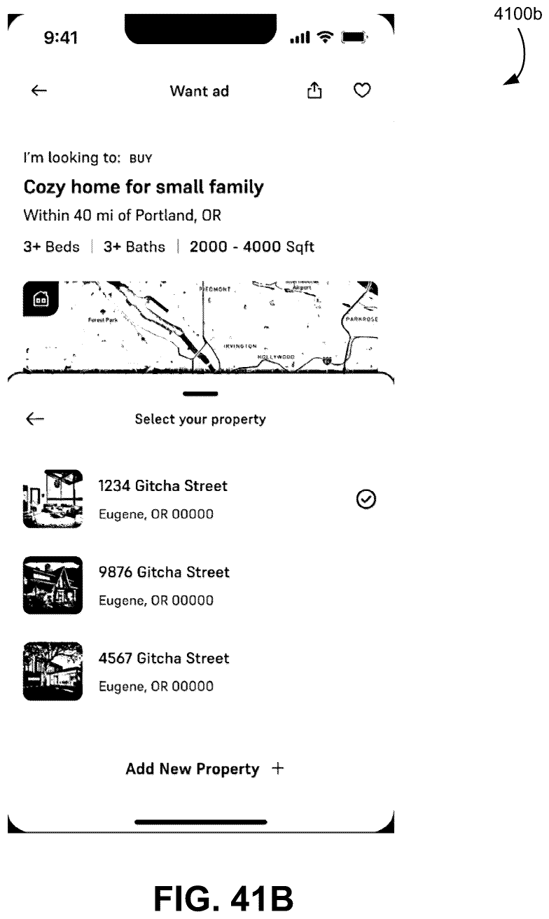

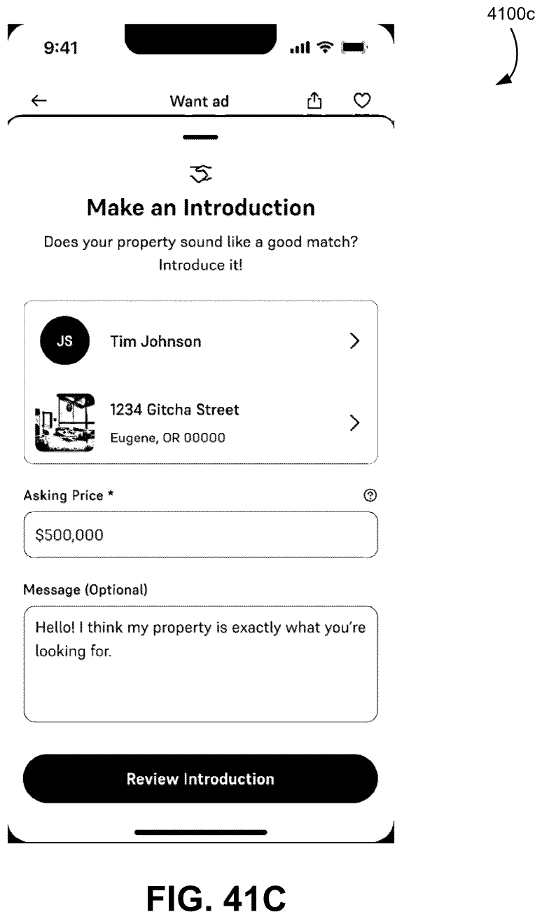

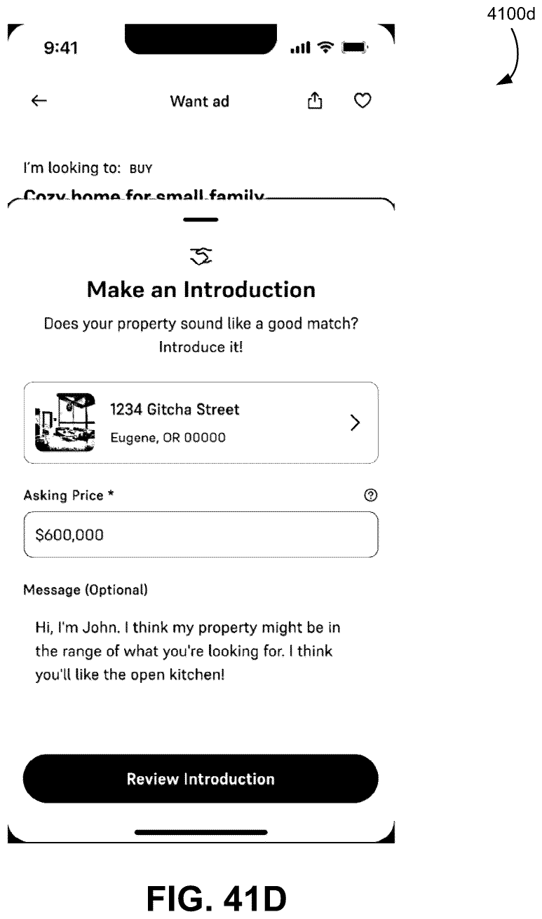

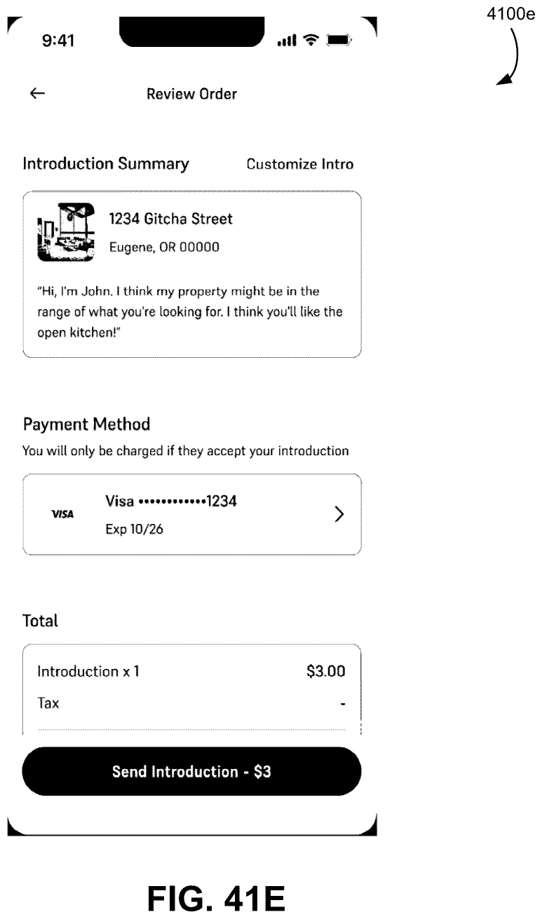

The system can then take the Sending Party to the ‘make an introduction’ screen that requires or allows them to select which property from their Inventory they would like to introduce. If they need to add a new property to their inventory, the system can in some examples can give them an option on a drop-down screen to add new property to their inventory so they can introduce that property, as illustrated in views 4100a-4100b of FIGS. 41A-41B.

For agents who want to introduce real property to the Receiving Party on behalf of a client, in various embodiments the agent can first select what client of theirs owns the property to be introduced, and then can be able to select a property from the Inventory of that client, as illustrated in view 4100c of FIG. 41C.

The ‘make introduction’ screen in various embodiments can display what property in their Inventory has been selected for the introduction and it can provide an area for the Sending Party to add an optional personal message to be sent to the Receiving Party. In some embodiments, the optional personal note will not be seen by the Receiving Party until the Receiving Party accepts the introduction to all the details of the introduced property. In some embodiments, the asking price for the property can also be adjusted before the introduction is sent to the Receiving Party once the Sending Party selects ‘review introduction’, it can take the Sending Party to the ‘introduction summary screen’, as illustrated in view 4100d of FIG. 41D.

As part of the Introduction System's process in various embodiments, a first stage can be a preview stage, where a limited preview of the property details are sent to the Receiving Party. The preview the Receiving Party receives can show, for example, a property's asking price, 3 photos of the property, the specifications of the property such as bedroom/bed count, bathroom count, square footage and lot size, some key features, and a general area where the property is located. The preview in some examples can also share if there are property related documents on file, if there is compensation offered to an agent representing a buyer or renter, the Sending Party's timeline and it can state if it's a property owner or a professional agent who sent the introduction.

During the preview stage of the Introduction System, in various embodiments the system will not reveal the exact location and address, the username or information related to the Owner or Owner's agent, nor will the system provide the written description of the property offered by the Owner or Owner's agent. The full suite of photos and the optional personal message the Property Sender may have included will also not be visible in some embodiments during the first or at least some initial stage(s) of the Introduction System's process.

In various embodiments, the system can limit the information shared at the preview stage of the introduction process, so the Receiving Party has a chance to efficiently determine if what has been introduced/proposed is close to what they are looking for. A primary objective for the Introduction System in various examples can be to give the Receiving Party enough information to swiftly look at the property details from a data-driven perspective.

The preview stage in various embodiments can allow the Receiving Party to keep their identity confidential until they determine what has been proposed could be worth looking further into, and the process can be designed to help deter spammers and unwanted correspondences sent to the Receiving Party. For example, should an unqualified introduction make it to the Receiving Party, the preview stage can be designed to make any poor/ill-intended introductions quick and easy to discard prior to seeing any messages from the Sending Party.

For the benefit of the Sending Party, in various embodiments the design of the Introduction System can keep the Property User from being charged for sending the introduction until the Receiving Party deems it could be a potential fit for what they are looking for, and it can allow the Sending Party to also preserve their privacy by not revealing their username & exact address should the Receiving Party decline the introduction during the preview stage.

To maximize the opportunity of having their introduction accepted, the Sending Party's first goal in some examples can be to create and send a compelling introduction to the Receiving Party so the Receiving Party is encouraged to review the full details of their property. Refining the details of the preview before it is sent to the Receiving Party can be one way to optimize the results of the introduction, and in various examples the Sending Party can improve the preview by adjusting a few important specifics. To do so, in some embodiments, the Sending Party can utilize the ‘customize intro’ feature that is shown on the ‘introduction summary’ screen, as illustrated in view 4100e of FIG. 41E.

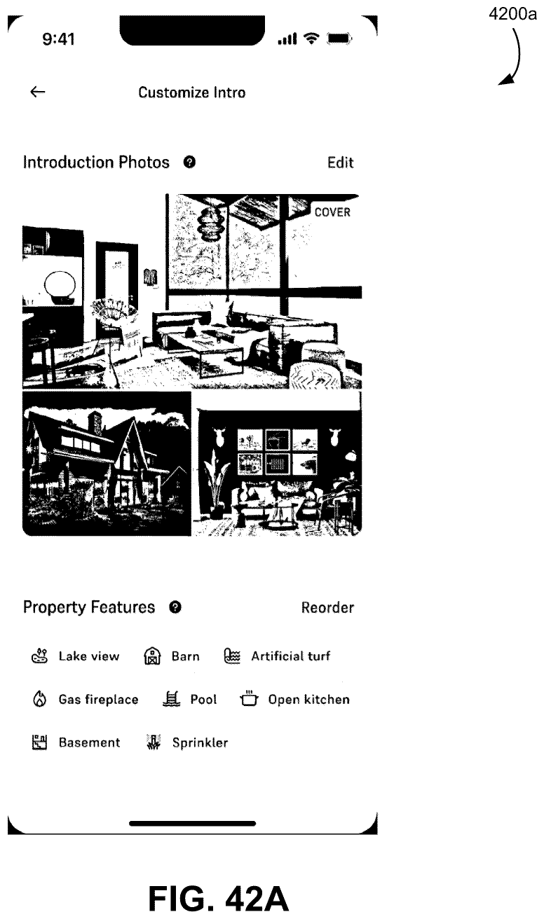

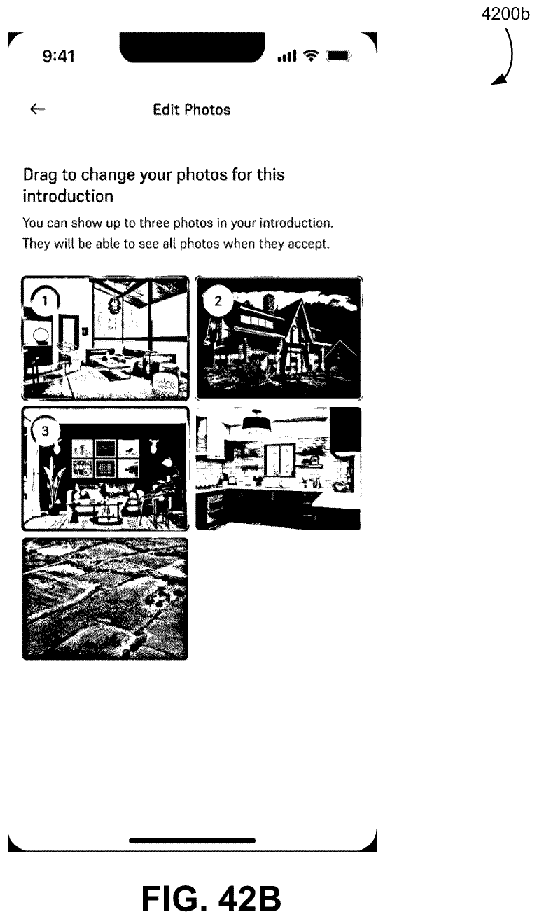

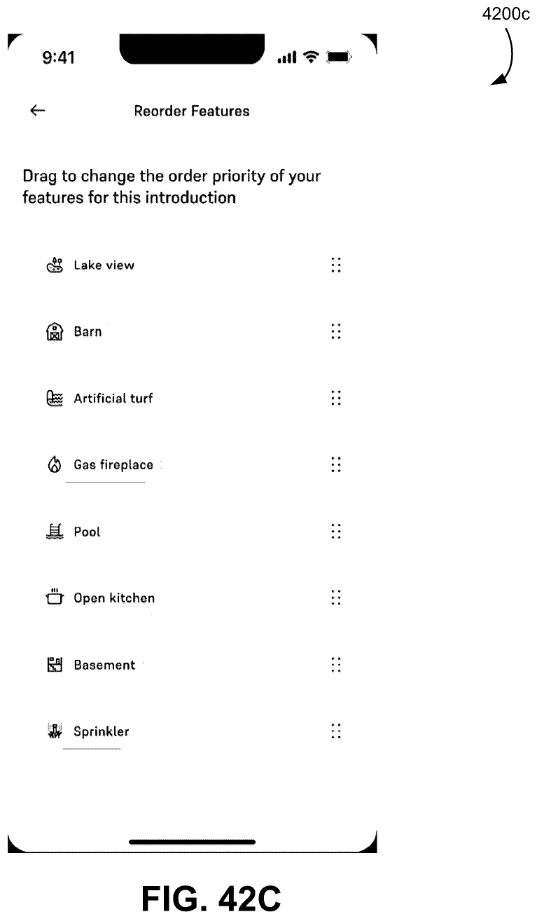

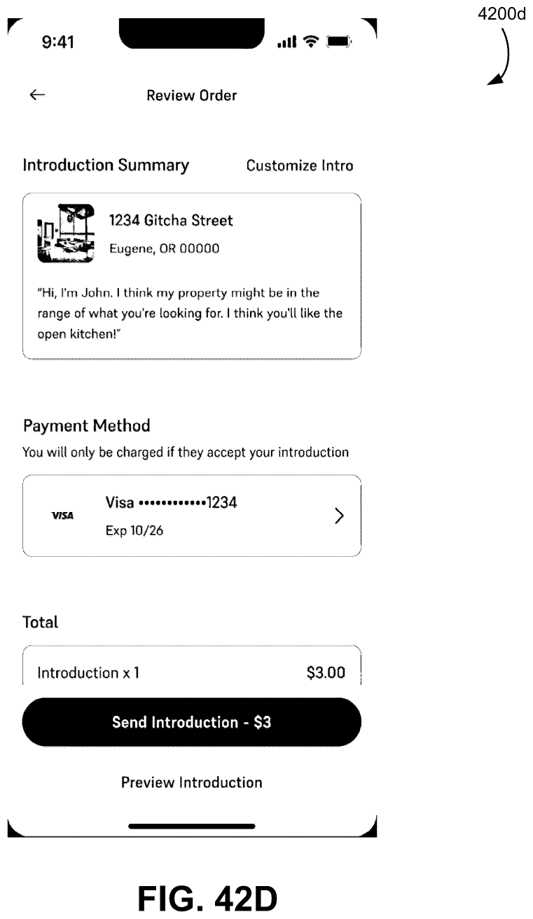

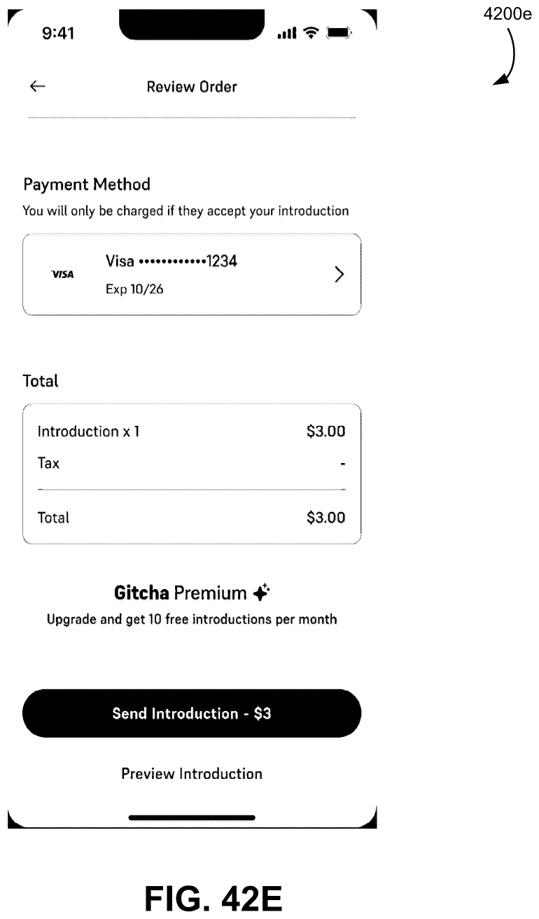

In various embodiments, the system can provide the Sending Party the opportunity to not only change the price of the property before an introduction is sent, but also the order in which photos and features will be highlighted—with the ‘customize intro’ feature, the Sending Party can prioritize what photos (e.g., top three photos) are seen by the Receiving Party as part of the preview and can reorganize the order of the property's key features shown as well. This can allow the Sending Party to prioritize photos and features that may match some of the key wants & needs mentioned as part of the Want User's want-ad listing, as illustrated in views 4200a-4200c of FIGS. 42A-42C.

In various embodiments, once the Sending Party has had an opportunity to customize the introduction's price, photos, order of features and has had the opportunity to add a personal message for the Receiving Party, they can review the order before sending. Before the introduction can be sent, the Sending Party can be required in some examples to submit a credit card (or other suitable payment method) to pay an introduction fee should the introduction be accepted by the Receiving Party.

In various embodiments, if the Sending Party has a monthly subscription to the platform, they may also be able to select from available included introductions for the month (or they can have a chance to subscribe to a monthly prepaid package of introductions if they don't already), which in some examples can include a pre-purchased package of introductions at a reduced rate. Once a user's pre-purchased introductions are used up within a month, in some examples they can pay a per-introduction fee for the rest of the month, upgrade their subscription, or the like.

In various embodiments, a fee paid by the Sending Party to introduce the property to the Receiving Party is only charged once the Receiving Party decides to accept the introduction to view more. If the Receiving Party opts to decline the introduction after reviewing the quick preview, in various embodiments no fee is charged to the Sending Party. A fee to use the Introduction System can be a desirable part of some embodiments of the process as it can act to dissuade Property Users from sending unwanted, unqualified introductions to Want Users, as illustrated in views 4200d-4200e of FIGS. 42D-42E.

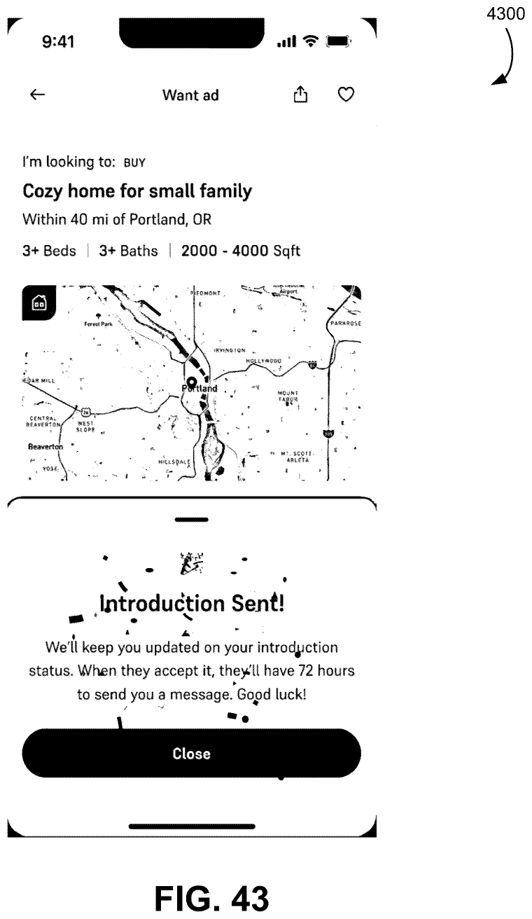

Once the Introduction is successfully sent by the Sending Party, the system in various embodiments can provide an ‘Introduction Sent’ confirmation to the Sending Party, as illustrated in view 4300 of FIG. 43.

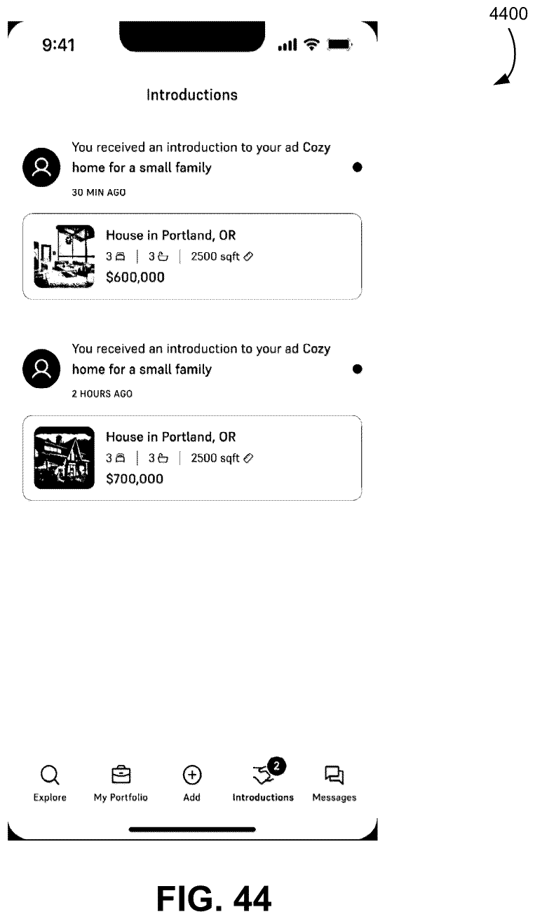

Once the introduction is sent by the Sending Party, in various embodiments the Receiving Party can get a notification from the system that there has been an introduction to their want-ad listing. The introductions notification screen in some examples can list recent introductions in order of time received, can show what want-ad listing each introduction is for and/or it can show a small preview screen with a photo, price and a few specs of the property that has been introduced, as illustrated in view 4400 of FIG. 44.

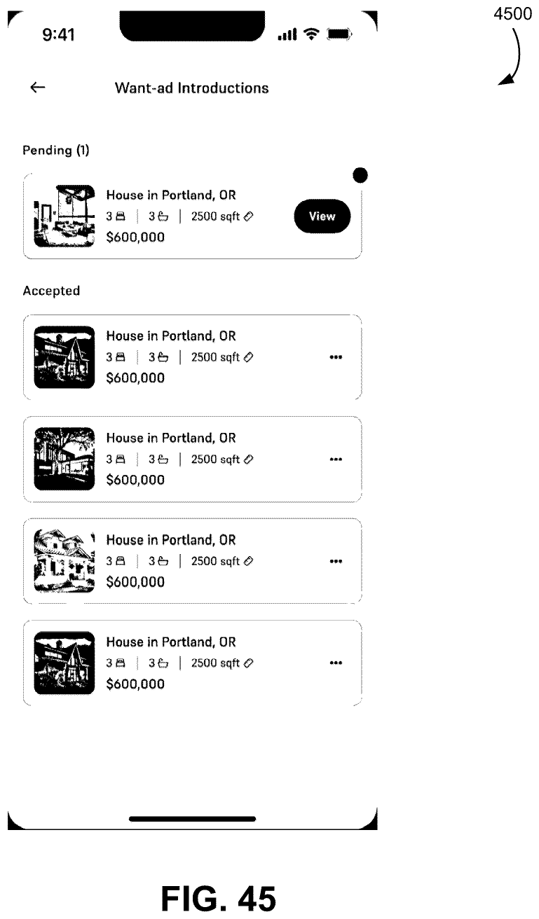

The Receiving Party in various embodiments can also see a list of received introductions on the want-ad introductions screen, where it can show accepted introductions and introductions that have not been responded to. In some examples, introductions that have yet to be responded to can be under the ‘pending’ designation, as illustrated in view 4500 of FIG. 45.

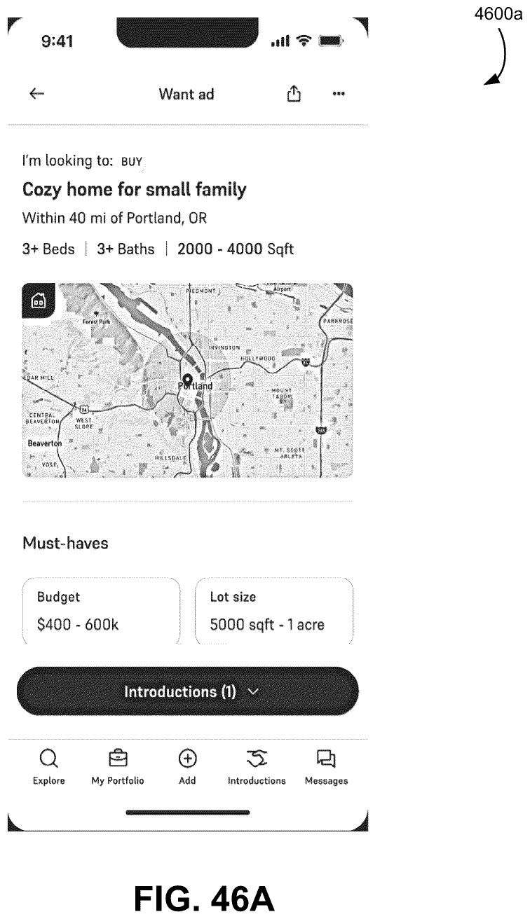

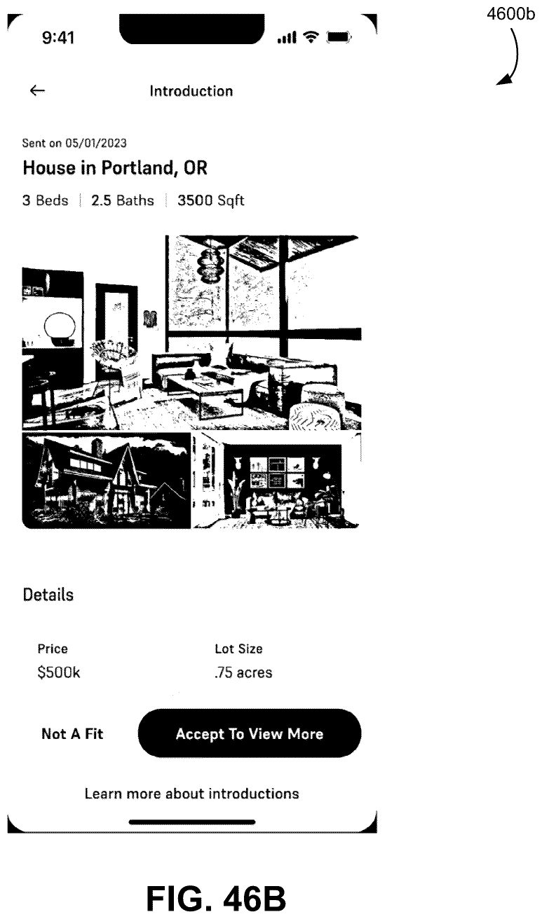

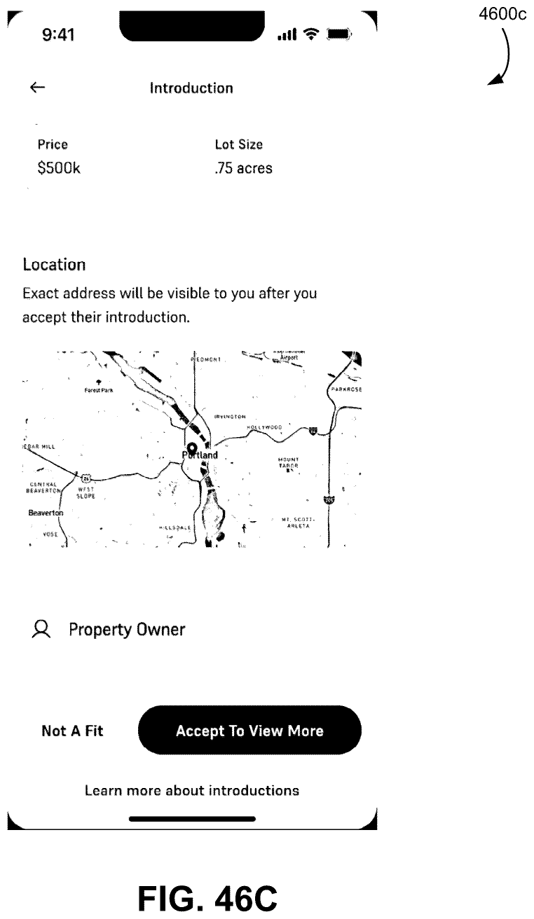

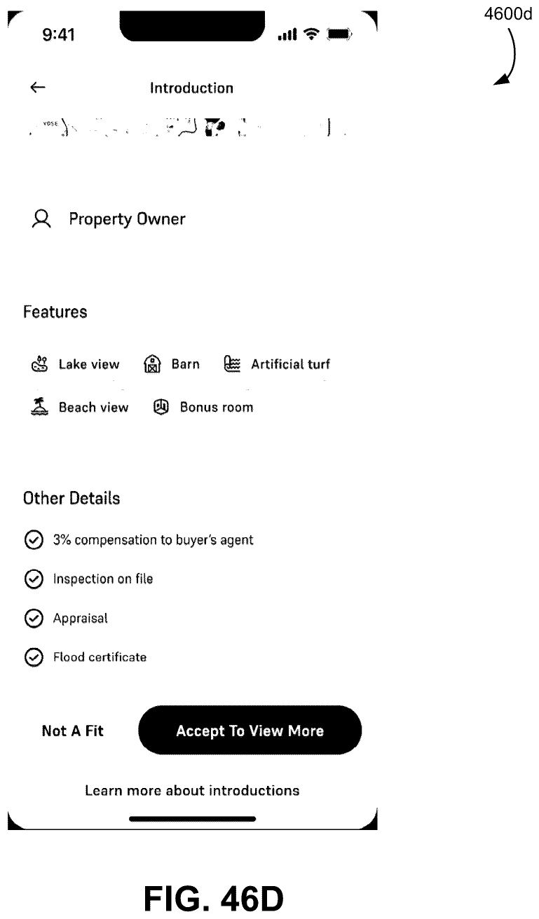

Received introductions can also be found by a Receiving Party in various embodiments by going to their individual want-ad listing, where it can highlight the number of introductions that have been sent to that particular listing, introductions that have not yet been viewed by the Receiving Party. The user in some examples can select the introductions tab on their want-ad listing to go to the preview screen of the property sent by the Sending Party, as illustrated in view 4600a of FIG. 46A.

The Receiving Party in various embodiments can have the opportunity to view the preview of the property, a preview that in some examples can include, consist of or consist essentially of include 3 photos of the property, the bedroom count, the bathroom count, the square footage, the asking price, the lot size and general location as well as some of the features of the property. And, while the introduction system of various embodiments can keep the identity of both parties private at this juncture, the system can indicate to the receiving party if the sender is an owner or if it's an agent acting on behalf of the owner. The system in some examples can also provide the section of ‘other details’ to the receiving party in the preview, such as if the sending party will pay an agent commission as part of their property sale or rental, the key timing of when the property will be available for rental or purchase, and/or if there are related documents or certifications available for review like an appraisal, an inspection report, etc. If the property is sent to a buy want-ad listing, in some examples it can also indicate to the Receiving Party if the Sending Party is open to providing financing or if there is an assumable mortgage available, as illustrated in views 4600b-4600d of FIGS. 46B-46D.

The Introduction System in various embodiments can provide the Receiving Party full, partial or a large amount of control once the introduction preview is received. For example, in some embodiments, no communication can be initiated by the Sending Party, and the Receiving Party not only gets to choose to accept or decline the introduction, but also has the exclusive ability to start the communication between parties too.

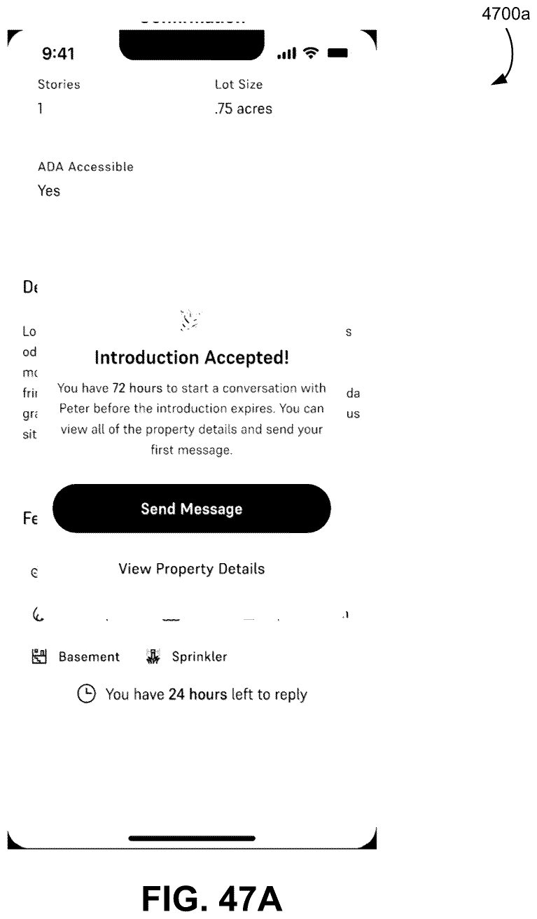

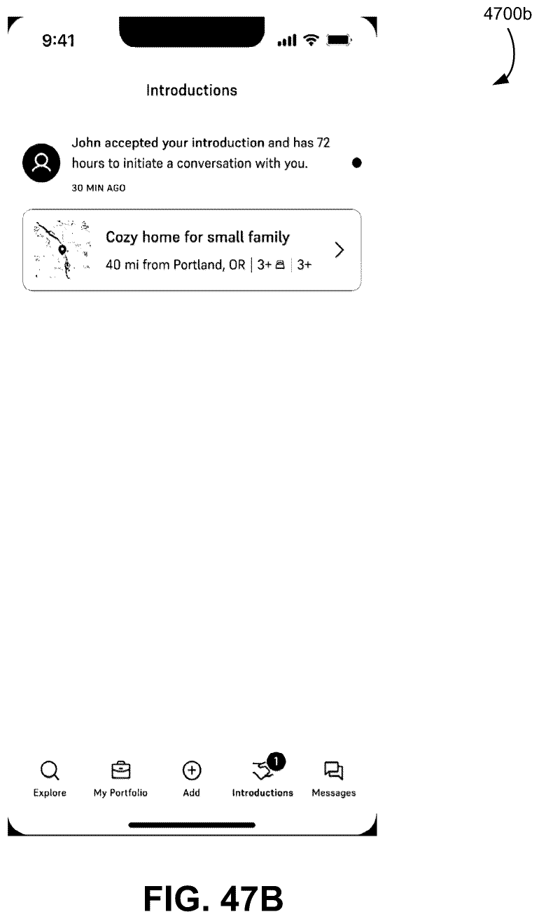

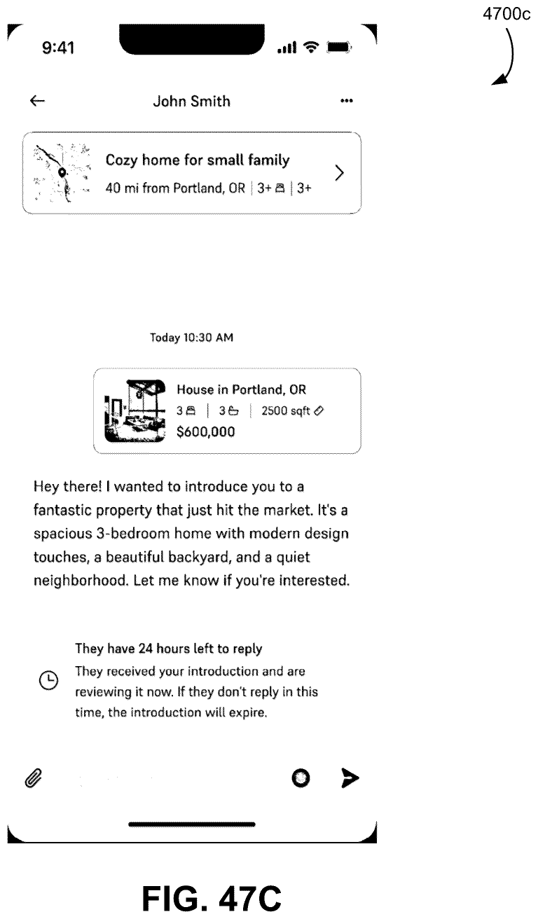

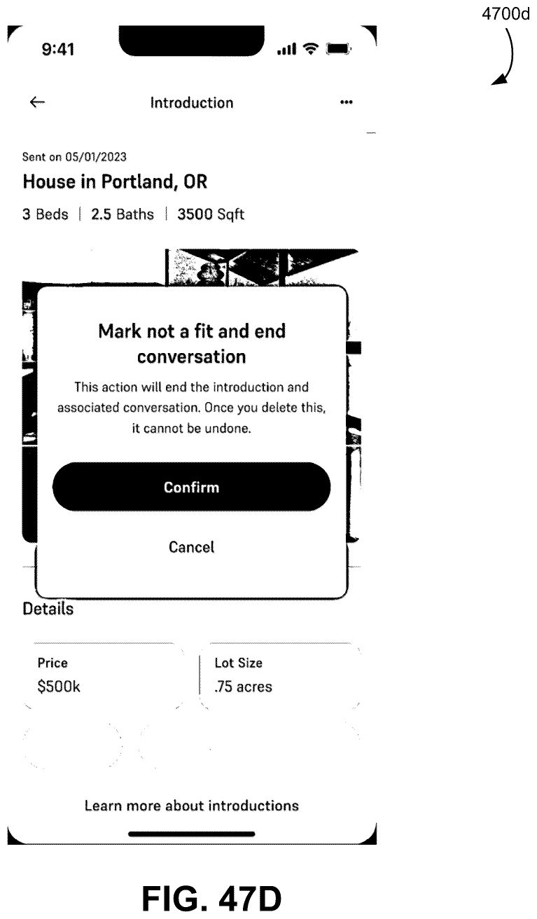

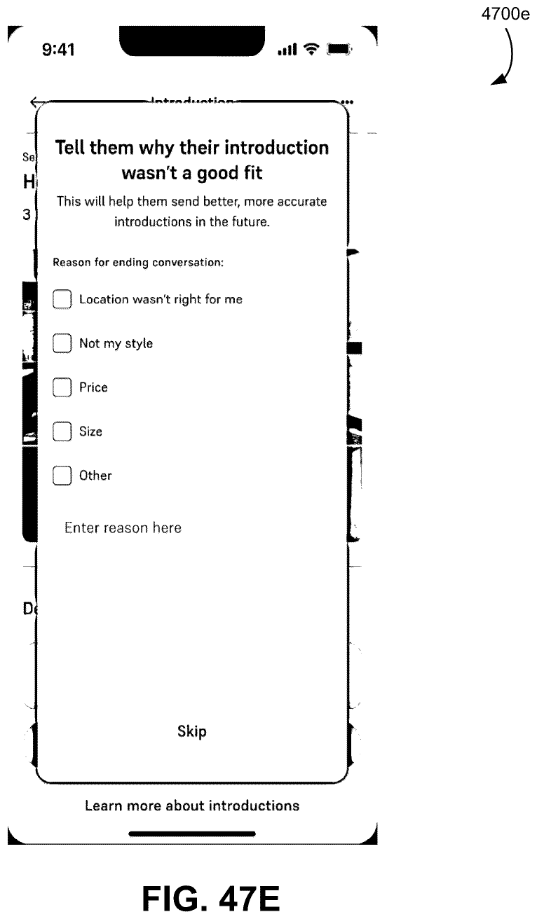

Should the Receiving Party be interested in learning more information on the property and choose to accept the introduction, in various embodiments they can select ‘accept to view more’ to go to a review stage of the Introduction System. In some examples, once they accept the Introduction, the system can provide confirmation to the Receiving Party that they have accepted the introduction. The Introduction System in various examples can then provide Receiving Party the option to either immediately message the Sending Party or to review all the property details. At this stage in some embodiments the system can also advise the Receiving Party that should they want to communicate with the Sending Party, they will need to do so within 72 hours of accepting the introduction or any other suitable amount of time such as 12, 24, 36, 48 hours or 1 week, 2 weeks, one month, or the like, as illustrated in view 4700a of FIG. 47A.

For the Sending Party, once the Receiving Party accepts or declines the Sending Party's introduction, the system in various embodiments can notify them that their introduction was either accepted or declined via a notification. It can also open up a messaging screen in some examples with the name of the Receiving Party, and how much time is left for the Receiving Party to reply in order to initiate the two-way conversation. This screen in some examples can also show the private note that the Sending Party included with their introduction, as illustrated in views 4700b-4700c of FIGS. 47B-47C.

If the Receiving Party decides they don't want to see more information and they decline the introduction during the preview stage, in various embodiments the Receiving Party can select ‘not a fit’ and they can confirm that they want to mark the introduction as ‘not a fit’. This can end the introduction process and in various examples it can prevent any potential conversation between parties based on that specific introduction, for a period of time, or permanently between the given users on the system. The Receiving Party in various examples can have an option to provide the Sending Party a reason for declining the introduction, and the sending party can receive a notification that their introduction was declined and the reason why their property was not a fit for the Receiving Party if a reason was provided, as illustrated in views 4700d-4700e of FIGS. 47D-47E.

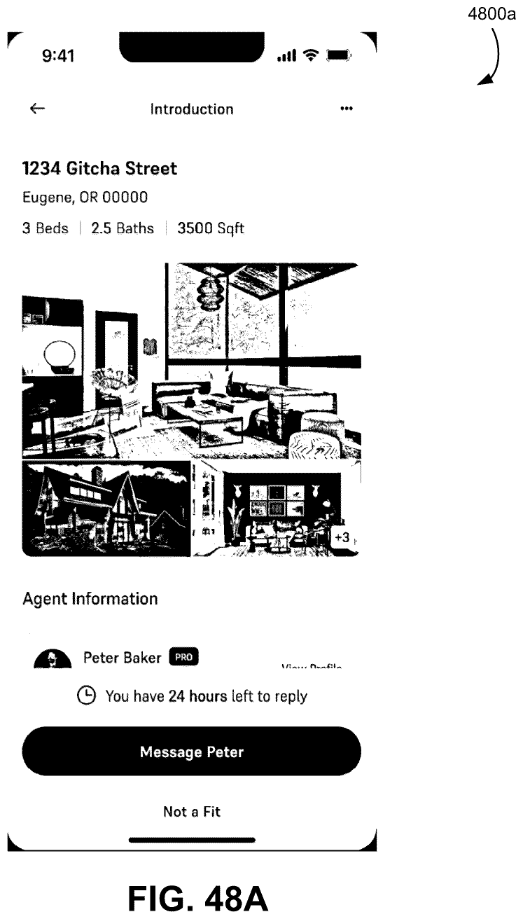

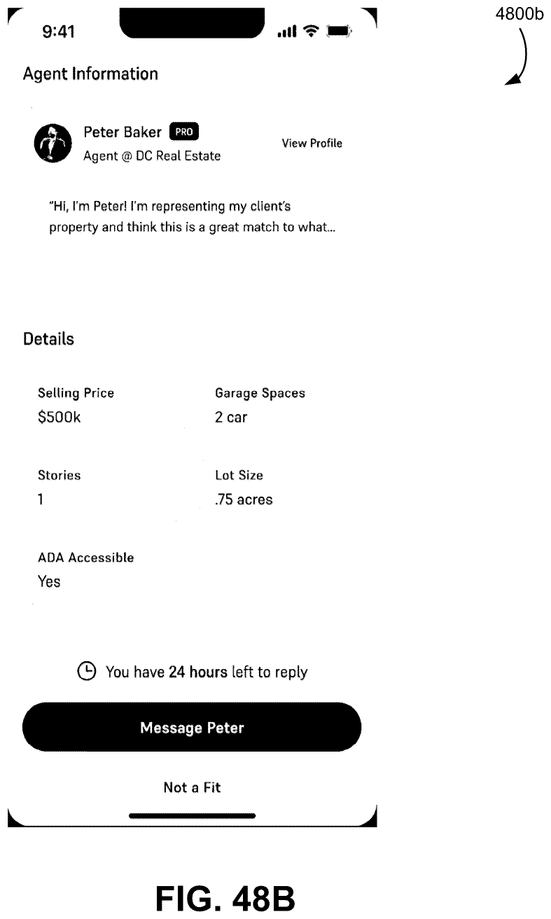

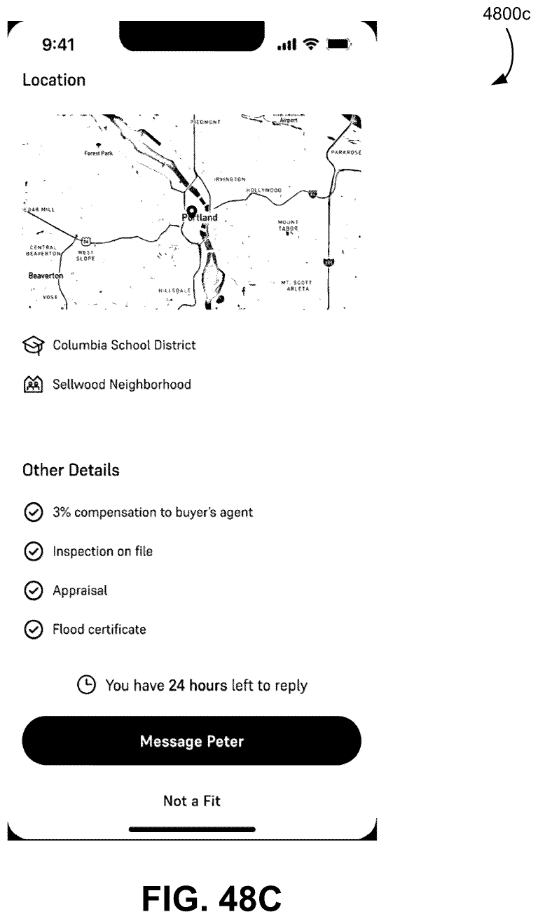

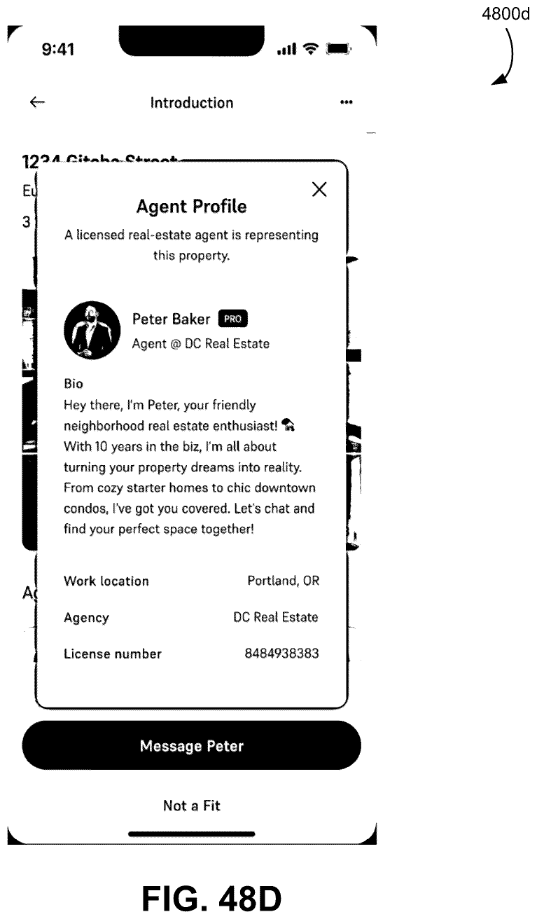

If the Receiving Party chooses to accept the introduction during the preview stage, in various embodiments the Receiving Party will be able review the full details of the property, the description of the property, all the photos and the exact address in a review stage of the Introduction System. In various embodiments, they can also see the private personal note provided by the Sending Party in this stage as well as the username of the Sending Party, as illustrated in views 4800a-4800c of FIGS. 48A-48C.

If the Property User is a professional agent that sent the introduction, in various embodiments the Receiving Party will be able to select ‘view profile’ to view, for example, the agent's bio, work location, real estate agency and license number, as illustrated in view 4800d of FIG. 48D.

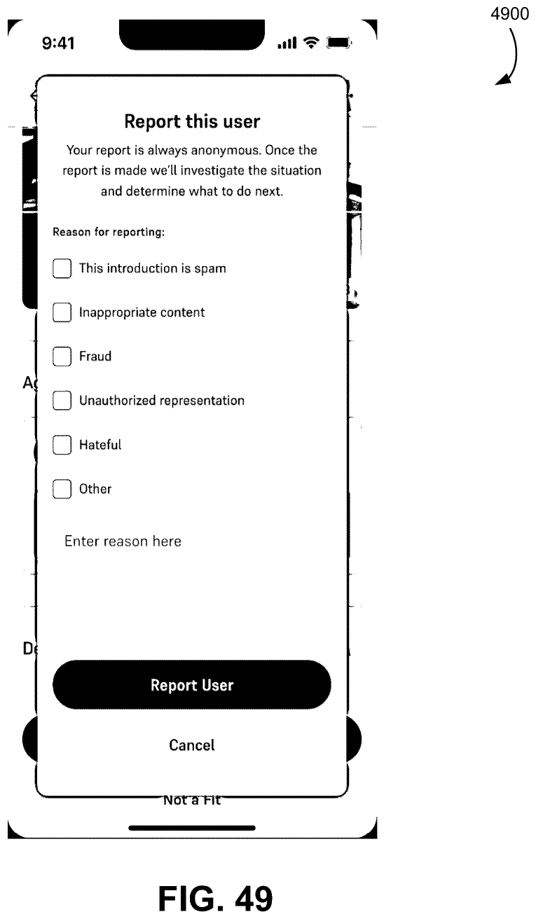

Following the review of the full details of the property introduction, for example including the description and private message, and should the Receiving Party believe the Sending Party sent an introduction identified as spam, a correspondence with fraud, hate or other inappropriate content, or is not authorized to represent this property, they can report the user in various examples, as illustrated in view 4900 of FIG. 49.

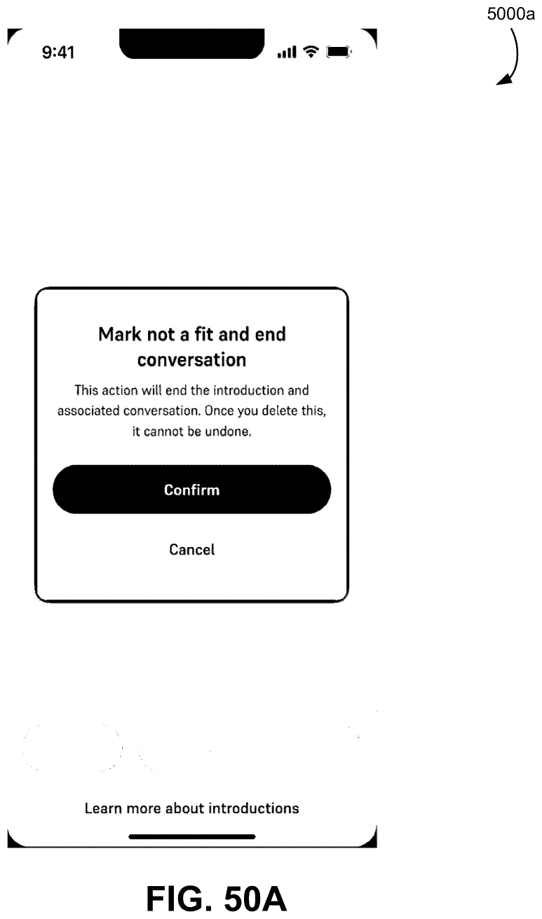

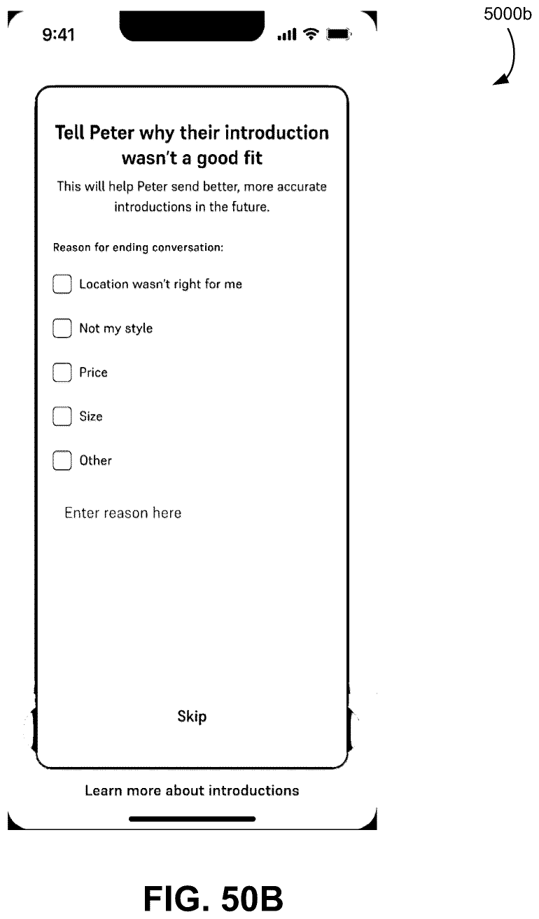

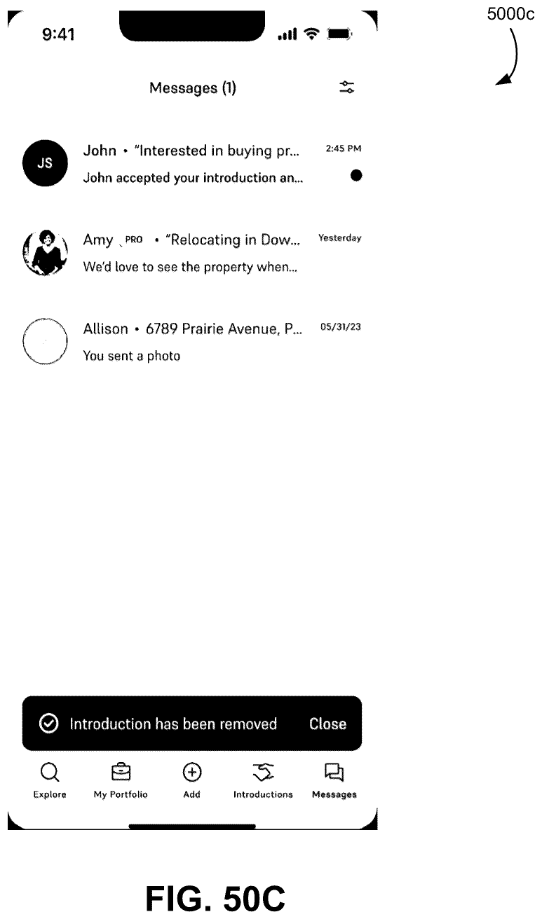

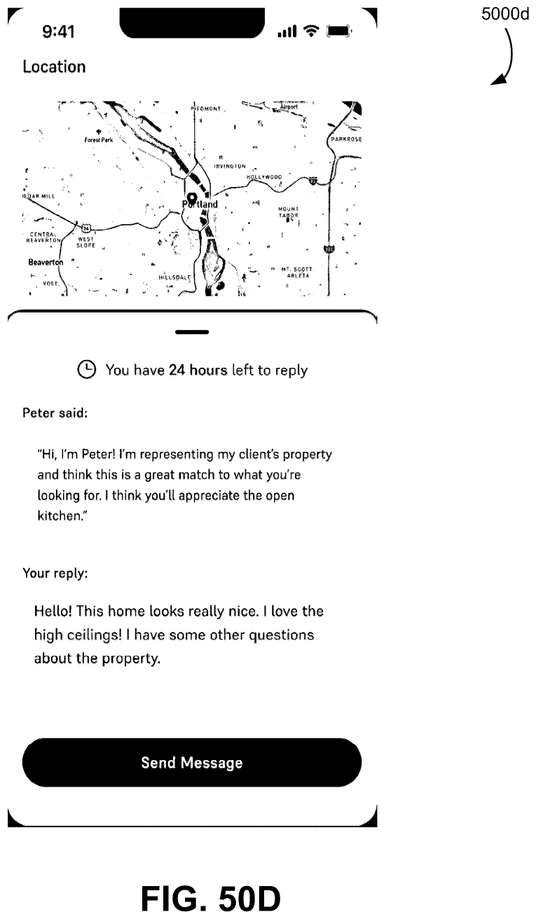

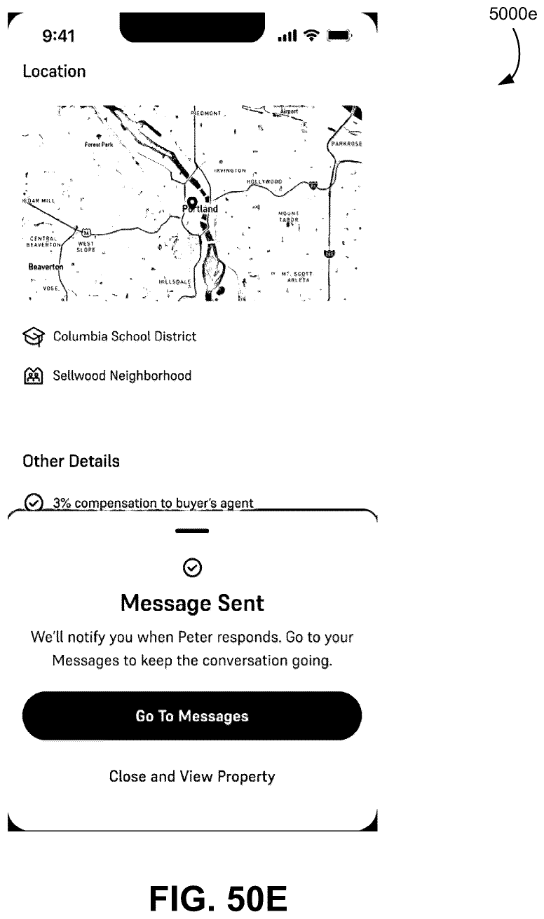

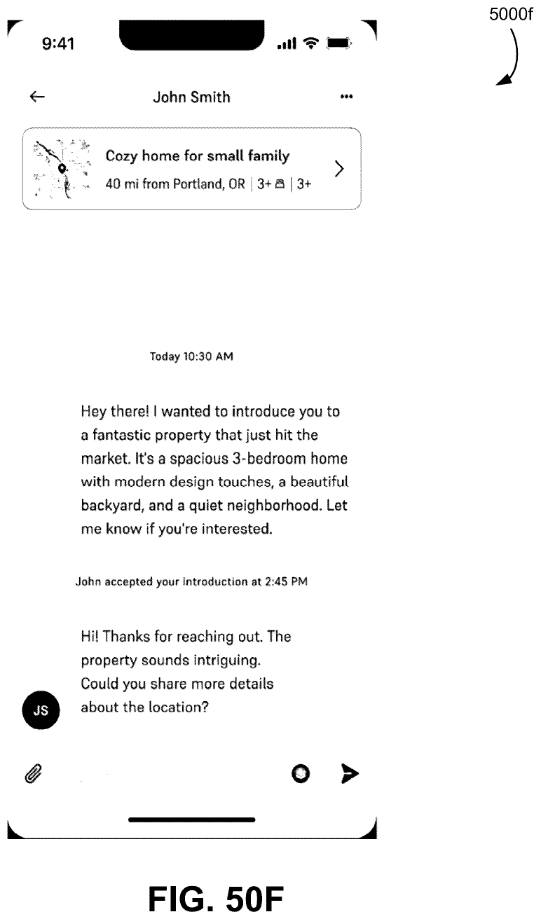

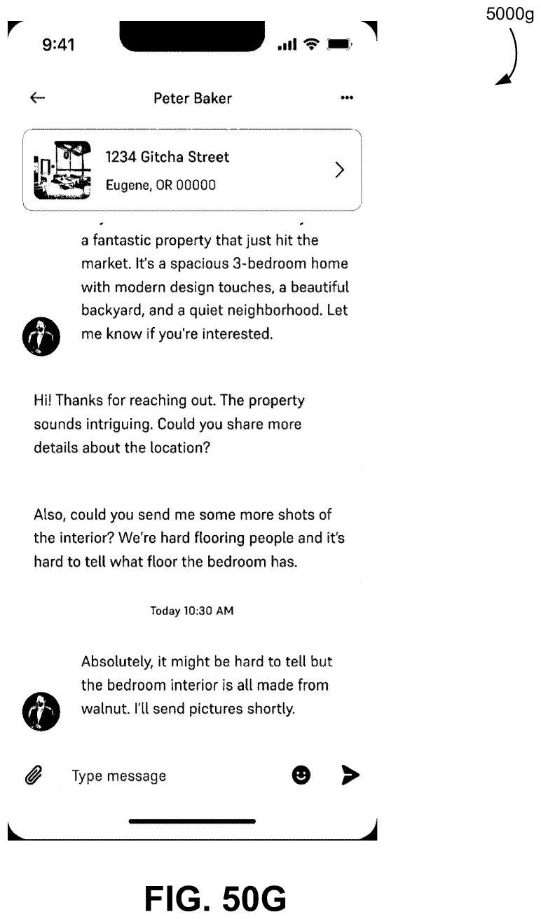

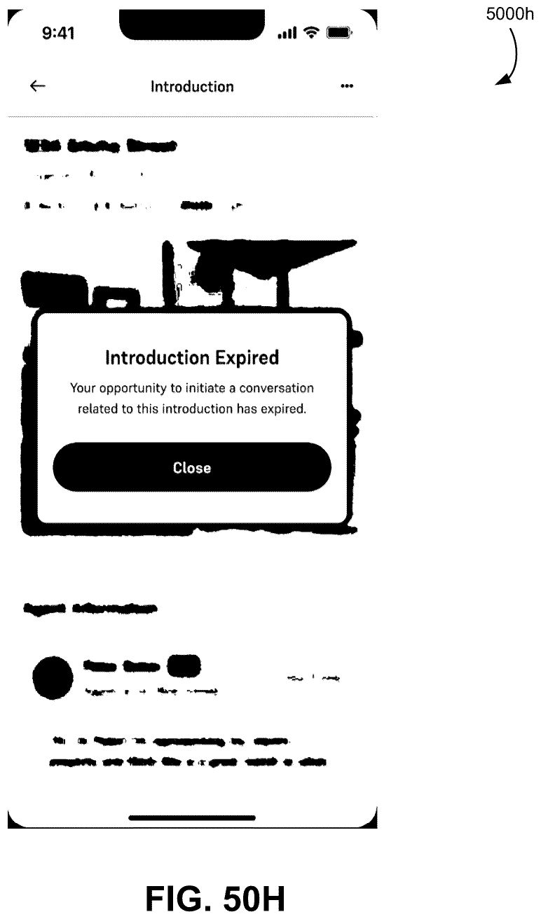

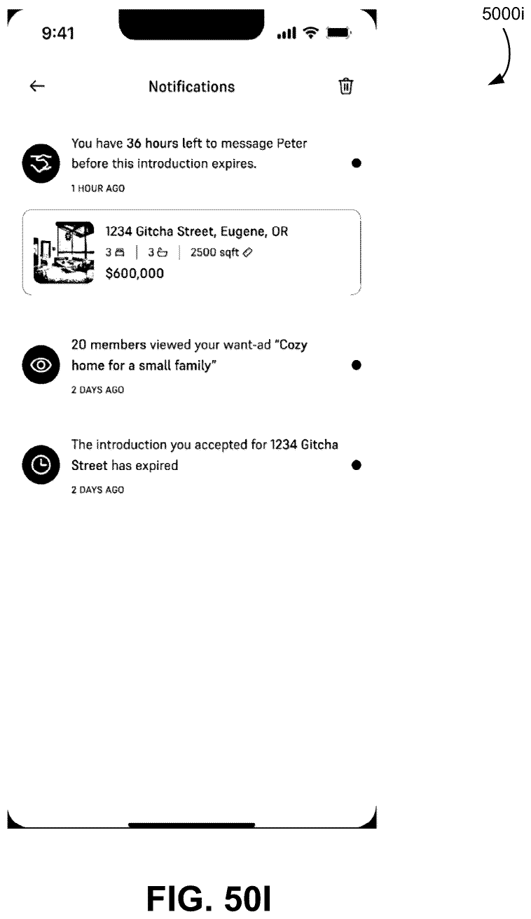

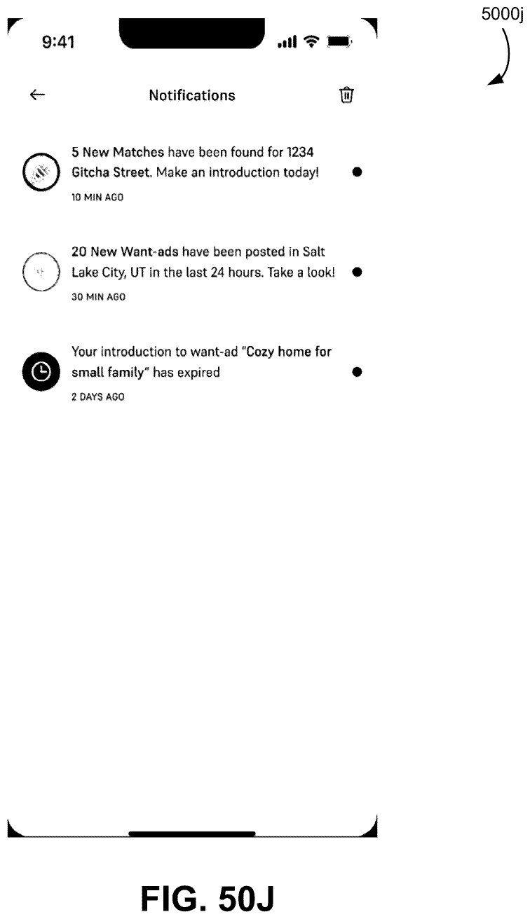

Such an Introduction System in various embodiments can allow the Receiving Party to take the process from the review stage to the connect stage if they want to get in touch with the Sending Party. Because in various embodiments they control the connection process of the Introduction System, in some examples only the Receiving Party has the right to initiate any communication between the parties and they can do that by responding within 72 hours or other suitable timeframe as discussed herein. Or, if after the Receiving Party reviews the property information and personal message and determines they are not interested, in various embodiments they can choose to end the connection phase of the introduction by marking ‘not a fit’, as illustrated in view 5000a of FIG. 50A.

Once the introduction has been ended by the Receiving Party, in various embodiments they can provide the Sending Party a reason why the property is not a fit, and then the introduction can be removed from the Receiving Party's introduction summary screen in some examples. At this stage, they may know the party's name since they have reviewed the full details of the property, as illustrated in views 5000b-5000c of FIGS. 50B-50C.

If, following the review of the introduction the Receiving Party is interested in talking to the Sending Party about the property, in various embodiments they can initiate 2-way messaging with the Sending Party who sent the introduction by choosing ‘message’ at the bottom of the review introduction screen, and a messaging portal can appear where they can write a custom message. They will have 72 hours (or other suitable time period) from the time they accept the introduction to correspond with the Sending Party and a countdown can show on the screen—this limited period of various examples can ensure the sending party isn't left without a response indefinitely should there be sincere interest. A timer can show them the time left to respond to the introduction and initiate the conversation between the parties, as illustrated in view 5000d of FIG. 50D.

Once a response is sent by the Want User to the Property User, the system in various embodiments can provide confirmation to the Want User that the message was successfully sent to the Property User and it can open up a two-way messaging portal where both parties can communicate with each other at this juncture, as illustrated in view 5000e of FIG. 50E.

Once the message is initiated, in various embodiments the Property User can get a notification that there is a new message on their introduction and it can take them to the messaging screen with the Want User, as illustrated in view 5000f of FIG. 50F.

The messaging portal can be where the parties can interact and communicate about the specific property introduced, a place where they can provide more details to each other, schedule a showing of the property as needed and may even negotiate privately. The system in some examples can then provide both parties third-party referrals to local professionals to help complete a potential transaction should they need assistance in putting together an agreement or help in facilitating inspections, financing, appraisals, repairs, or other property-related services, as illustrated in view 5000g of FIG. 50G.

Should the Receiving Party accept the introduction but then fail to initiate a conversation with the Sending Party within the 72-hour time period (or other suitable time period), in various embodiments the introduction's connection stage can expire, and, for example, Receiving Party's screen will blur, and a notification on the introduction screen will appear ‘your opportunity to initiate a conversation related to this introduction has expired’, as illustrated in view 5000h of FIG. 50H.

Upon an expired introduction, in various embodiments both parties can receive a notification that the introduction has expired. For the Receiving Party, they can get a notification that ‘the introduction you accepted for (address) has expired’. For the Sending Party, they can get a notification that the introduction that had been accepted expired and no conversation can occur. The Sending Party in various embodiments can have the option to resend the property to the Want User again should they see fit, as illustrated in views 5000i-5000j of FIGS. 50I-50J.

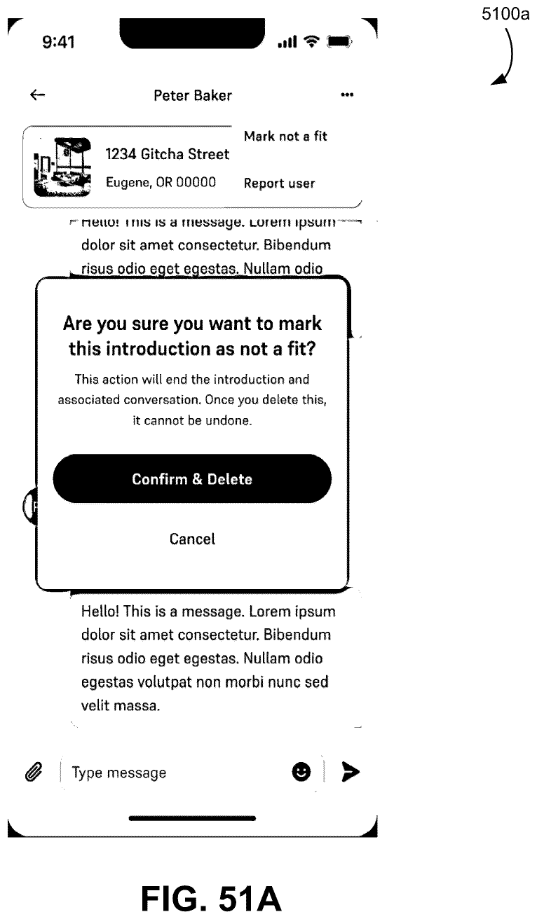

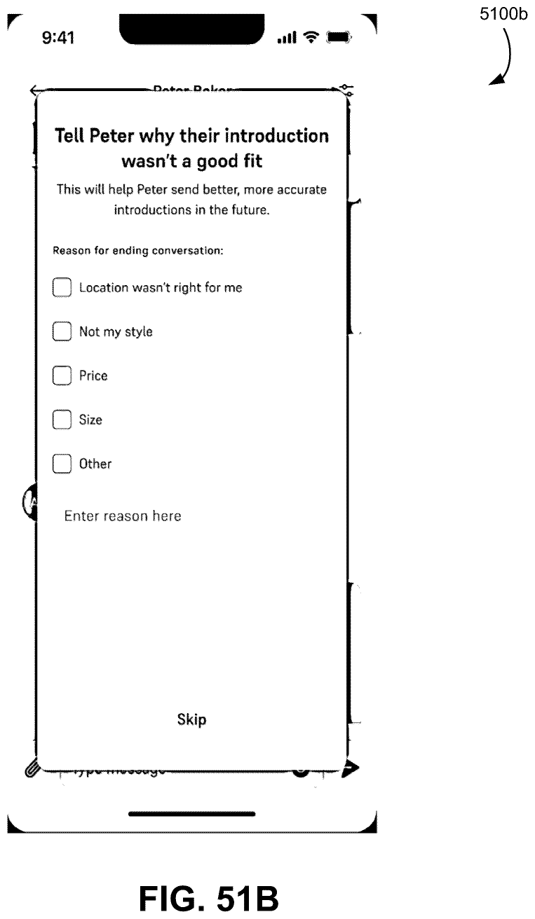

In various embodiments, if the Receiving Party decides to not pursue the property further and wants to end the conversation with the Sending Party at any time during the messaging stage of the process, they can click ‘mark not a fit’ to end the conversation and in some examples can be able to provide the Sending Party the reason for ending their conversation on the next screen. This can prevent any more communication happening between parties, as illustrated in views 5100a-5100b of FIGS. 51A-51B.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood. however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A system, comprising:
one or more processors; and
memory that stores computer-executable instructions that, if executed, cause the one or more processors to:
receive, a plurality of want items from one or more want users, individual want items of the plurality of want items specifying a plurality of attributes of a good or service desired by the one or more want users;
receive a plurality of property items from one or more property users, individual property items of the plurality of property items specifying a plurality of attributes of a good or service offered for consumption by the one or more property users;
generate and publish an online listing of the plurality of want items, the online listing being publicly accessible;
determine a first want item of the plurality of want items that satisfies matching criteria for a first property item of the plurality of property items, the matching criteria comprising first tier matching criteria and second tier matching criteria, wherein the second tier matching criteria are optional;
generate an introduction message from a first property user associated with the first property item to a first want user associated with the first want item and enforce a set of privacy restrictions on the introduction message, the set of restrictions comprising removing identifying information of the first property user from the introduction message, wherein the introduction message comprises a subset of the plurality of attributes of the first property item;
cause the introduction message to be sent from an account associated with the first property user to an account associated with the first want user;
upon receiving acceptance of the introduction message from the first want user, make available the remainder of the plurality of attributes of the first property item to the want user, and
upon receiving further acceptance of the first property item from the first want user, establish a secure messaging session between the first want user and the first property user to enable a transaction between the first want user and the first property user for the property item.

2. The system of claim 1, wherein the computer-executable instructions that, if executed, further cause the one or more processors to:
provide a selection to the first want user to decline further communications with the first property user after receiving the introduction message, and
upon receiving the selection to decline further communications, cause further communications between the first want user and the first property user to be terminated and cause a notification to be routed to the account associated with the property user terminating the introduction.

3. The system of claim 1, wherein the computer-executable instructions that, if executed, further cause the one or more processors to:
provide a selection to the first want user to decline further communications with the first property user the remainder of the plurality of attributes of the first property item are made available to the want user, and
upon receiving the selection to decline further communications, cause further communications between the first want user and the first property user to be terminated and cause a notification to be routed to the account associated with the property user terminating the introduction.

4. The system of claim 2, wherein the computer-executable instructions that, if executed, further cause the one or more processors to:
provide a selection to the first want user to decline further communications with the first property user after the remainder of the plurality of attributes of the first property item are made available to the want user, and
upon receiving the selection to decline further communications, cause further communications between the first want user and the first property user to be terminated and cause a notification to be routed to the account associated with the property user terminating the introduction.

5. The system of claim 1, wherein the computer-executable instructions that, if executed, further cause the one or more processors to:
provide a selection to the first want user to decline further communications with the first property within the secure messaging session, and
upon receiving the selection to decline further communications, terminate the secure messaging session.

6. The system of claim 4, wherein the computer-executable instructions that, if executed, further cause the one or more processors to:
provide a selection to the first want user to decline further communications with the first property within the secure messaging session, and
upon receiving the selection to decline further communications, terminate the secure messaging session.

7. The system of claim 1, wherein the set of privacy restrictions further comprises removing one or more attributes of the subset of attributes of the property item from the introduction message.

8. The system of claim 4, wherein the set of privacy restrictions further comprises removing one or more attributes of the subset of attributes of the property item from the introduction message.

9. The system of claim 1, wherein the computer-executable instructions that, if executed, further cause the one or more processors to:
enforce a second set of privacy restrictions upon making the remainder of the plurality of attributes of the first property item available to the want user, wherein the first set of privacy restrictions are different than the set of privacy restrictions.

10. The system of claim 1, wherein the computer-executable instructions that, if executed, further cause the one or more processors to:
remove the set of privacy restrictions upon establishing the secure messaging session between the first want user and the first property user.

11. The system of claim 9, wherein the computer-executable instructions that, if executed, further cause the one or more processors to:
remove one or more of the set of privacy restrictions or the second set of privacy restrictions upon establishing the secure messaging session between the first want user and the first property user.

12. A computerized method for securely and anonymously connecting two parties, the computerized method comprising:
receiving, a plurality of want items from one or more want users, individual want items of the plurality of want items specifying a plurality of attributes of a good or service desired by the one or more want users;
receiving one or more property items from one or more property users, individual property items of the one or more property items specifying a plurality of attributes of a good or service offered for consumption by the one or more property users;
generating and publishing an online listing of the plurality of want items, the online listing being publicly accessible;
determining a first want item of the plurality of want items that satisfies matching criteria for a first property item of the one or more property items;
generating an introduction message from a first property user associated with the first property item to a first want user associated with the first want item and enforcing a set of privacy restrictions on the introduction message, the set of restrictions comprising removing one or more of identifying information of the first property user or one or more identifying attributes of the property item the from the introduction message, wherein the introduction message comprises a subset of the plurality of attributes of the first property item;
causing the introduction message to be sent from an account associated with the first property user to an account associated with the first want user;
upon receiving acceptance of the introduction message from the first want user, making available the remainder of the plurality of attributes of the first property item to the want user, and
upon receiving further acceptance of the first property item from the first want user, establishing a secure messaging session between the first want user and the first property user to enable a transaction between the first want user and the first property user for the property item.

13. The computerized method of claim 12, further comprising:
providing a selection to the first want user to decline further communications with the first property user after receiving the introduction message, and
upon receiving the selection to decline further communications, causing further communications between the first want user and the first property user to be terminated.

14. The computerized method of claim 12, wherein:
providing a selection to the first want user to decline further communications with the first property user the remainder of the plurality of attributes of the first property item are made available to the want user, and
upon receiving the selection to decline further communications, causing further communications between the first want user and the first property user to be terminated.

15. The computerized method of claim 13, further comprising:
providing a selection to the first want user to decline further communications with the first property user after the remainder of the plurality of attributes of the first property item are made available to the want user, and
upon receiving the selection to decline further communications, causing further communications between the first want user and the first property user to be terminated.

16. The computerized method of claim 12, further comprising:
providing a selection to the first want user to decline further communications with the first property within the secure messaging session, and
upon receiving the selection to decline further communications, terminating the secure messaging session.

17. The computerized method of claim 12, wherein the set of privacy restrictions further comprises removing one or more attributes of the subset of attributes of the property item from the introduction message.

18. The computerized method of claim 12, further comprising:
enforcing a second set of privacy restrictions upon making the remainder of the plurality of attributes of the first property item available to the want user.

19. The computerized method of claim 12, wherein:
removing the set of privacy restrictions upon establishing the secure messaging session between the first want user and the first property user.

20. One or more non-transitory computer-readable storage media storing thereon executable instructions that, as a result of being executed by one or more processors of a computer system, cause the computer system to at least:
receive, a plurality of want items from one or more want users, individual want items of the plurality of want items specifying a plurality of attributes of a good or service desired by the one or more want users;
receive one or more property items from one or more property users, individual property items of the one or more property items specifying a plurality of attributes of a good or service offered for consumption by the one or more property users;
generate and publish an online listing of the plurality of want items, the online listing being publicly accessible;
determine a first want item of the plurality of want items that satisfies matching criteria for a first property item of the one or more property items;
generate an introduction message from a first property user associated with the first property item to a first want user associated with the first want item and enforce a set of privacy restrictions on the introduction message, the set of restrictions comprising removing one or more of identifying information of the first property user or one or more identifying attributes of the property item the from the introduction message, wherein the introduction message comprises a subset of the plurality of attributes of the first property item;
cause the introduction message to be sent from an account associated with the first property user to an account associated with the first want user;
upon receiving acceptance of the introduction message from the first want user, cause the remainder of the plurality of attributes of the first property item to be accessible to the want user, and
upon receiving further acceptance of the first property item from the first want user, establish a secure messaging session between the first want user and the first property user to enable a transaction between the first want user and the first property user for the property item.
